(19) United States
(12) Patent Application Publication
(10) Pub. No.: US 2002/0165732 A1
(43) Pub. Date: Nov. 7, 2002

(54) System and method for automated and interactive scheduling

(75) Inventors: Bilal Ezzeddine, Kettering, OH (US); Basil Bakri, Centerville, OH (US); Austin Cleveland, Bellbrook, OH (US); Sam Bakri, Centerville, OH (US); Thomas Merle, Springboro, OH (US)

Correspondence Address: Matthew R. Jenkins, JACOX, MECKSTROTH & JENKINS, Suite 2, 2310 Far Hills Building, Dayton, OH, 45419-1575, US

(73) Assignee: MatchMD, LLC

(21) Appl. No.: 10/102,776

(22) Filed: Mar. 21, 2002

Related U.S. Application Data
(60) Provisional application No. 60/288,055, filed on May 2, 2001.

(51) Int. Cl. G06F 17/60

(52) U.S. Cl. 705/2

(57) ABSTRACT

An on-call system and method which utilizes the Internet and WCTP and WAP protocols and is suitable for use with medical personnel and enables users to remotely access information relative to a person and the person's on-call schedule. The system and method permits at least one user to have immediate and direct communication with at least one recipient using the Internet and/or wireless communications systems and methods. The system and method further provides an automated answering and communication service for persons consisting of an interactive Internet-based system and method that uses a centralized database of scheduling information to organize, orchestrate and instantly connect physicians, hospitals and related medical professionals and even patients during both routine and urgent situations. The system and method enables individuals to be grouped or categorized as desired.

### CROSS-REFERENCE TO RELATED APPLICATION

This application is related to provisional patent application Serial No. 60/288,055, filed May 2, 2001, to which Applicants claim the benefit of the earlier filing date.

### BACKGROUND OF THE INVENTION

1. Field of the Invention

This invention relates to a system and method for matching users, paging users and dispatching communications among users, such as physicians, and enabling such users to access a stored database of information, such as on-call schedules, utilizing the Internet and wireless application protocols.

2. Description of Prior Art

In the past, many people carried pagers and cellular phones to permit them to communicate with others who needed to contact them. This was particularly true in the medical field, where it was important for doctors to be able to communicate with persons who wanted to contact them, for example, in the event of an emergency. To do this, an on-call service was typically used. In the past, the typical on-call service required users to call a central calling center and provide the name of the physician and a return phone number or message that the physician could use to contact the user. The on-call service would then contact the physician and provide or relay the phone number or message provided by the user. The physician would then return the call to the user. Unfortunately, the methods and systems of the past were not capable of providing coverage status information for any physicians who were designated as “on-call” or not on-call. Moreover, the ability to page a person, such as a physician, was limited because it required a telephone call by the requesting user to the call center, which would then page the person or another person who was on-call for the person. Oftentimes, the users are put on hold, and it is not uncommon that the person answering the call at the on-call center would relay an incorrect or inaccurate message or phone number. It was not possible in the systems of the past to allow a user of the on-call service to page an on-call physician directly.

Another drawback of the systems of the past is that they did not provide users with up-to-date information as to on-call schedules for a physician, for example. Also, it is not uncommon in the medical field, for example, for physicians to have a preferred list of referral physicians to whom they prefer to have patients referred for medical attention. In the systems of the past, it was not possible for an authorized person to remotely view a physician's list of preferred referral physicians.

In a hospital-wide call center in a first hospital, it was not uncommon that the call on-call center only serviced hospital-affiliated physicians or clinicians. In this case, the systems of the past were limited in their ability to reach out-of-hospital persons, such as clinicians, physicians, float-pool nurses, imaging technicians or the like, because they may have been covering a hospital that does not share the first hospital's dedicated on-call center and/or the clinician on-call schedule. Therefore, the systems and methods of the past typically failed to provide a complete or comprehensive solution for all clinicians, physicians, float-pool nurses, imaging technicians or the like, regardless of their location.

Another problem with systems and methods of the past is that the data, such as a name, address, phone or pager numbers, referral physicians associated with a physician, was not accessible by, for example, a group administrator who was in charge of the on-call schedule for all persons, such as physicians, within the group. Consequently, keeping track of the data, such as an on-call schedule, for every physician, was often a tedious and sometimes inaccurate process. For example, if an on-call schedule for a physician was not up-to-date, the on-call center referred a caller to an incorrect covering person.

Still another problem with the systems of the past, was that the information associated with a person or a group of persons, such as a group of physicians, was not easily accessible over the Internet. Moreover, the systems of the past did not provide a means for a user at a computer to communicate a message to or among multiple persons using the Internet and wireless communication protocols and technologies.

What is needed, therefore, is a system and method for providing a matching and on-call system and method that permits one or more users to access information relative to a person or group of persons, such as physicians and their staffs, and to communicate to such persons over the Internet and utilizing wireless communication systems and methods.

### SUMMARY OF THE INVENTION

A primary object of the invention is to provide an on-call system and method which utilizes the Internet and is suitable for use with physicians.

Another object of the invention is to provide an on-call system and method which enables at least one user to remotely access information relative to a person, such as a physician, a person's schedule, and a person's on-call schedule.

Another object of the invention is to provide an on-call system and method that permits at least one user to communicate to at least one recipient using the Internet and/or wireless communications systems and methods.

Still another object of the invention is to provide a system and method which enables users to have immediate and direct communication with a recipient, such as a physician.

Yet another object of the invention is to provide an automated answering and communication service for medical practitioners consisting of an interactive Internet-based system and method that uses a centralized database of scheduling information to organize, orchestrate and instantly connect physicians, hospitals and related medical professionals and even patients during both routine and urgent situations.

Still another object of the invention is to provide a system and method for entering, interrogating, and retrieving information, such as a call schedule, between or among users of the system.

Still another object of the invention is to provide a system and method for storing paging information to contact and communicate with a selected recipient, either manually or by an Internet-enabled paging system, which also has the optional feature of providing delivery notification and replies to the originating user.

Still another object of the invention is to provide an Internet-based system that expedites the paging communication between users of the system and recipients of the paging messages that the users enter on behalf of themselves or the facilities or organizations that they are associated with, such as a hospital or other health care institution.

Still another object of the invention is to provide an Internet-based system that will provide a direct line of communication between the physician and the hospital, regardless of the location of the physician.

Yet another object of the invention is to provide an Internet-based information storage and retrieval system that provides vital information to users, including but not limited to a preference list of physician specialists or referral physicians that the primary care physician prefers or utilizes.

Another object of the invention is to provide a system that enables a user to contact a physician directly or contact a physician's covering physician or preferred referral physician.

Yet another object of this invention comprises a method for communicating on-call information among medical personnel, said method comprising the steps of: submitting a message to an on-call server, and transmitting the message from the on-call server to a communication device.

In one aspect this invention comprises an on-call system comprising a host, said host comprising a database, at least one server and a plurality of active server pages, said database comprising on-call data associated with a person, and said plurality of active server pages comprising an user interface page for permitting a user to access said database via the Internet.

In another aspect, this invention comprises a communication system for communicating among medical personnel, comprising a host comprising a database, at least one server and a plurality of active server pages for enabling a user to access said database, determine information associated with at least one of said medical personnel and to send a message to said at least one medical personnel, a wireless communication system for communicating said message between said host and at least one network server, and a communication device for receiving said message from said network server when transmitted by said wireless.

In still another aspect, this invention comprises a method for communication among medical personnel comprising the steps of providing a host having a database for receiving information regarding said medical personnel, permitting a user to enter said information into said database and permitting a second user to access said information after logging onto said host, said information comprising at least one of the following: a medical personnel's on-call schedule or contact information for contacting said medical personnel.

These and other objects and advantages of the invention will be apparent from the following description, the appended claims, and the accompanying drawings.

### BRIEF DESCRIPTION OF ACCOMPANYING DRAWING

FIG. 1 is an illustration of a system in accordance with one embodiment of the invention;

FIG. 2 is a schematic diagram showing further details of the system;

FIG. 3 is another schematic showing further details of the system;

FIG. 4 is a schematic diagram showing further details of the invention;

FIG. 5 is a schematic diagram showing further details of the system;

FIG. 6 is a schematic diagram showing further details of the system;

FIG. 7 is a schematic diagram showing further details of the system;

FIG. 8 is a schematic diagram showing further details of the system;

FIG. 9 is a schematic diagram showing further details of the system;

FIG. 10 is a schematic diagram showing further details of the system;

FIG. 11 is a schematic diagram showing further details of the system;

FIG. 12 is a schematic diagram showing further details of the system;

FIG. 13 is a schematic diagram showing further details of the system;

FIG. 14 is a schematic diagram showing further details of the system;

FIG. 15 is a schematic diagram showing further details of the system;

FIG. 16 is a schematic diagram showing further details of the system;

FIG. 17 is a schematic diagram showing further details of the system;

FIG. 18 is a schematic diagram showing further details of the system;

FIG. 19 is a schematic diagram showing further details of the system;

FIG. 20 is a schematic diagram showing further details of the system;

FIG. 21 is a schematic diagram showing further details of the system;

FIG. 22 is a schematic diagram showing further details of the system;

FIG. 23 is a schematic diagram showing further details of the system;

FIG. 24 is a schematic diagram showing further details of the system;

FIG. 25 is a schematic diagram showing further details of the system;

FIG. 26 is a schematic diagram showing further details of the system;

FIG. 27 is a schematic diagram showing further details of the system;

FIG. 28 is a schematic diagram showing further details of the system;

FIG. 29 is a schematic diagram showing further details of the system;

FIG. 30 is a schematic diagram showing further details of the system;

FIG. 30A is a schematic diagram showing further details of the system;

FIG. 31 is a schematic diagram showing further details of the system;

FIG. 32 is a schematic diagram showing further details of the system;

FIG. 33 is a schematic diagram showing further details of the system;

FIG. 34 is a schematic diagram showing further details of the system;

FIG. 35 is a schematic diagram showing further details of the system;

FIG. 36 is a schematic diagram showing further details of the system;

FIG. 37 is a schematic diagram showing further details of the system;

FIG. 38 is an illustration of an active server page in accordance with one embodiment of the invention;

FIG. 39 is an illustration of another active server page showing further details;

FIG. 40 is an illustration of another active server page showing further details;

FIG. 41 is an illustration of another active server page showing further details;

FIG. 42 is an illustration of another active server page showing further details;

FIG. 43 is an illustration of another active server page showing further details;

FIG. 43A is an illustration of another active server page showing further details;

FIG. 44 is an illustration of another active server page showing further details;

FIG. 45 is an illustration another active server page showing further details;

FIG. 46 is an illustration of another active server page showing further details;

FIG. 47 is an illustration of another active server page showing further details;

FIG. 48 is an illustration of another active server page showing further details;

FIG. 49 is an illustration of another active server page showing further details;

FIG. 50 is an illustration of another active server page showing further details;

FIG. 51 is an illustration of another active server page showing further details;

FIG. 52 is an illustration of another active server page showing further details;

FIG. 53 is an illustration of another active server page showing further details;

FIG. 54 is an illustration of another active server page showing further details;

FIG. 55 is an illustration of another active server page showing further details;

FIG. 56 is an illustration of another active server page showing further details;

FIG. 57 is an illustration of another active server page showing further details;

FIG. 58 is an illustration of another active server page showing further details;

FIG. 59 is an illustration of another active server page showing further details;

FIG. 60 is an illustration of another active server page showing further details;

FIG. 61 is an illustration of another active server page showing further details;

FIG. 62 is an illustration of another active server page showing further details;

FIG. 63 is an illustration of another active server page showing further details;

FIG. 64 is an illustration of another active server page showing further details;

FIG. 65 is an illustration of another active server page showing further details;

FIG. 66 is an illustration of another active server page showing further details;

FIG. 67 is an illustration of another active server page showing further details;

FIG. 68 is an illustration of another active server page showing further details;

FIG. 69 is an illustration of another active server page showing further details;

FIG. 70 is an illustration of another active server page showing further details;

FIG. 71 is an illustration of another active server page showing further details;

FIG. 72 is an illustration of another active server page showing further details;

FIG. 73 is an illustration of another active server page showing further details;

FIG. 74 is an illustration of another active server page showing further details;

FIG. 75 is an illustration of another active server page showing further details;

FIG. 76 is an illustration of another active server page showing further details;

FIG. 77 is an illustration of another active server page showing further details;

FIG. 78 is an illustration of another active server page showing further details;

FIG. 79 is an illustration of another active server page showing further details;

FIG. 80 is an illustration of another active server page showing further details;

FIG. 81 is an illustration of another active server page showing further details;

FIG. 82 is an illustration of another active server page showing further details;

FIG. 83 is an illustration of another active server page showing further details;

FIG. 84 is an illustration of another active server page showing further details;

FIG. 85 is an illustration of another active server page showing further details;

FIG. 86 is an illustration of another active server page showing further details;

FIG. 87 is an illustration of another active server page showing further details;

FIG. 87A is an illustration of another active server page showing further details;

FIG. 87B is an illustration of another active server page showing further details;

FIG. 87C is an illustration of another active server page showing further details;

FIG. 87D is an illustration of another active server page showing further details;

FIG. 88 is an illustration of another active server page showing further details;

FIG. 89 is an illustration of another active server page showing further details;

FIG. 90 is an illustration of another active server page showing further details;

FIG. 91 is an illustration of another active server page showing further details;

FIG. 92 is an illustration of another active server page showing further details;

FIG. 93 is an illustration of another active server page showing further details;

FIG. 94 is an illustration of another active server page showing further details;

FIG. 95 is an illustration of another active server page showing further details; and

FIG. 96 is an illustration of another active server page showing further details;

### DETAILED DESCRIPTION OF PREFERRED EMBODIMENT

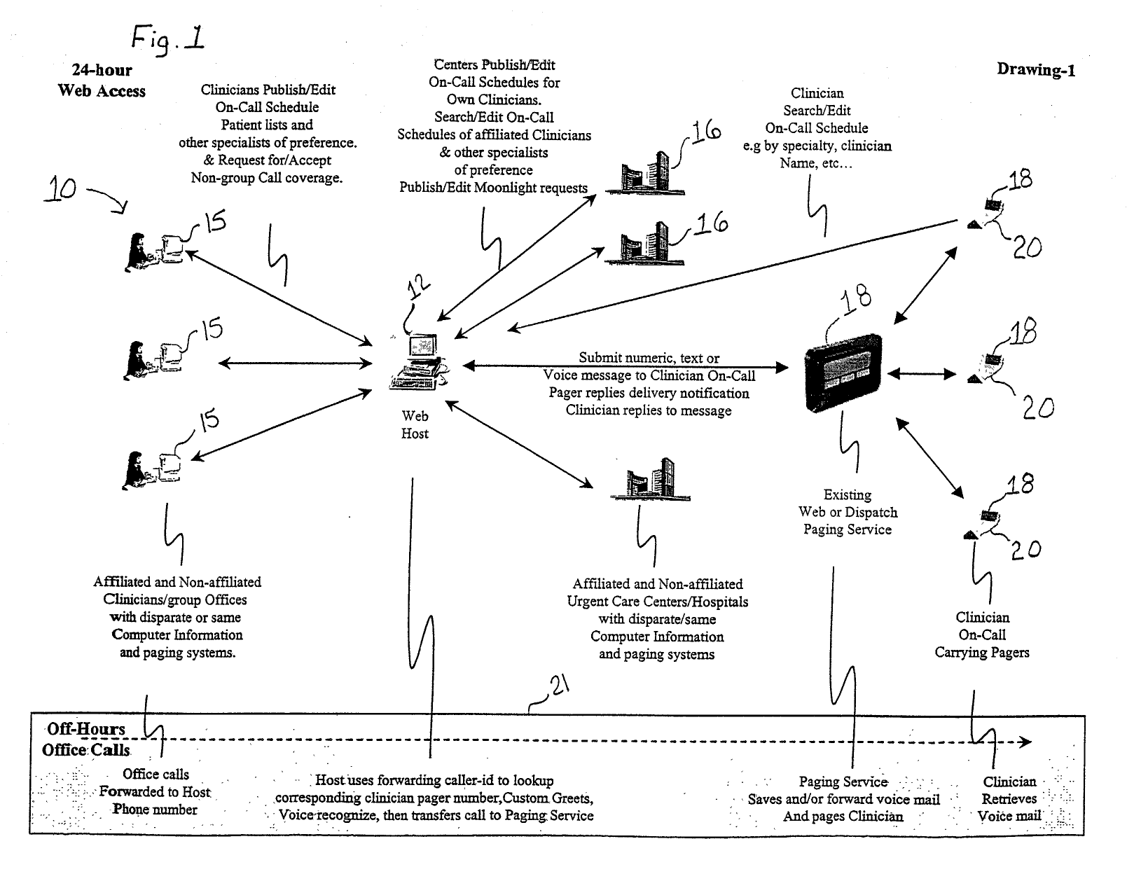

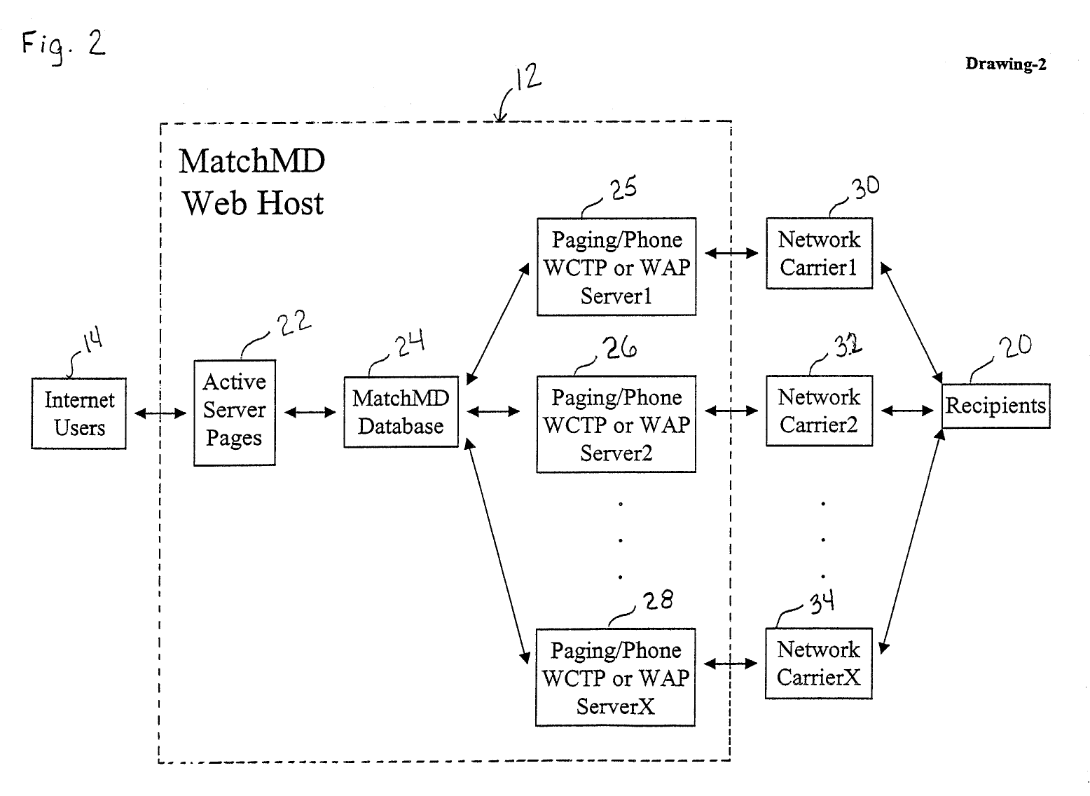

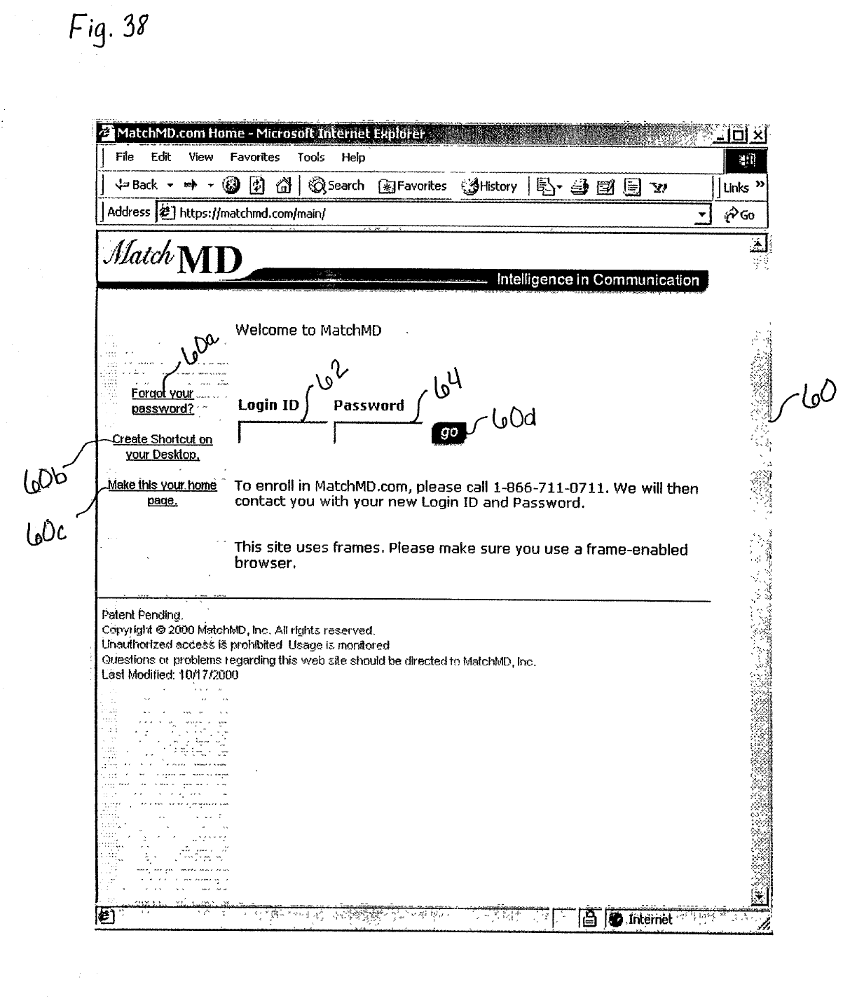

Referring now to FIG. 1 a system 10 in accordance with one embodiment of the invention is shown diagrammatically as including a web site host server 12 which in the embodiment being described comprises a conventional computer such as a Dell Dimensions 4100 PC available from Dell Computers comprising an Intel Pentium processor running Microsoft 2000 Operating System, Microsoft-IIS Internet server and Microsoft SQL server. In the embodiment being described, the host server 12 is connected to the Internet using a static PCP/IP address. As will be described in detail later here, remote terminals 15 may connect via host server 12 along with computers (not shown) located at remote stations or centers 16. The host 12 is also coupled to an existing web or dispatch paging service utilizing one or more pagers 18 for saving and/or forwarding voice mail and messages between the host 12 and end users or recipients 20. Note that the in manner described later herein, the pagers communicate directly with host 12 using wireless communication transfer protocol (WCTP), as well as the wireless application protocol (WAP), which utilize HTTP and HTTPS Internet protocols. The web host 12, comprising a plurality of active server pages (FIGS. 38-96) and represented schematically by block 22 in FIG. 2, permits users, such as users 12 or users (not shown) at station 16 or even other remote users, to access a database 24 using the Microsoft IIS and SQL servers. The web host 12 further comprises at least one or a plurality of servers 25, 26 and 28 that communicate information to and from the recipients 20 via the network carriers 30, 32 and 34, respectively, as shown. In the embodiment being described, the servers 25, 26 and 28 comprise WTCP and WAP servers and may include national providers/servers available from Ameritech 1way, Arch, AT&T WAP Phone, Metrocall 2-way Cap Code, Metrocall 2way, Metrocall 1way Alphanumeric, Motient, Nextell WAP Phone, PageNet 2way, PageNet 1way Local, PageNet 1way National, Palm -No Alert-, Skytel, Sprint WAP Phone, TSR 2way, Verizon Pager, Verizon SMS Phone, Verizon WAP Phone (-No Alert-) and network carriers 30, 32 and 34 comprise Ameritech 1way, Arch, AT&T WAP Phone, Metrocall 2-way Cap Code, Metrocall 2way, Metrocall 1way Alphanumeric, Motient, Nextell WAP Phone, PageNet 2way, PageNet 1way Local, PageNet 1way National, Palm -No Alert-, Skytel, Sprint WAP Phone, TSR 2way, Verizon Pager, Verizon SMS Phone, Verizon WAP Phone (-No Alert-).

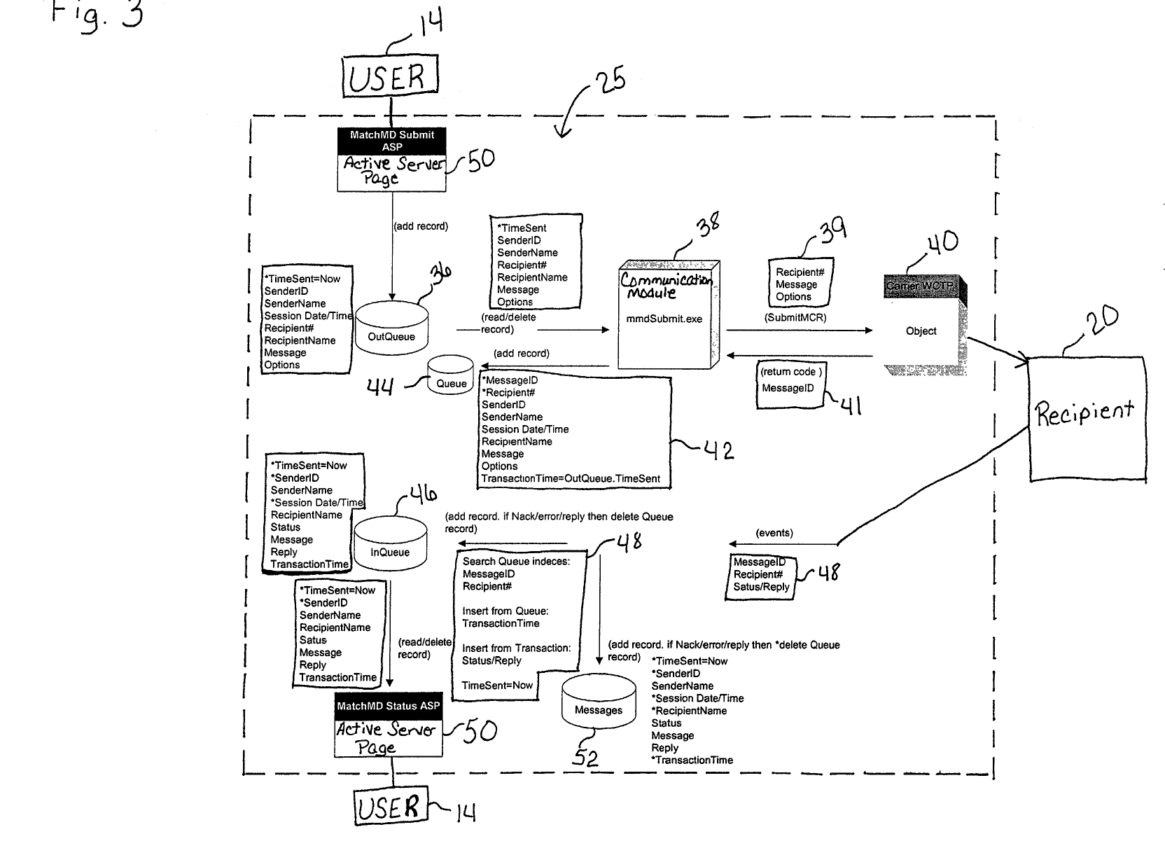

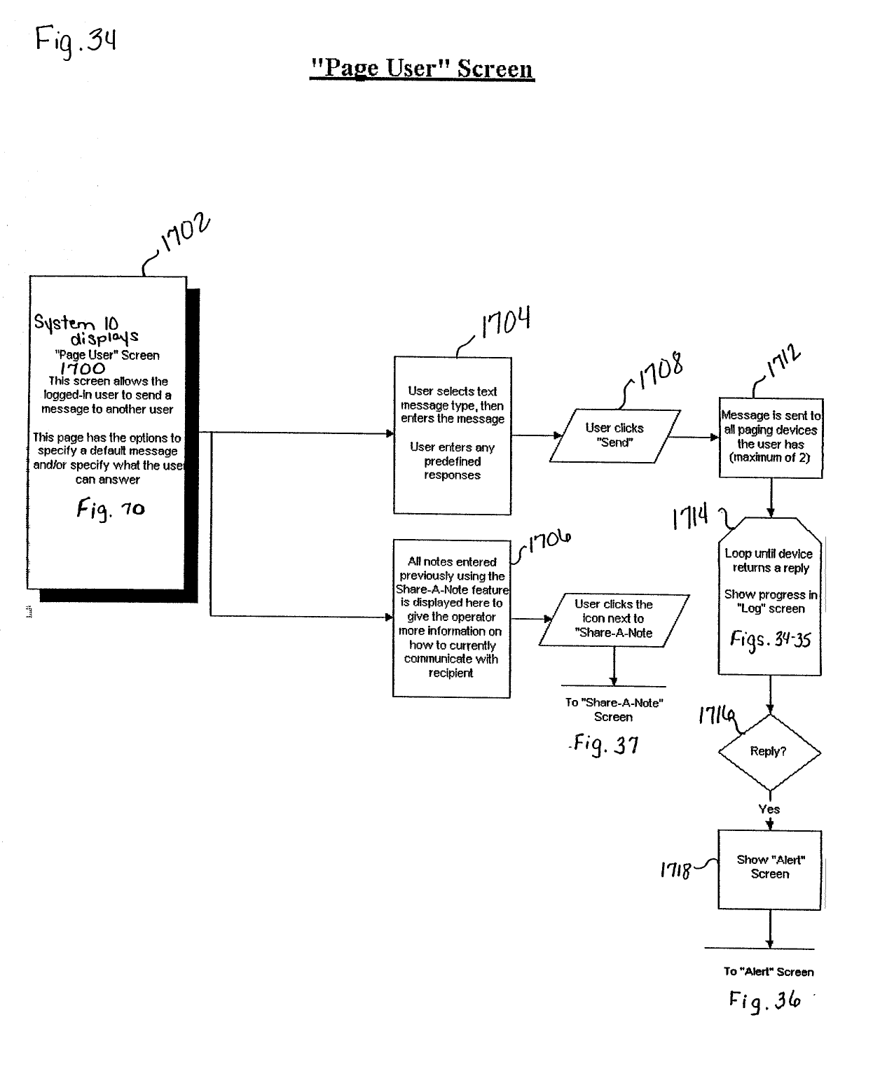

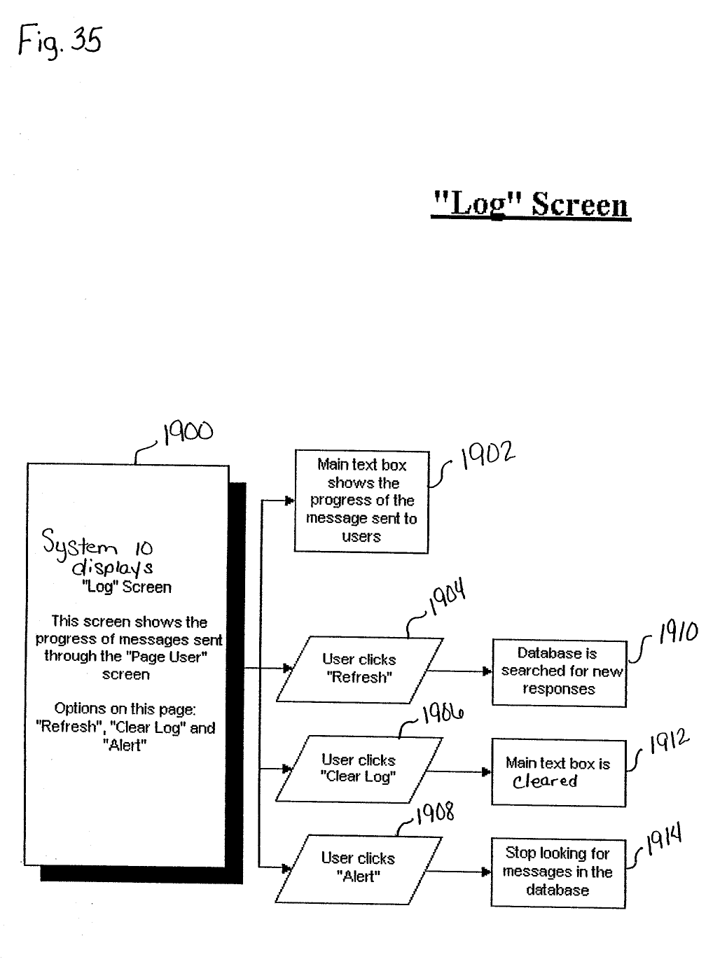

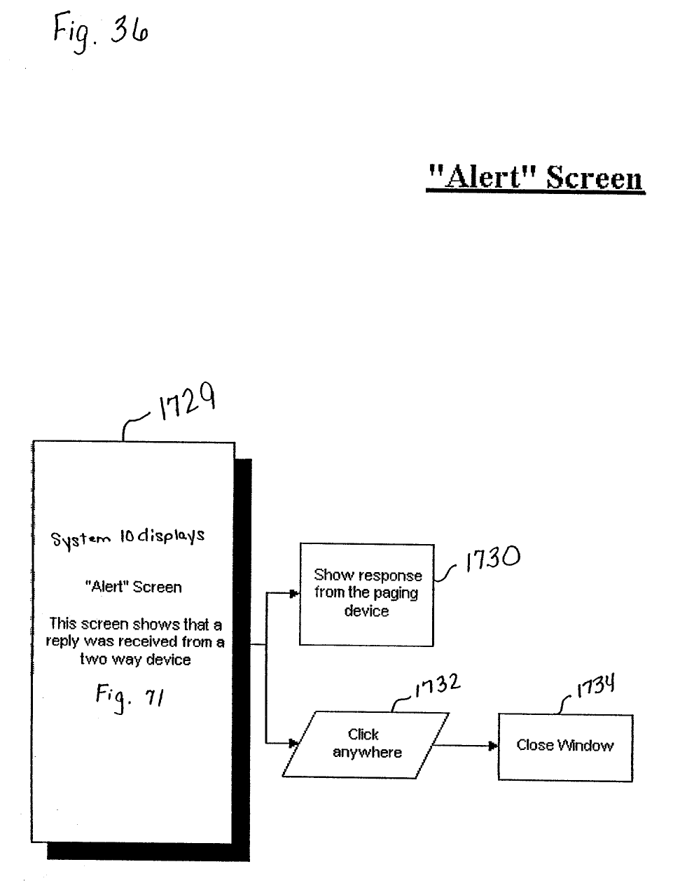

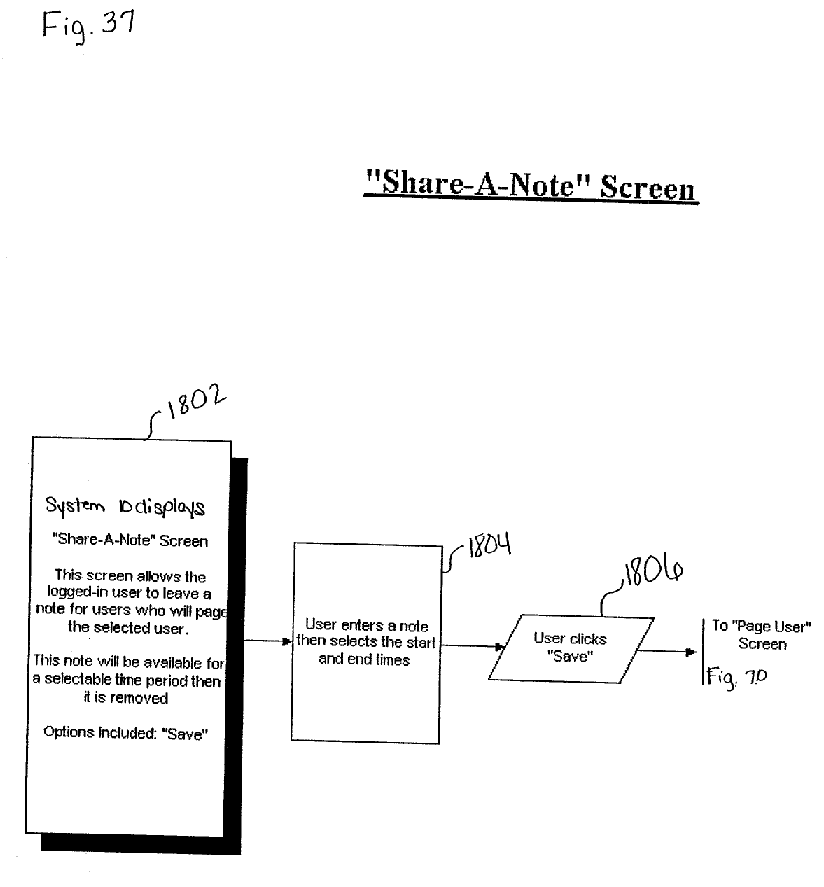

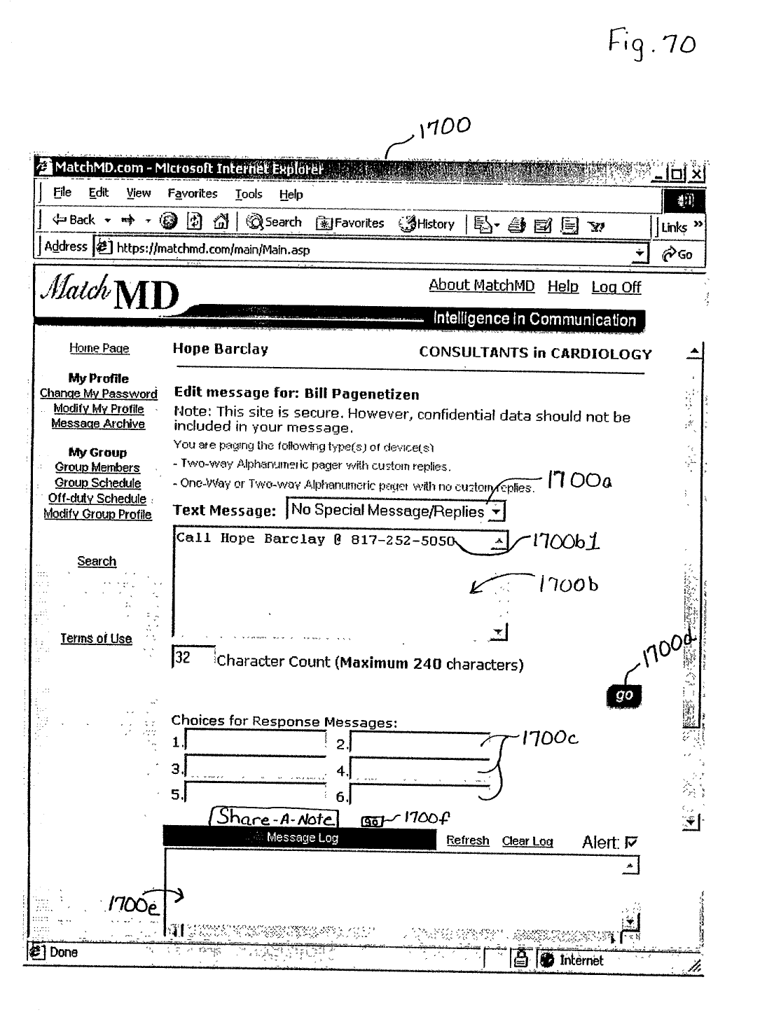

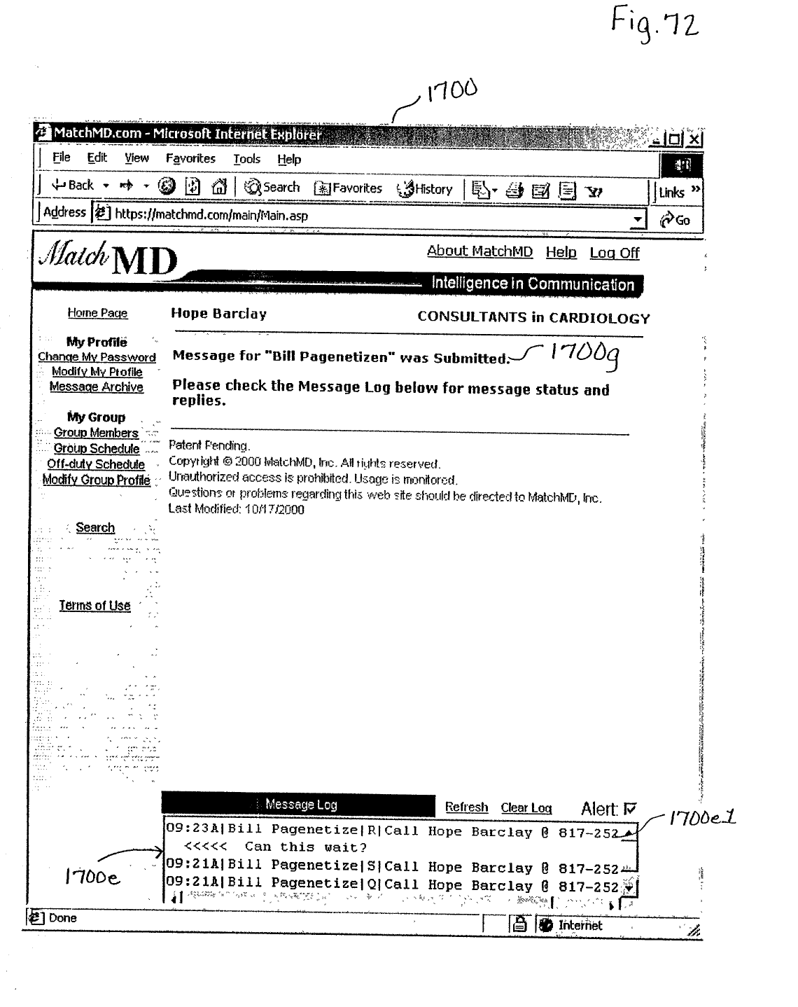

For ease of illustration, one of the servers, server 25, will be described relative to FIG. 3. In the embodiment being described, the system 10 comprises application process that will be described relative to blocks 1702-1718 in FIG. 34, block 1900-1914 in FIG. 35, blocks 1729-1734 in FIG. 36 and blocks 1802-1806 in FIG. 37 and associated server pages 70-74. The architecture for the process comprises the active server pages (FIGS. 70-74) which are used by user 14 to send, request and receive using a suitable browser such as Netscape Navigator version 4.7 or higher or Microsoft Internet Explorer version 4.0 or higher via, for example, the user's internet service provider (ISP). The active server pages are transmitted over the Internet using the Microsoft IIS. The active server pages store a user's 14 request(s) in the SQL server databases 36 in a first-in-first-out (FIFO) manner. In the embodiment being described, the active server pages (FIGS. 72-74) may contain various types of information, such as the time the user's message was sent, the sender's identification, the session date and time, the recipient's name number or identification, the message could be conveyed or other options or information.

A communication module 38 polls the in-queue for paging requests and submits each request to the paging carrier server using the supported protocol. The communication module 38 communicates the information, such as the recipient name and identification number, the sender's name and identification number, the message and the like and provides response options to the end user or recipient 20, as will be described later herein. As previously mentioned, the invention utilizes conventional wireless technologies, such as the wireless communication transfer protocol (WCTP) and wireless application protocol (WAP) mentioned earlier herein to communicate via the networks 30, 32 and/or 34 to the recipient 20. Thus, the communication module 38 generates an object 40 comprising the aforementioned information which is ultimately received by the recipient 20. The recipient 20 utilizes the conventional response mechanism, such as the devices 18, which may comprise a conventional pager, such as Motorola “Talkabout” T900 available from Motorola Corporation, a portable digital assistant (PDA), such as Samsung SPH-1300 available from Samsung, or 2way wireless telephones, such as Sprint PCS Touchpoint 1100 available from Sprint. The recipient 20 may respond to the user 14 using appropriate active server pages and a record 42 associated with that response is stored on a FIFO basis in the database 44.

The servers 25, 26 and 28 further comprise an in-queue database 46 that receives a record 48 generated by the recipient 20 by using the active server pages 34. In the embodiment being described, the record 48 may comprise a variety of information, as described later herein, including the recipient's name, identification, status or reply information, time stamp, a message identification and a reply message, among other information. The record 48 is added to the in-queue database 46. Ultimately, the record 48 and the information or portions of the information thereon is provided to the user 14 via the active server page or pages 50. If the recipient 20 failed to receive the message or if an error message is generated, then the record 48 is stored in database 52 and is indicated via a tracking message (not shown) that the message failed to reach the recipient. The error message may be generated if the recipient 20 does not acknowledge receipt of the information 39 in response to the recipient's ID 41, such as when the recipient 20 fails to acknowledge receipt of the message, when there is an error in transmission of the message, if the recipient 20 has its communication device 18 turned off, or other reply failure.

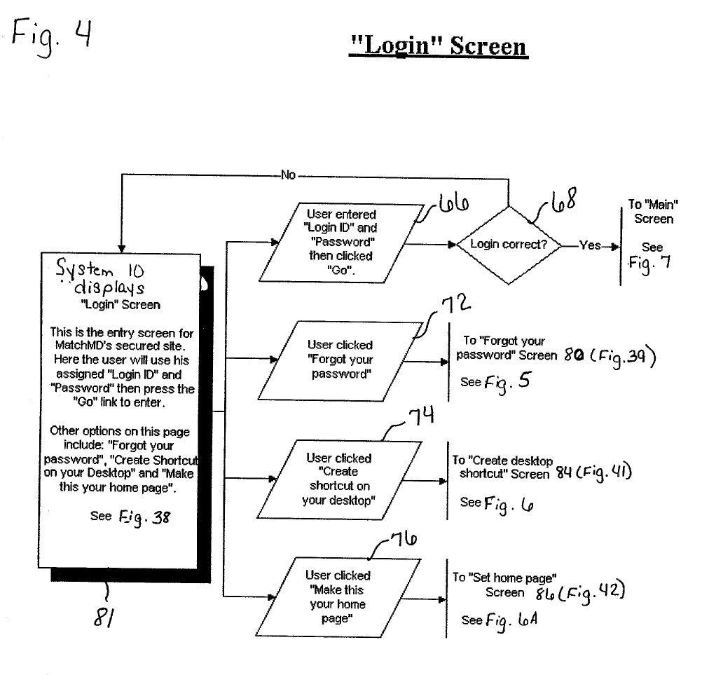

Having described the architecture, the operation and use of the system 10 will now be described relative to the schematics illustrated in FIGS. 4-37 and the associated active server page screen shots illustrated in FIGS. 38-96.

For ease of illustration, the FIGS. 4-6 and FIG. 12 illustrate the process or routine and FIGS. 38-42 are associated active server pages used for implementing the system and process described.

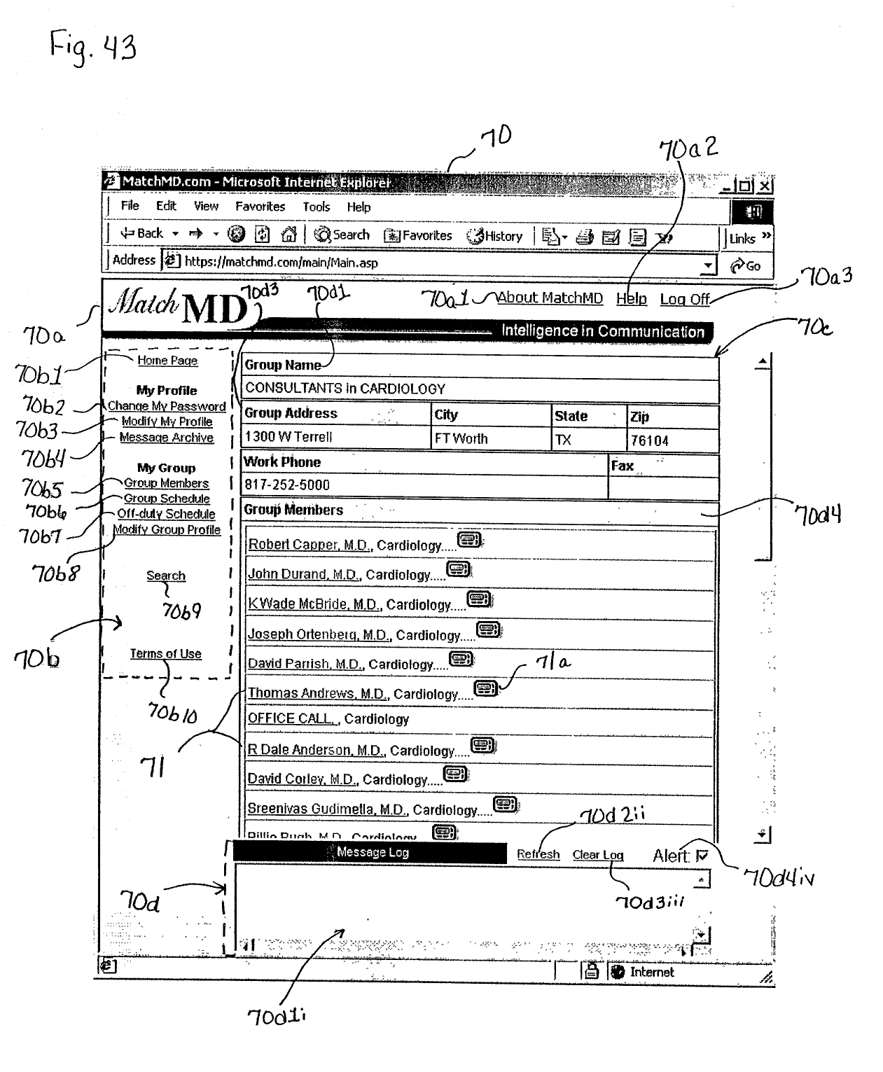

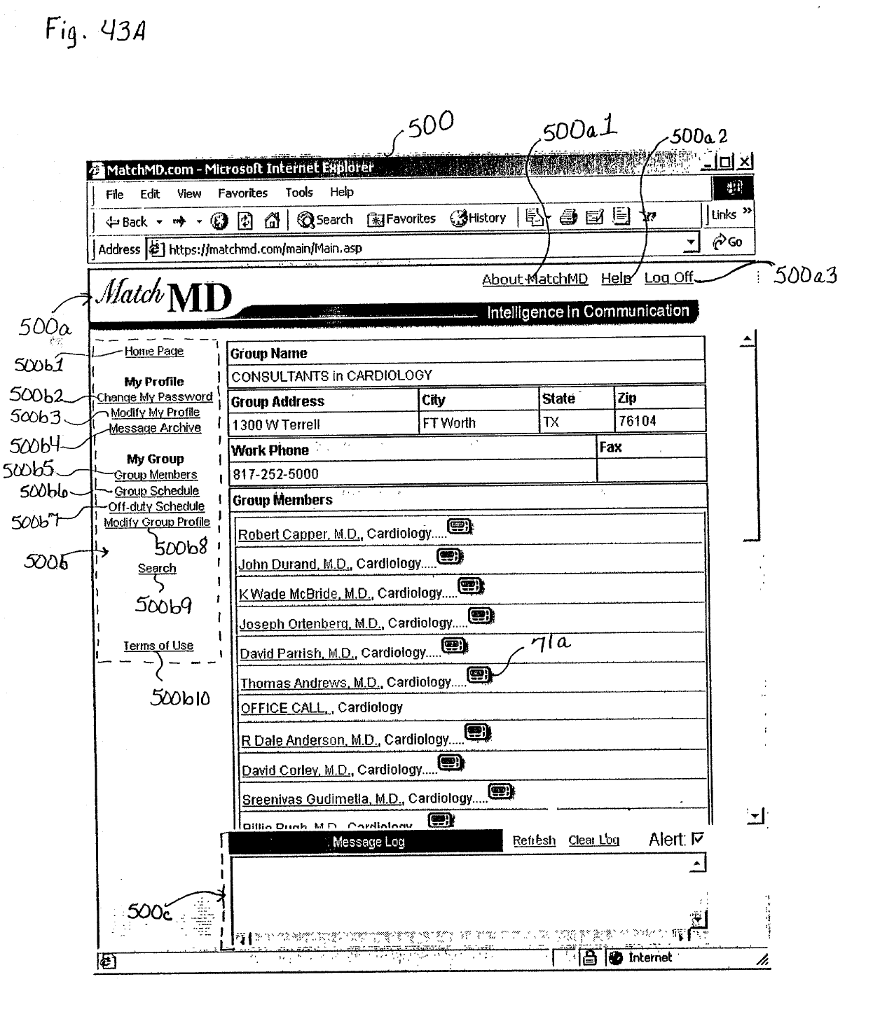

The system and method includes a first active server page 60 (FIG. 38) displayed (block 81 in FIG. 4) by system 10. The user accesses (block 81 in FIG. 4) the page 60 and may enter a login ID 62 and password 64, as shown at block 66 in FIG. 4. At decision block 68 (FIG. 4), it is determined whether the login identification and password are correct and if they are not, the login screen 60 (FIG. 38) is again displayed by system 10. If the login screen 60 is correct, then the routine proceeds to display a main active server page 70 (FIG. 43) as described later herein.

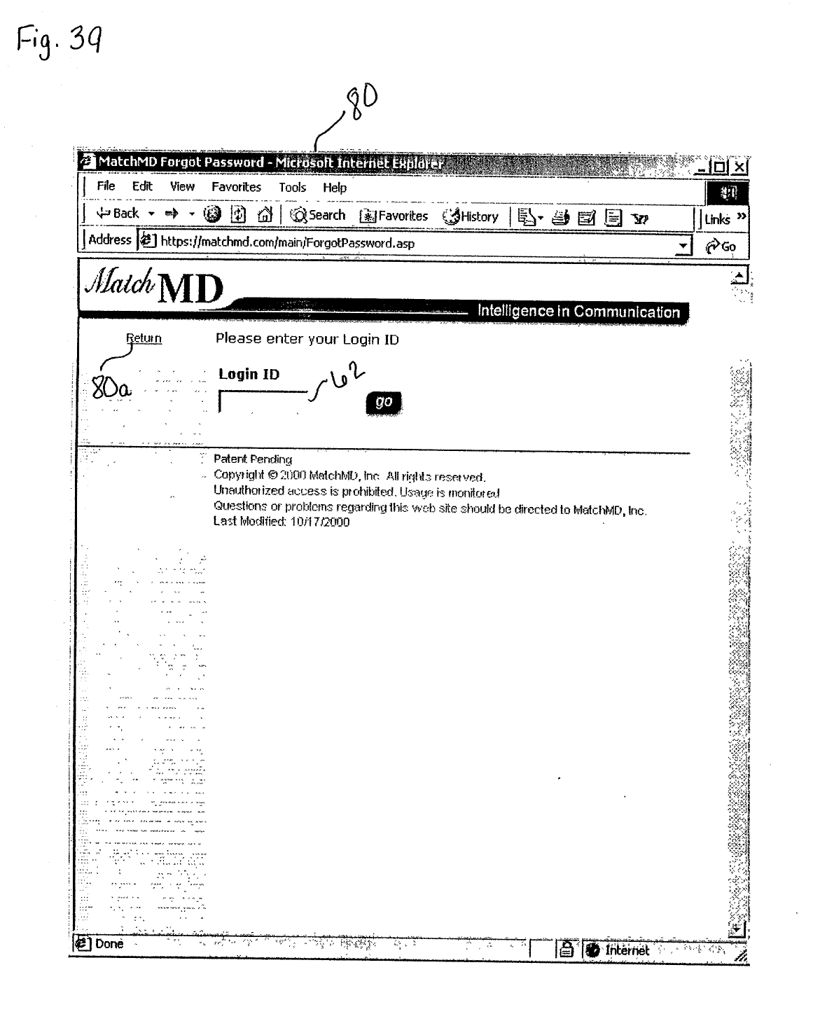

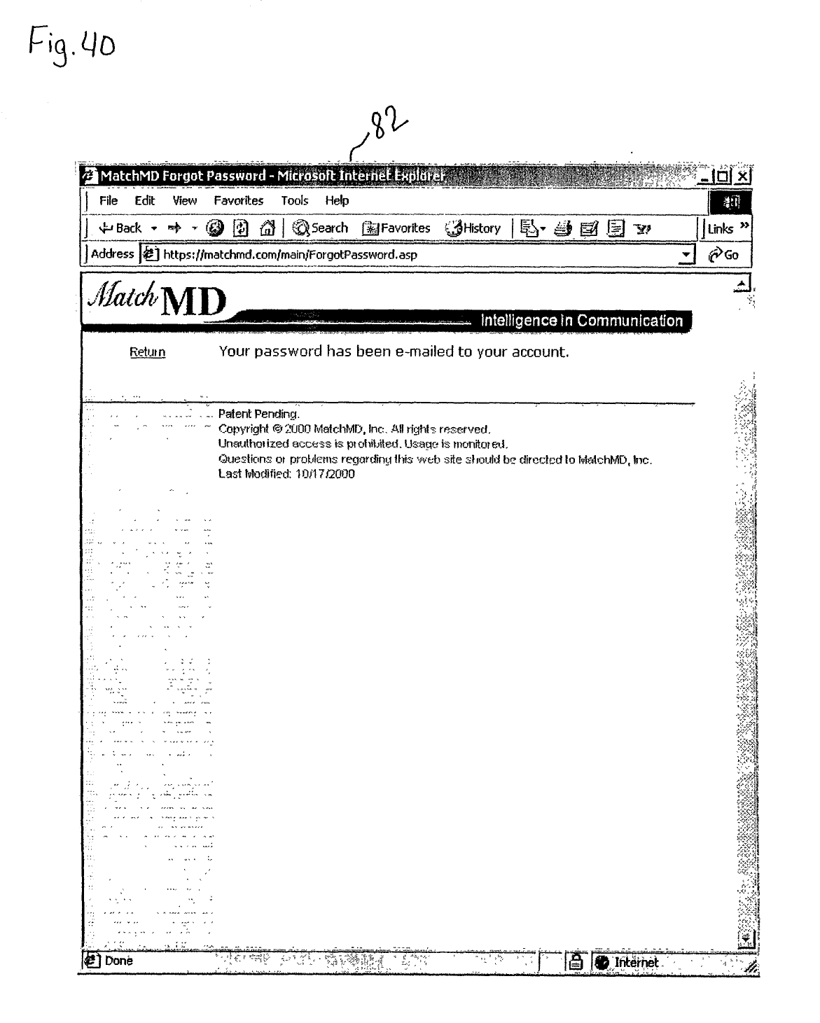

The active server page 60 (FIG. 38) also provides means for the user 14 to perform various functions including being reminded of a password (block 72 in FIG. 4), creating a shortcut on their desktop (block 74) or make the login screen 60 their home page (block 76) in FIG. 4. If the user selects the “Forgot your password” link 60a (FIG. 38) at block 72 (FIG. 4), then a forgot your password active server page 80 (FIG. 39) is displayed by system 10 at which the user may enter their login ID 62. The password 64 associated with the login ID 62 is then electronically mailed to the user's 14 account, as shown by an active server page 82 (FIG. 40) which system 10 causes to be displayed by the web host 12 on the user's 14 terminal.

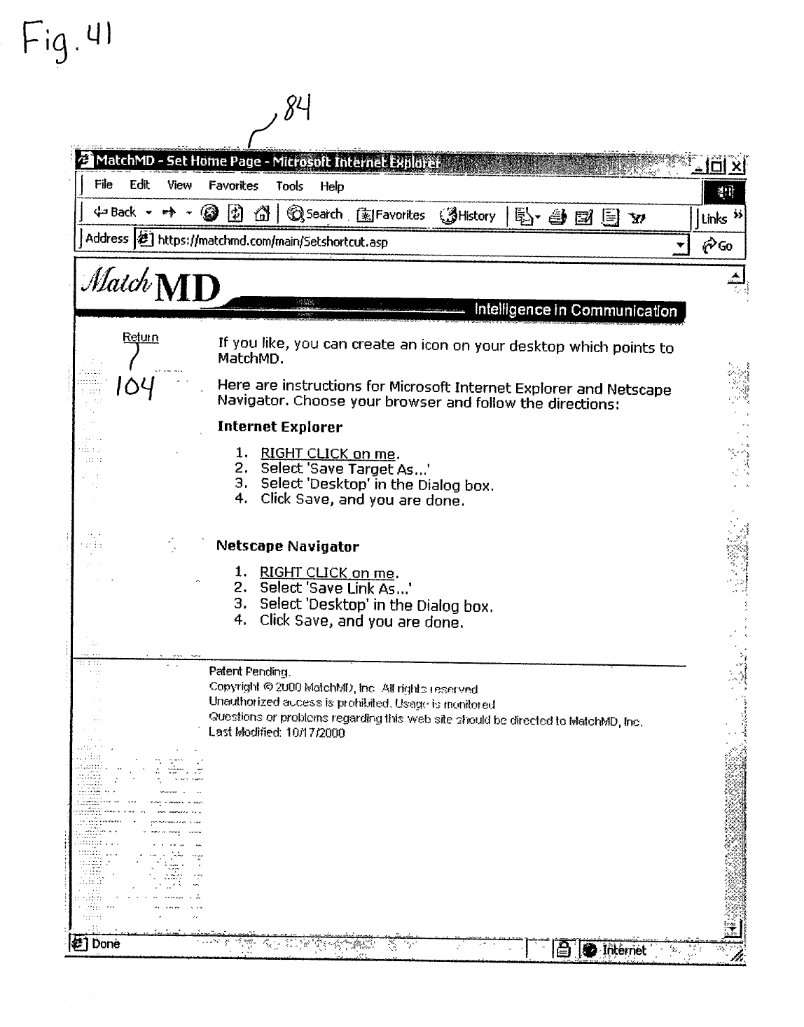

If the user 14 selects the “Create Shortcut on Desktop” link 60b (FIG. 38), then the active server page 84 (FIG. 41) is displayed by host 12 which enables the user 14 to create an icon on their desktop computer which points to the main login screen 60. The active server page 84 provides instructions for Microsoft's Internet Explorer and Netscape Navigator programs.

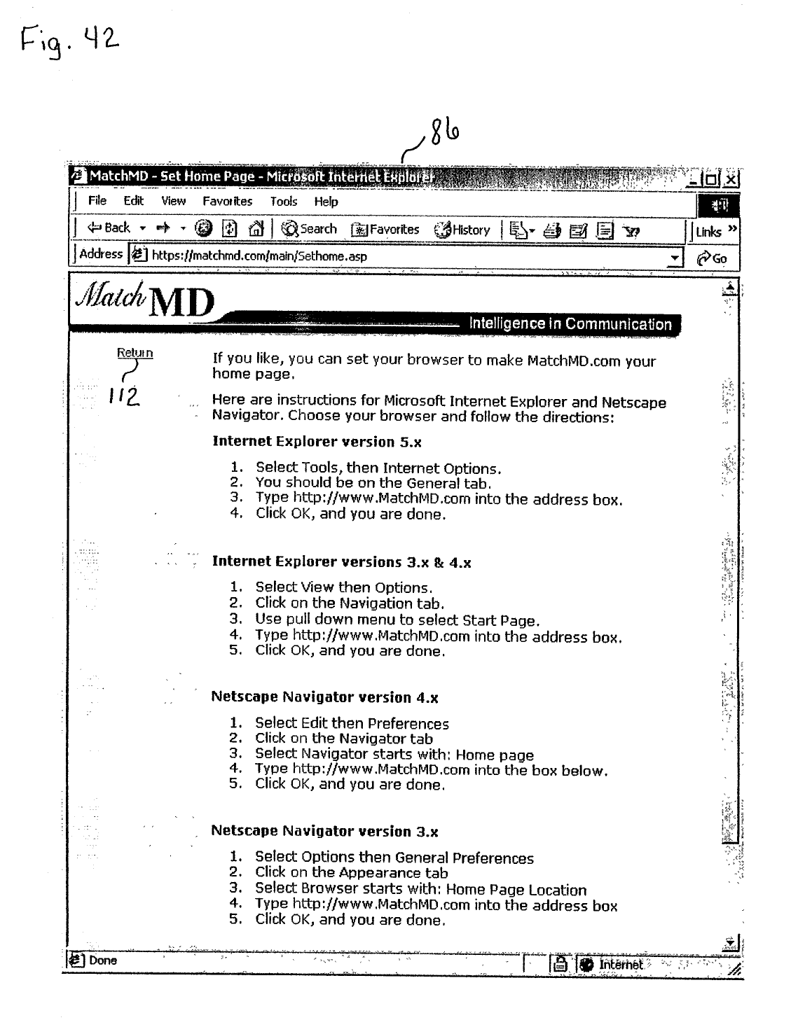

If the user 14 wishes to make the login screen 60 (FIG. 38) their home page, then the user selects the “Make this your home page” link 60c (FIG. 38) on the active server page 60. The host 12 then responds by displaying the active server page 86 (FIG. 42) which provides the user with instructions on setting the user's Internet browser to make the login screen 60 their home page.

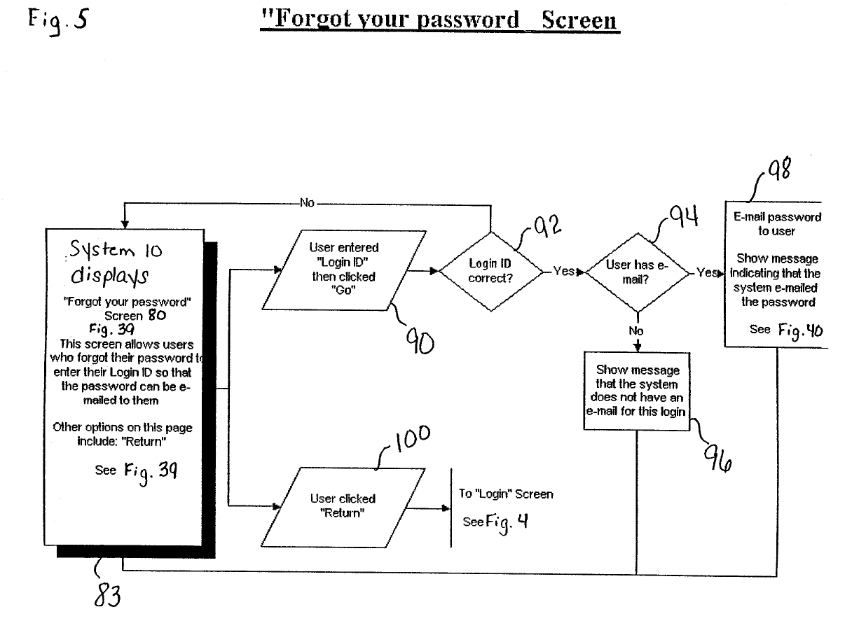

After the user 14 has selected the “Forgot your password” link, the system 10 displays (block 83 in FIG. 5) an active server page 80 (FIG. 39) and the routine proceeds as illustrated in FIG. 5, which allows users who have forgotten their password 64 to enter their login ID 62 so that the password can be electronically mailed to the user 14. After the user 14 has entered its login ID 62 (block 90 in FIG. 5), the user selects the “go” link 60d (FIG. 38) on the active server page 80 (FIG. 39). At decision block 92 (FIG. 5), it is determined whether the login ID was correct and if it was not, then the routine loops back and the host 12 displays the active server page 80 (FIG. 39). If the decision at decision block 92 is affirmative, then the routine proceeds to decision block 94 where host 12 determines whether the user 14 has an electronic mail address. If he does (block 98 in FIG. 5), then the host 12 electronically mails the user 14 the password 64 associated with the user's 14 login identification and subsequently shows a message indicating that the password 64 has been electronically mailed to the user 14 with the active screen page 82 (FIG. 40).

If the decision at decision block 94 is negative, thereby indicating that the user does not have an electronic mail address, then the host 12 may display a message (block 96 in FIG. 5) that the system does not have an electronic mail address for this login identification 62 using an active server page (not shown). After blocks 96 and 98, the host 12 returns to the active server page 80 shown in FIG. 39. If the user 14 selects the return link 80a (block 100 in FIG. 5), he is returned to the login server page 60.

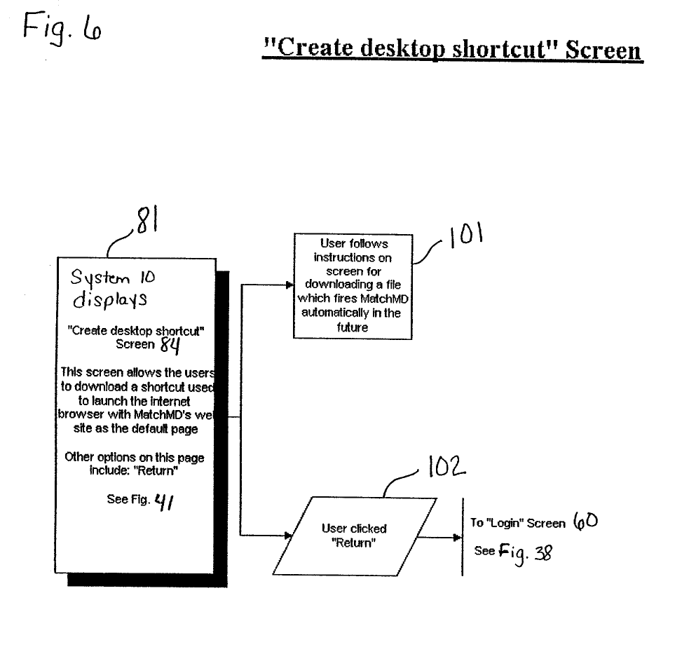

If the user 14 has elected to create a desktop shortcut by selecting the “Create Shortcut on your Desktop” link 60 on the login screen 60 (FIG. 38), then the host 12 proceeds in accordance with the routine shown in FIG. 6. The host 12 displays (block 81 in FIG. 6) the active server page 84 (FIG. 41) whereupon the user 14 follows the instructions on the screen 84 for creating a shortcut (not shown) that will automatically locate the host 12 and the active server page 60 (block 101 in FIG. 6). After the user 14 has created the shortcut as desired, the user 14 actuates the return using the “Return” link 104 (FIG. 41) on the active server page 84 as shown. In response, the host 12 returns (block 102 in FIG. 6) the user 14 to the active server page 60 (FIG. 38).

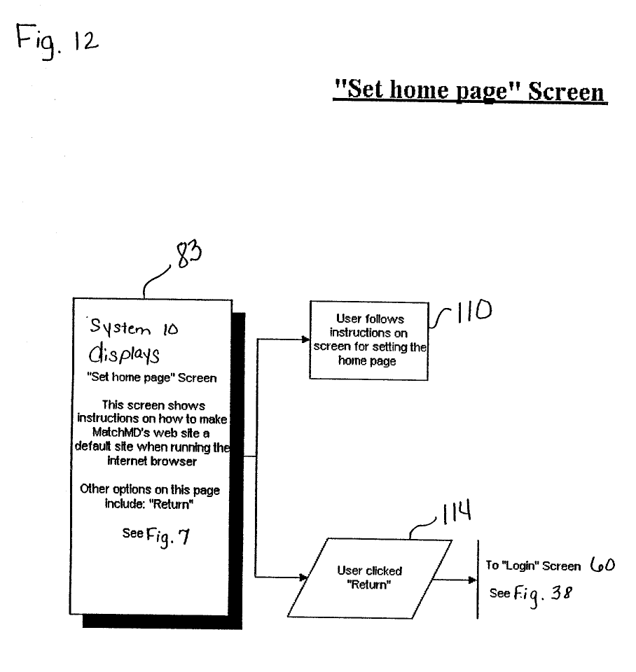

Returning now to the method shown in FIG. 4, if the user 14 desires to make the active server page 60 the user's home page in their particular Internet browser, then the user 14 may select (block 76 in FIG. 4) the “Make this your home page” link 60c (FIG. 38). In response, the host 12 displays (block 83 in FIG. 12) the active server page 86 (FIG. 42).

After the active server page 86 is displayed, the user 14 follows the instructions on the active server page 86 (FIG. 42) to make the page 60 (FIG. 38) the user's home page, as indicated at block 110 (FIG. 12). Thereafter, the user 14 actuates the “Return” link 112 in FIG. 42 (block 114 in FIG. 12) whereupon the user 14 is returned to the active server page 60 (FIG. 38).

After the user 14 has logged into the host 12 via the active server page 60 (FIG. 38), the user 14 is directed to a main screen or active server page 70 (FIG. 43). It should be appreciated that this main screen 70 may be different for different types of users. The main screen 70 comprises a title and logo area 70a, a navigation area 70b comprising a plurality of hypertext links to various active server pages described later herein, a body area 70c and a message log area 70d wherein one or more messages may be conveyed between or among, for example, a plurality of physicians 71 (FIG. 43) or an administrator, such as a group staff administrator for a physician's office. Note that the message log area 70d comprises a message area 70d1 i, a refresh link 70d2ii for refreshing the log, a clear log link 70d3iii for clearing the log, and an alert link 70d4iv that may be actuated or enabled by the user 14.

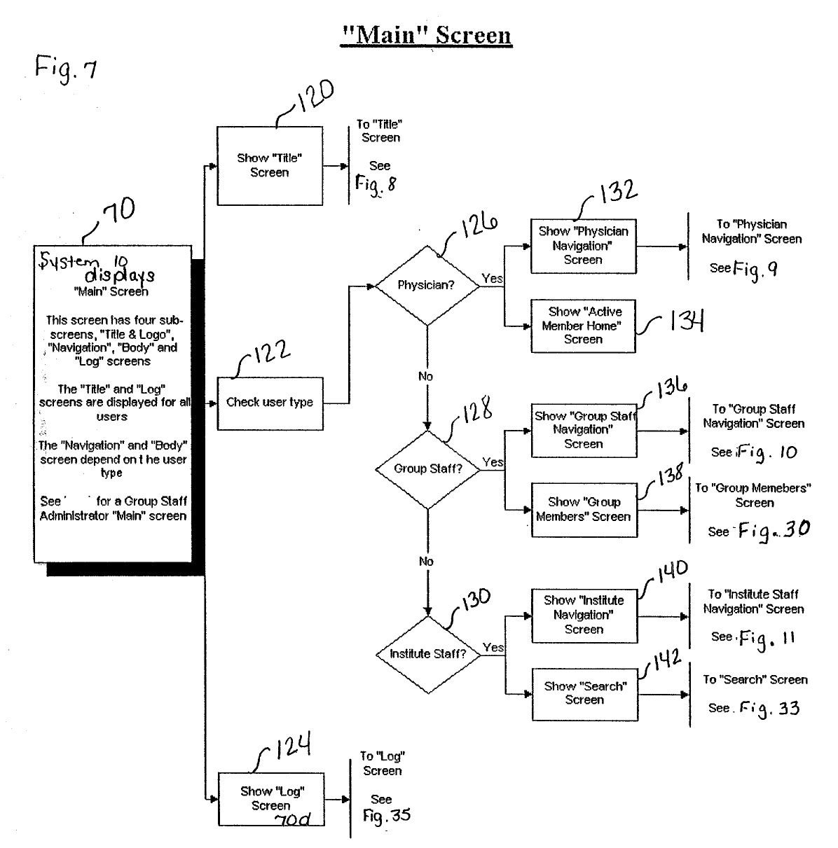

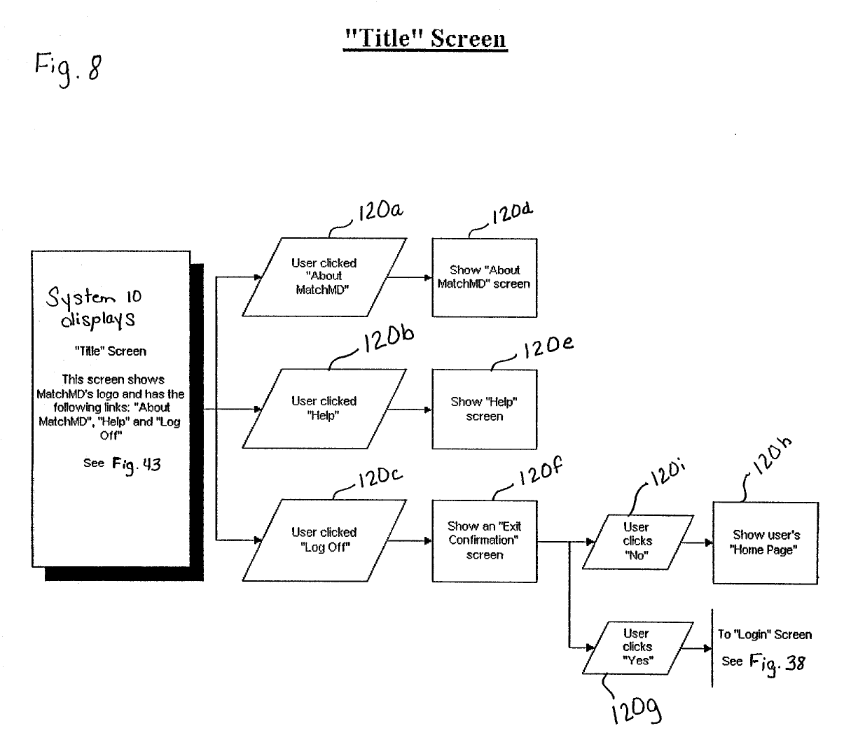

After the user 14 has logged in using the active server page 60 (FIG. 38), the host 12 displays (block 120 in FIG. 7) the main screen 70. As illustrated in FIG. 43, the host 12 displays the title area 70a of active server page 70 whereupon the user 14 is presented a plurality of links 70a1, 70a2 and 70a3. As illustrated in FIG. 8, if the user actuates the link 70a1 (FIG. 43) to the company (block 120a), then the routine proceeds to block 120d (FIG. 8) where information about the company is displayed. If the user 14 actuates (block 120b in FIG. 8) link 70a2 (FIG. 43), then the routine proceeds to block 120e (FIG. 8) where a help screen (not shown) is displayed to provide assistance to the user 14. If the user 14 actuates (block 120c in FIG. 8) the logoff link 70a3 in FIG. 43 then the routine proceeds to block 120f (FIG. 8) where an exit confirmation active server page (not shown) is displayed. This page provides the user with the option of selecting to confirm that the user 14 wishes to exit the website (block 120g), whereupon the host 12 displays the active server page 60 (FIG. 38). If the user 14 actuates a negative response to the exit confirmation (block 120i), then the routine proceeds to the user's 14 homepage (block 120h).

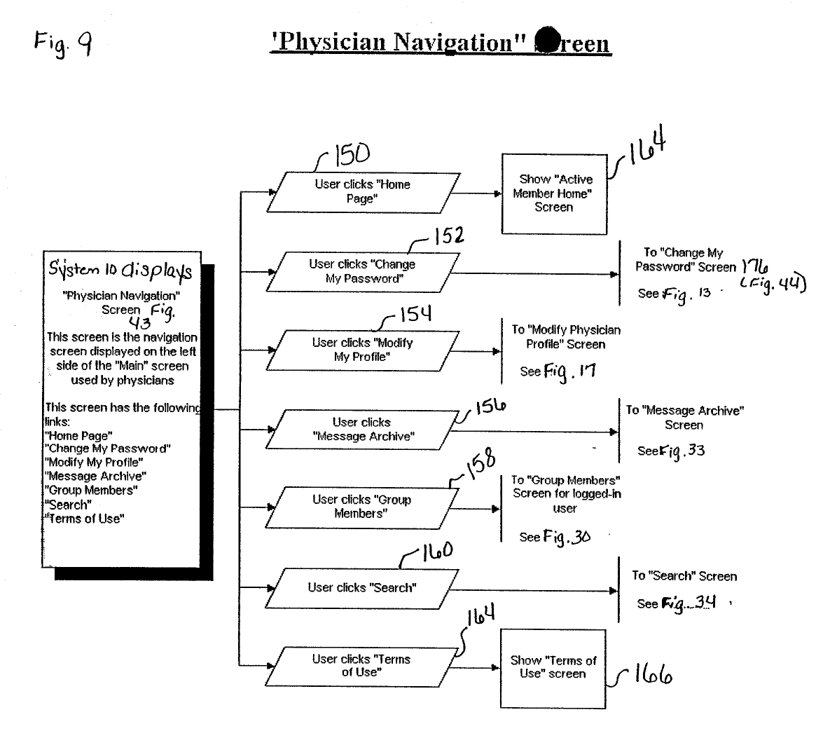

Referring back to FIG. 7, the host 12 determines (block 122 in FIG. 7) the type of user among a plurality of different types, such as a physician user, a group staff administrator user or an institute staff user, at the time of login based upon the user's 14 identification and password. Depending on the level of access to the system 10 and database 24 assigned, the host 12 will provide selected navigation links 70b. In this illustration, the link 70b for an administrator will comprise all links 70b1-70b10 (FIG. 43), while a physician user 14 may only be provided with links 70b1-70b5, 70b9 and 70b10. Thus, the system 10 can control the user's 14 level of access to the system 10 and database 24. Assuming in this illustration that the host 12 determines that the user 14 is a physician at decision block 126 (FIG. 7), then the host 12 displays (blocks 132 and 134 in FIG. 7) a physician navigation screen, which is similar to the screen 70 and the active member home screen (not shown). The routine then proceeds to FIG. 9 where the physician navigation active server page (screen 70, without links 70b6-70b8) is displayed.

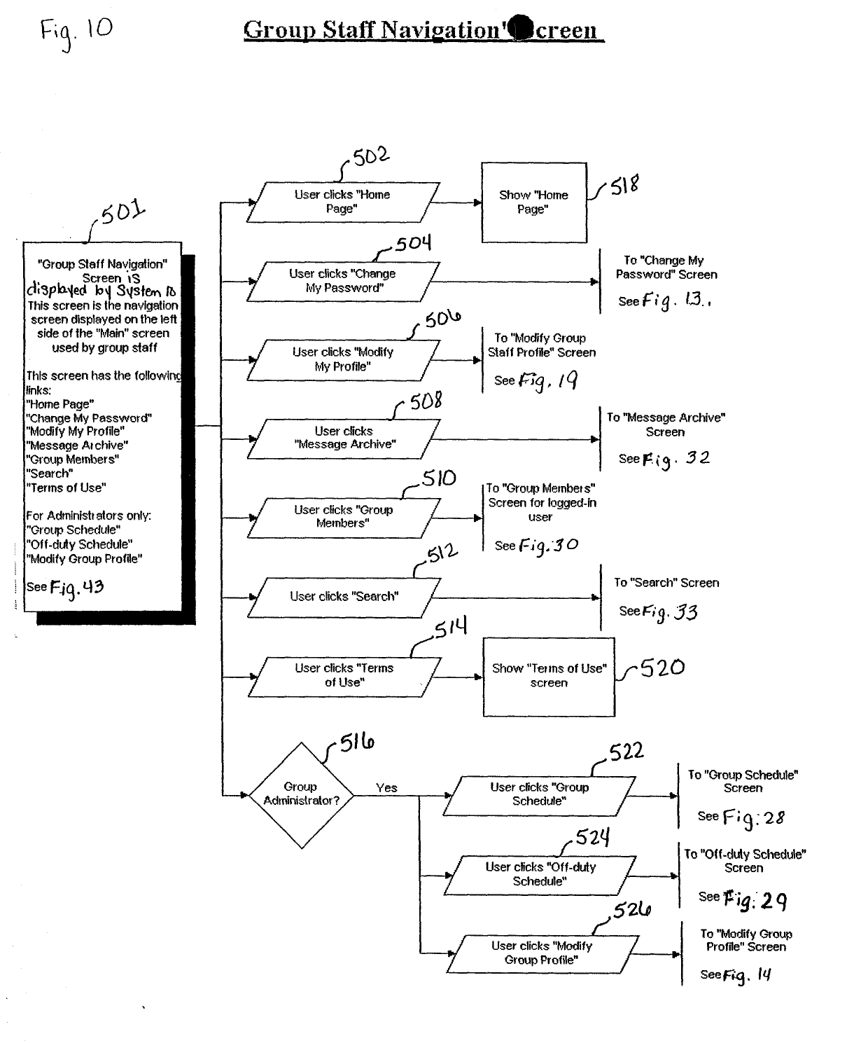

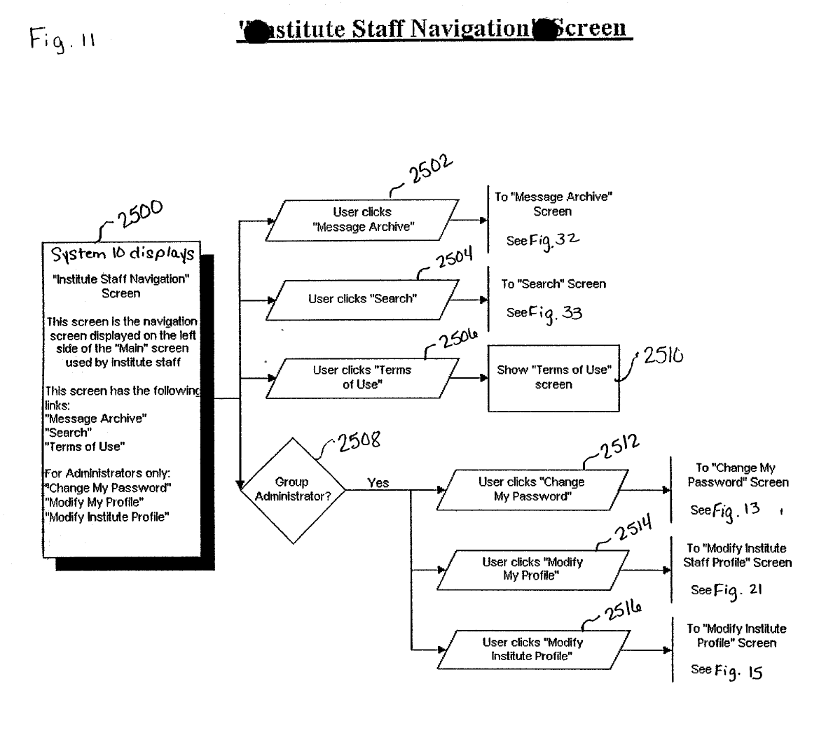

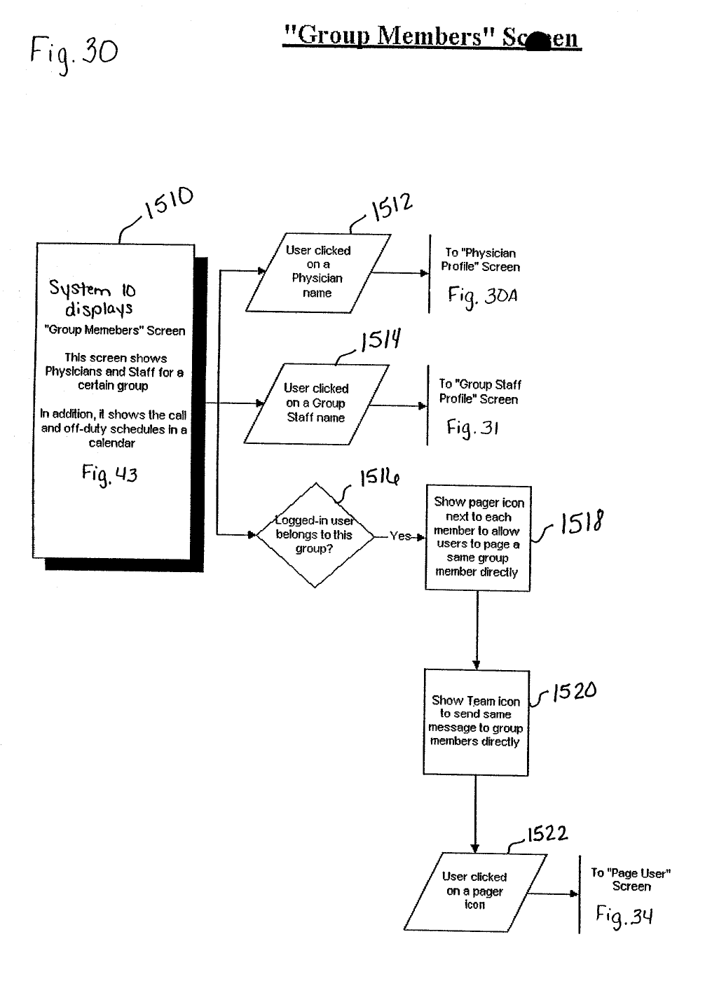

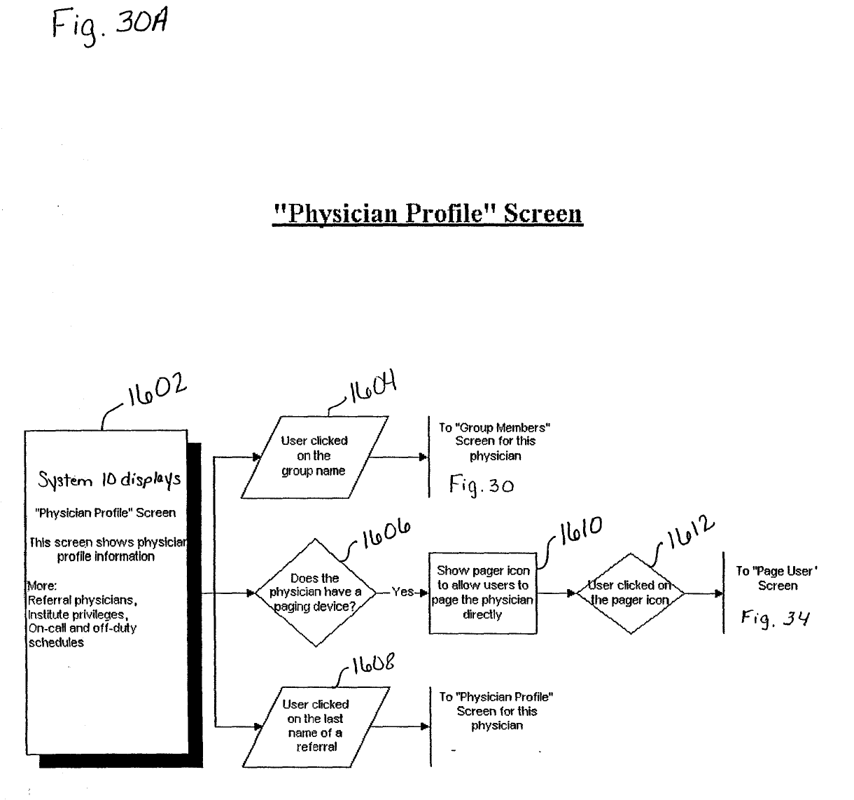

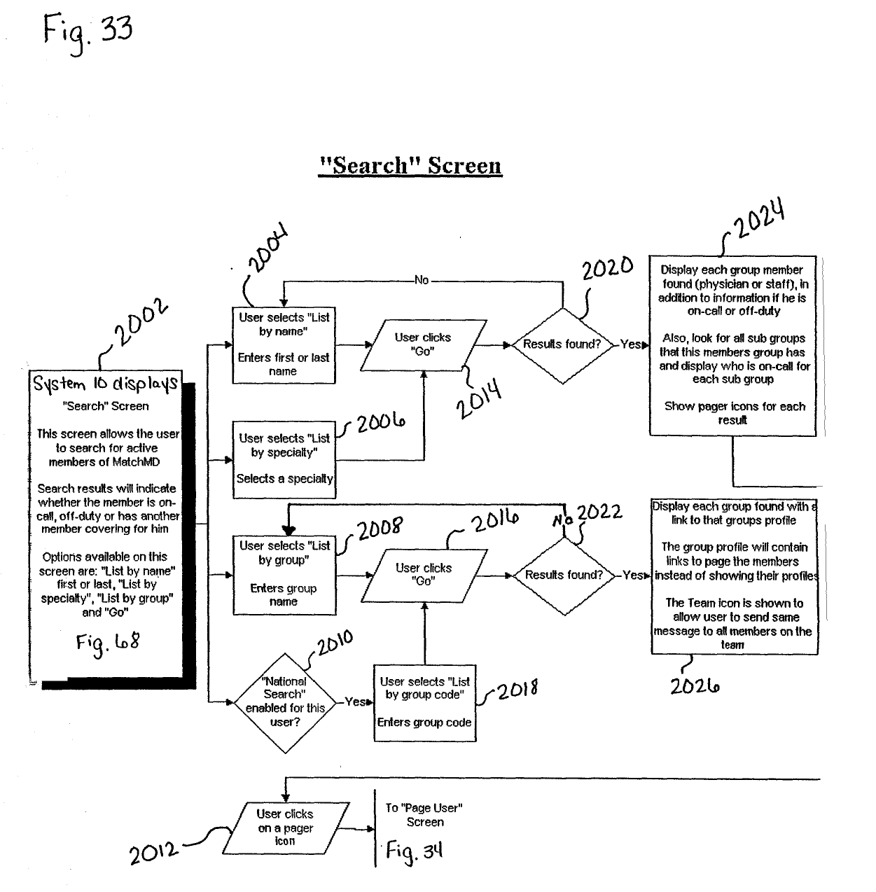

If the system 10 determines that the user is a group staff person (block 128 in FIG. 7), such as a nurse then system 10 displays (blocks 136 or 138 in FIG. 7) an appropriate group staff navigation screen 70 (FIG. 43) and follows the routines of either FIG. 10 or FIG. 30, depending on the type of user. If the system 10 determines that the user is an institute staff person (block 130 in FIG. 7), then system 10 displays (blocks 140 or 142 in FIG. 7) an appropriate group staff navigation screen 70 (FIG. 43) and follows the routines of either FIG. 11 or FIG. 33, depending on the type of user. These routines will be described later herein.

The screen 70 comprises the log area 70d (FIG. 43) which system 10 displays (block 124 in FIG. 7) which functions in accordance with the routine described in FIG. 35.

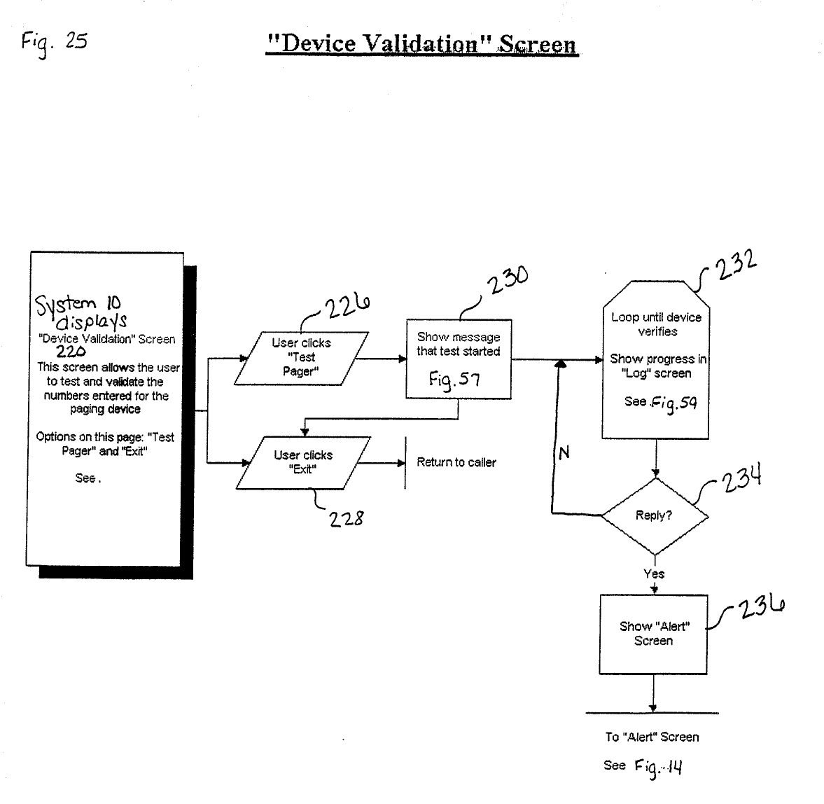

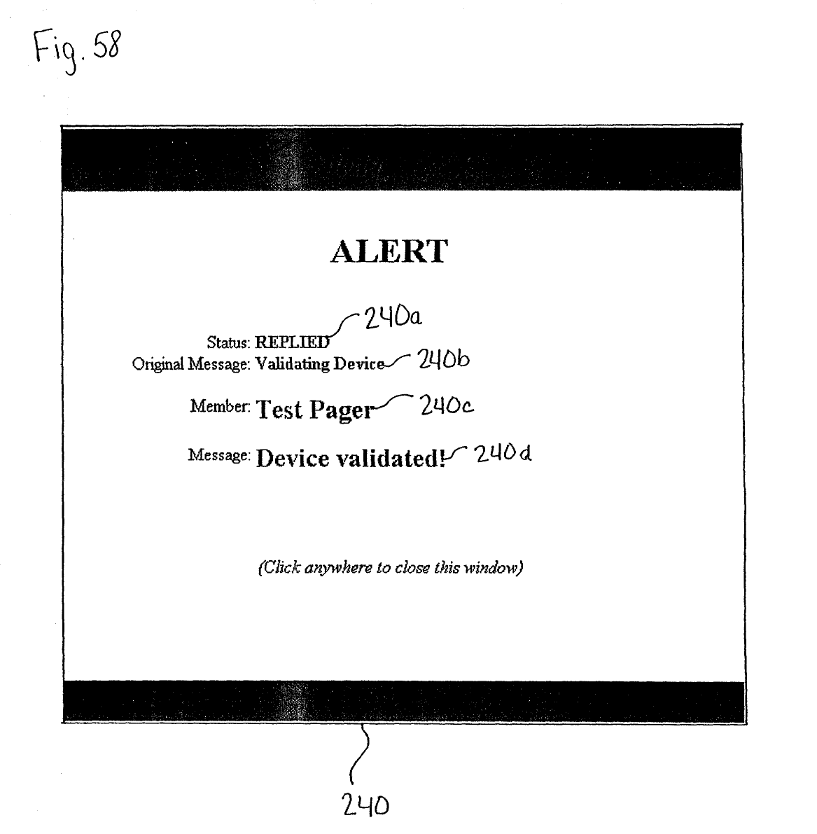

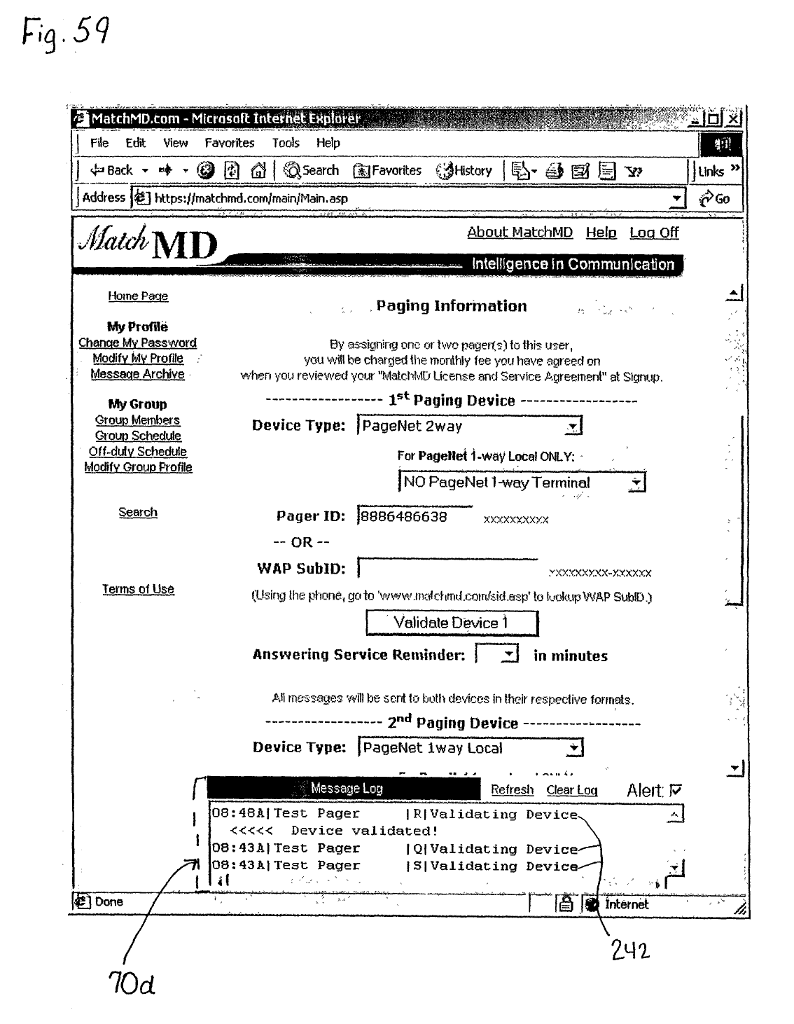

As best illustrated in FIG. 25 the host 12 displays the progress of the validation during the validation process at block 232 in FIG. 25. The validation information 242 (FIG. 59) is displayed in the “Message Log” area 70d as shown in FIG. 59. As indicated at block 232 in FIG. 25, the host 12 continuously loops until the device, such as a pager, verifies receipt of the message. If there is a reply (block 234 in FIG. 25), then the “Alert” screen 240 (FIG. 58) is displayed to communicate to the logged-in user that the device is validated.

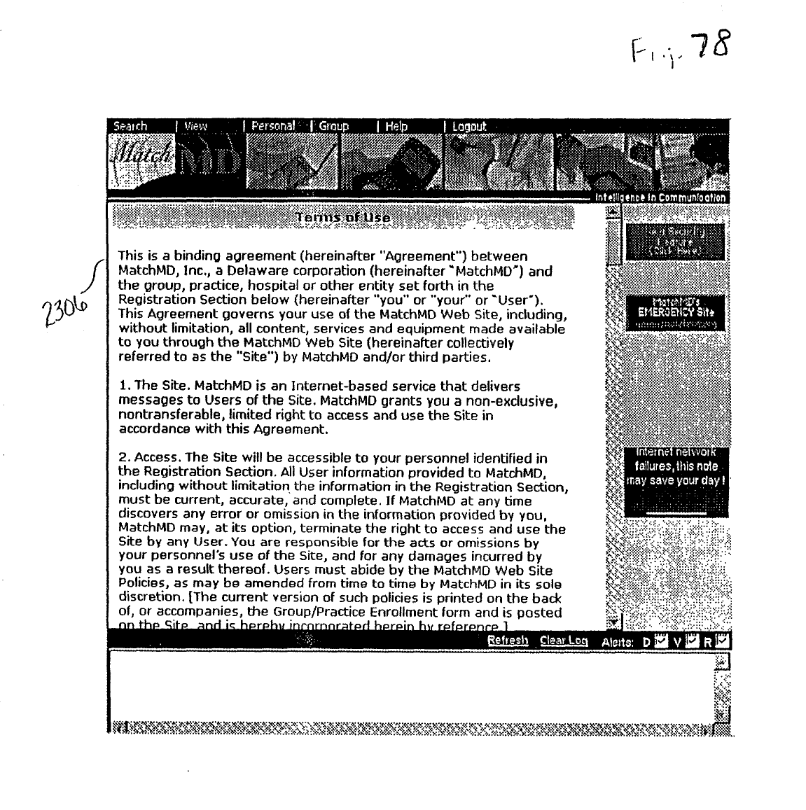

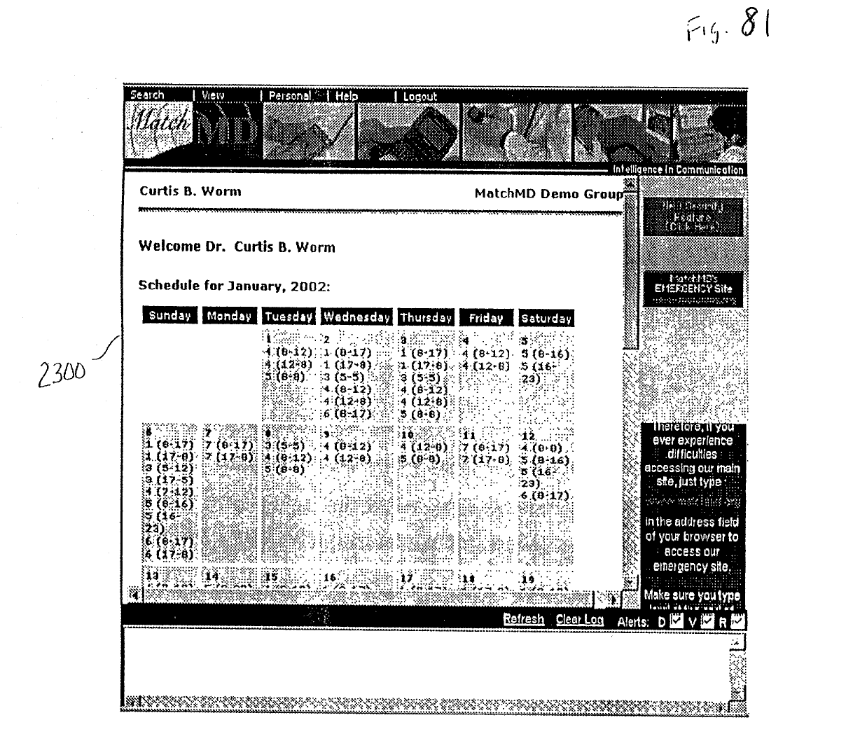

As best illustrated in FIG. 9, the system 10 causes a physician navigation screen 70 (FIG. 43) to be displayed if system 10 determines the user is a physician. As illustrated in FIG. 43, the active server page or screen 70 comprises the title 70a mentioned earlier herein and various active links to a “Home Page” 70b1, “Change My Password” link 70b2, “Modify My Profile” link 70b3, “Message Archive” link 70b4, “Group Members” link 70b5, “Search” link 70b9 and “Terms of Use” link 70b10. These links 70b1-70b10 may be actuated (blocks 150-162 in FIG. 9) in which case other active pages, such as an active member home screen 2300 in FIG. 81, which is the default page that the user gets when she goes to her home page or when she first logs on, and Terms of Use screen, which sets forth terms of use established by or programmed in the system 10 and as illustrated in active server page 2306 (FIG. 78), are displayed (blocks 164 and 166 in FIG. 9). Note in FIG. 9 that system 10 initiates other active servers pages and associated routines in response to the user activating the links referred to in block 152-160. If the user 14 selects (block 156) the message archive link, then the message archive screen is displayed. If the user 14 selects (block 150 in FIG. 9) the “Homepage” link, then an “Active Member” home screen 2300 is displayed at block 164 (FIG. 81). If the user selects (block 160) the search link, then a search screen is displayed. If the user selects (block 164) the terms of use link, then the terms of use page is displayed at block 166. Although links 70b1-70b10 have been shown in the embodiment being described, it should be appreciated that more or fewer links may be provided as desired.

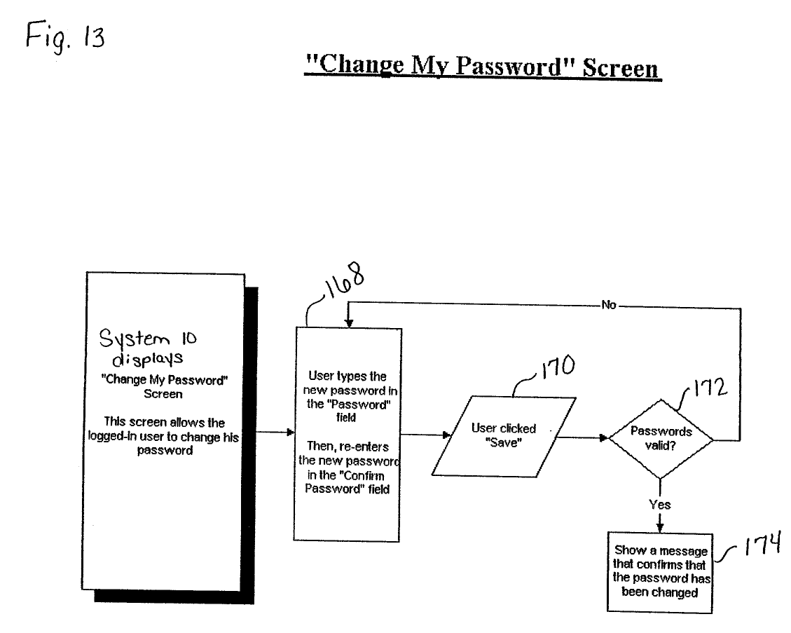

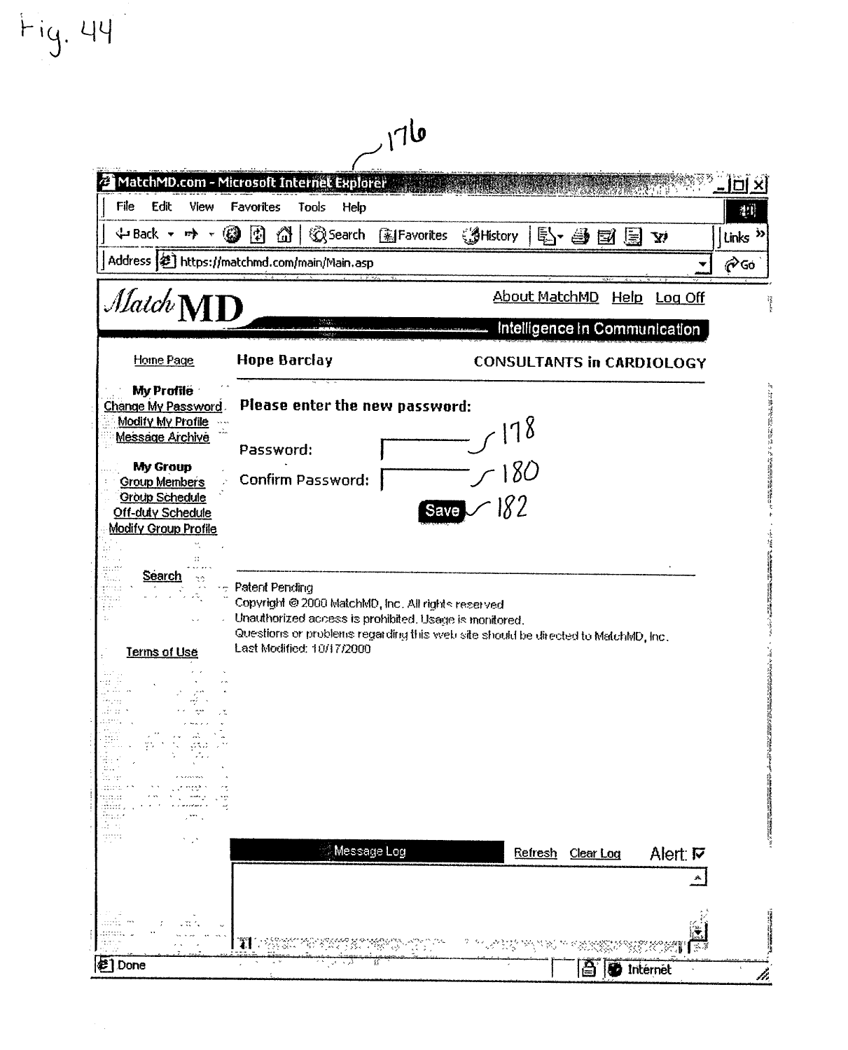

If the user selects (block 152) to change their password, then the routine proceeds to the routine shown in FIG. 13 and displays the active member home screen 176 (FIG. 44). After the screen 176 is displayed, the user enters (block 168 in FIG. 13) a new password in the area 178 (FIG. 44) and reenters the new password at area 180. As illustrated at FIG. 13, the user 14 proceeds to save the new password (block 170 in FIG. 13) by clicking the save button 182 (FIG. 44). The system 10 determines, at decision block 172 in FIG. 13, whether the new password is valid. If it is, then the routine proceeds to decision block 174 and the system 10 displays a message (not shown) that the password has been changed. If the decision at decision block 172 is negative, then the routine loops back to block 168 as shown.

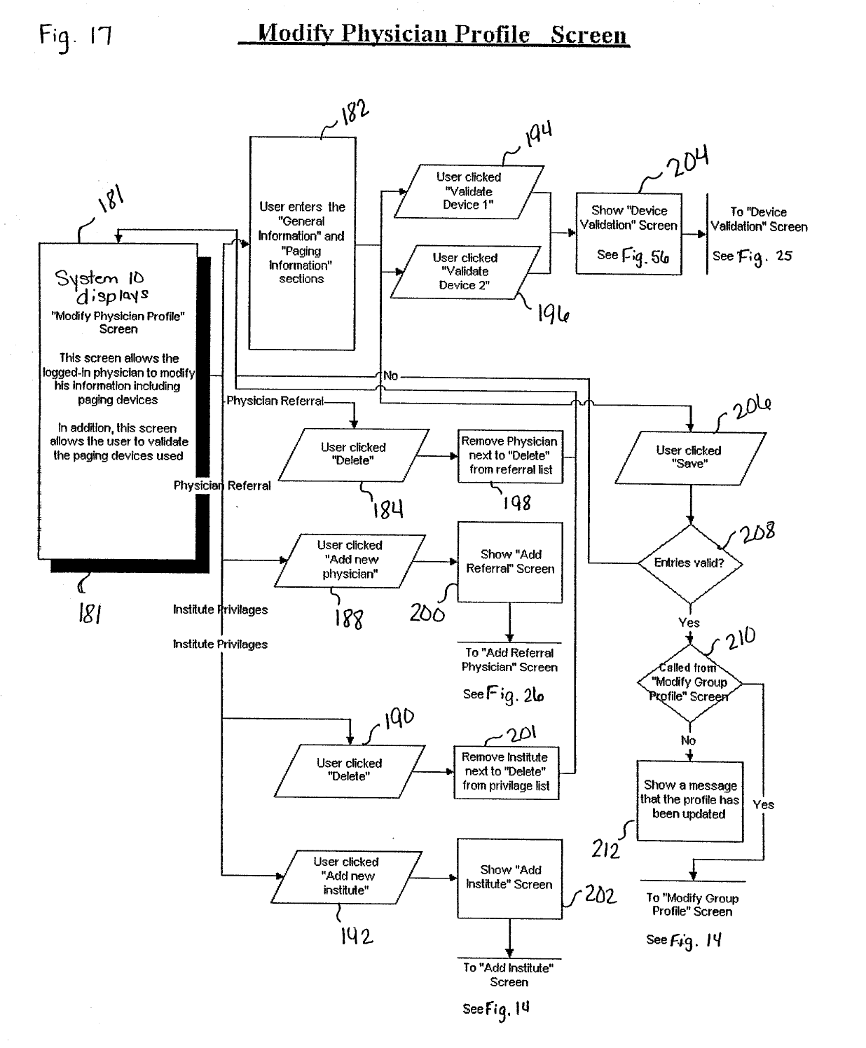

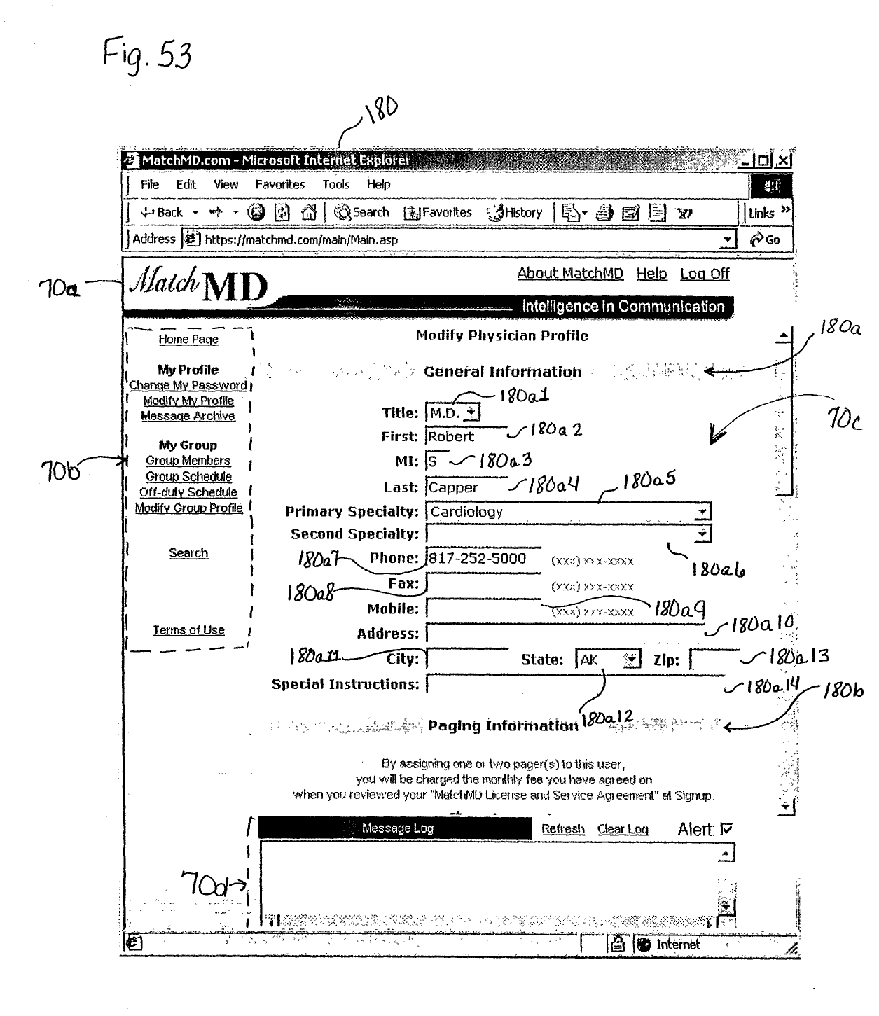

Referring back to FIG. 9, if the user 14 has selected (block 154) to modify their profile by actuating link 70b3 in FIG. 43, then the system 10 displays the screen 180 (FIG. 53) active server pages illustrated at FIGS. 53-55 which will now be described in relation to the routine shown in FIG. 17. In general, the active server pages 53-55 are displayed by system 10 at block 181 (FIG. 17) and enable the logged-in physician user 14 in the embodiment being described to modify (block 182 in FIG. 17) his user information including information relative to communications devices, such as paging devices 18 (FIG. 1). In addition, host 12 allows the user 14 to validate any paging devices 18 used to confirm that they are operating properly.

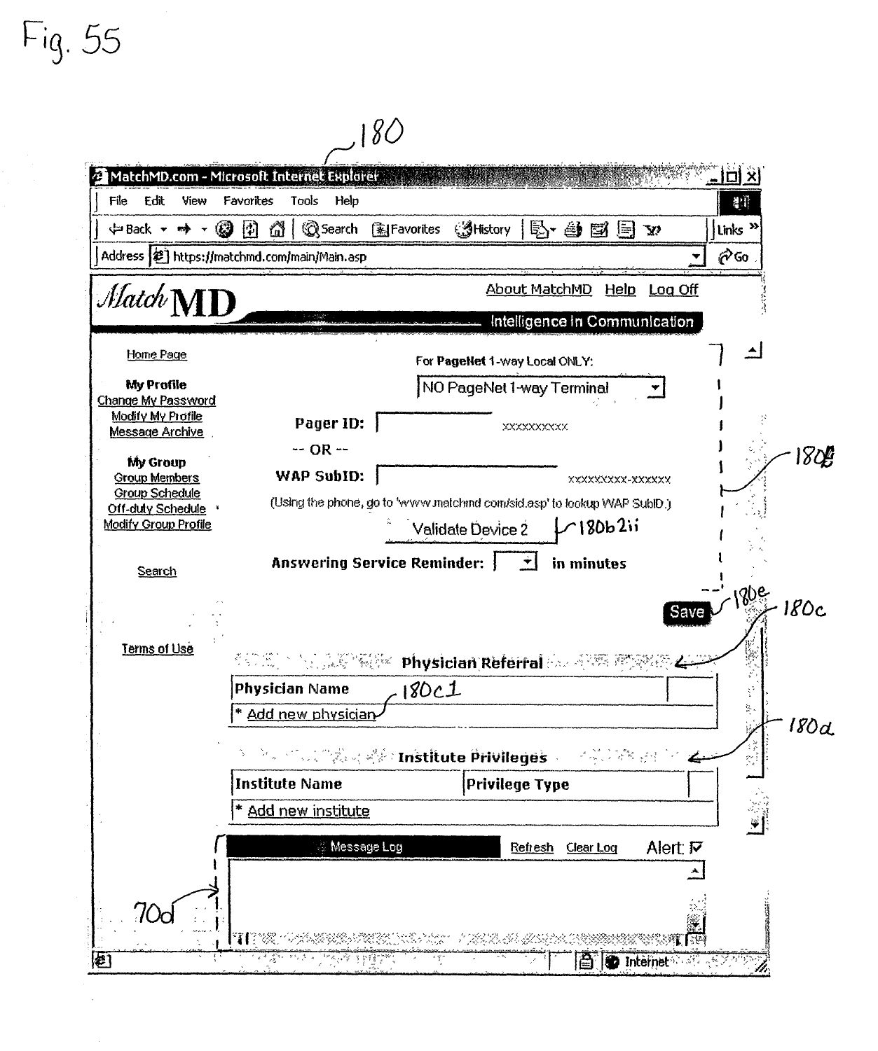

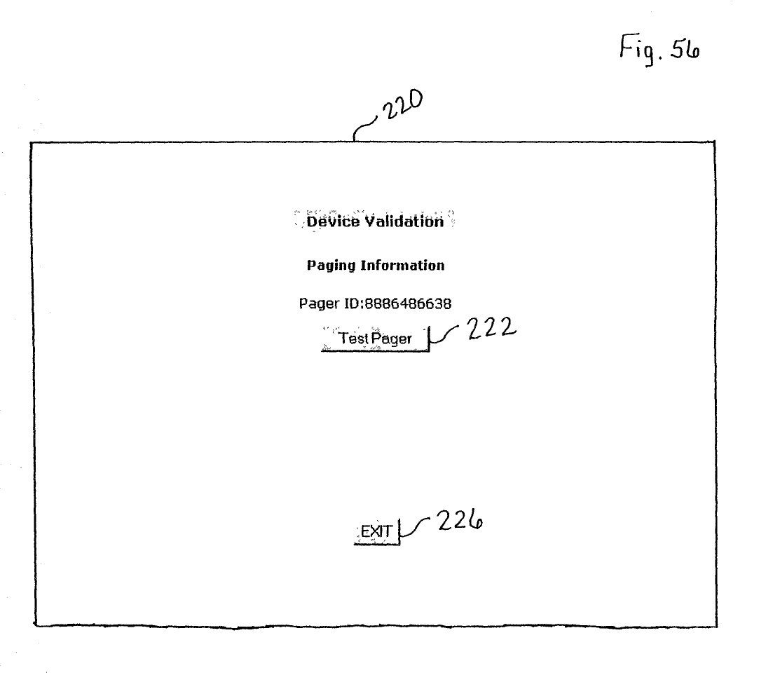

As can be seen from the illustration in FIGS. 53-55, the screen 180 comprises the active server page 70 comprising the title area 70a, navigation are 70b, body area 70c and message area 70d mentioned earlier. Note that the host 12 displays in body area 70c, a general information area 180a (FIG. 53), paging information area 180b (FIGS. 53-55), physician referral area 180c (FIG. 55), institute privileges area 180d (FIG. 55) and device validation area 180b2 (FIG. 56) in this illustration.

The general information area 180a presents the logged-in user 14, such as a physician, with the current information stored in database 24 for that user 14. In the embodiment being described, the general information area 180a comprises a title 180a1, first name 180a2, middle initial 180a3, last name 180a4, primary specialty 180a5, secondary specialty 180a6, phone number 180a7, fax number 180a8, mobile phone number 180a9, address 180a10, city, 180a11, state 180a12, zip code 180a13 and special instructions 180a14 input areas for the logged-in user to view, modify or add information relative to himself.

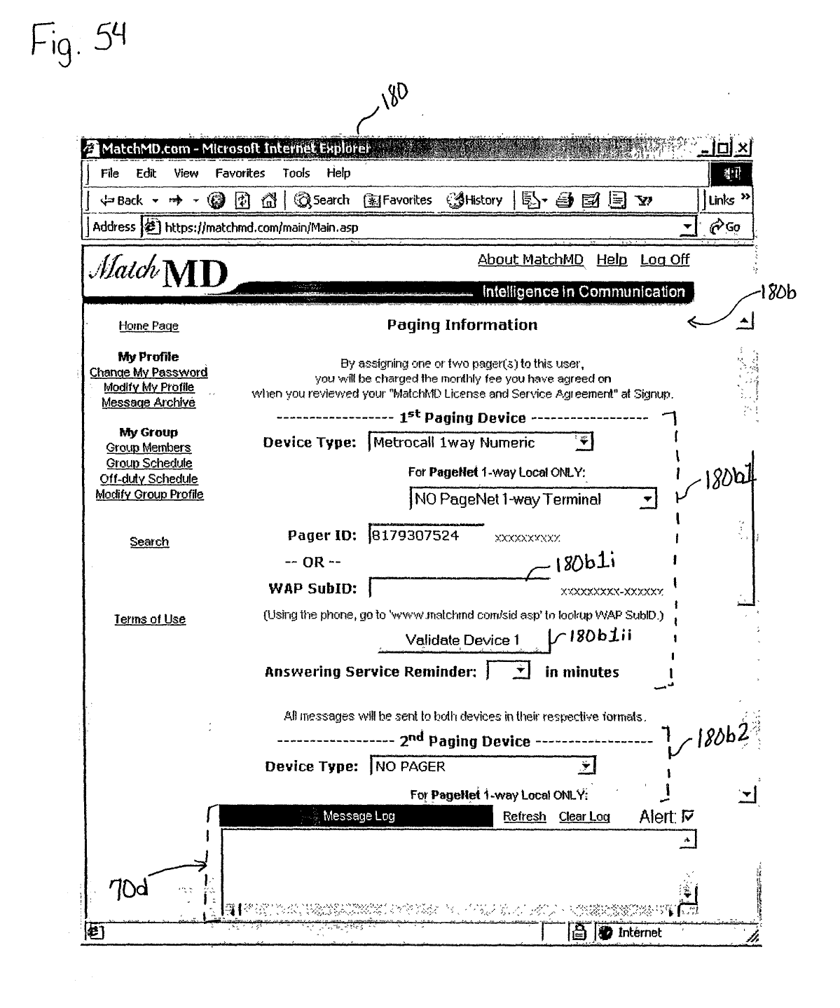

In the paging information area 180b (FIGS. 53-55), the user 14 is shown what, if any, paging or communication devices are assigned by system 10 to the user 14. By way of example, in the first paging device area 180b1 (FIG. 54), the user 14 is presented with the information relative to the user's 14 communication device, such as a pager 18.

In the illustration shown in FIG. 54, a Metrocall 1way Numeric pager is illustrated as being assigned to the logged-in user, Dr. Robert S. Capper, whose name appears in FIG. 53. The user's 14 pager identification number (8179307524 in the illustration shown in FIG. 54) is also displayed. It should also be appreciated that a wireless application protocol (WAP) identification number may also be assigned to the user 14 in the area 180b1i.

It should be appreciated that the logged-in user 14 may add, modify or change the information relative to a paging device in the area 180b1 or add or assign a second paging device in the area 180b2 (FIGS. 54-55). As mentioned earlier herein, the invention facilitates enabling the users of the system 10 to communicate with network carriers using the wireless communication transfer protocol (WCTP) or the wireless application protocol (WAP), which capitalize on the HTTP and HTTPS Internet protocols.

Returning to FIG. 17, if the user 14 elects to validate the operation of one or more of the paging devices 18, then the user 14 actuates the appropriate validate device link 180b1ii (FIG. 54) or 180b2ii (FIG. 55), respectively. Upon actuation of the validation links 180b1ii (block 194 in FIG. 17) or 180b2ii (block 196 in FIG. 17), the system 10 displays (block 204 in FIG. 17) the device validation screen 220 (FIG. 56) whereupon the user is presented with the test pager link 222 and exit link 224 for exiting the validation procedure. If the user actuates the test pager link 222 in FIG. 56, then the system 10 begins a validation procedure which will now be described relative to FIG. 25.

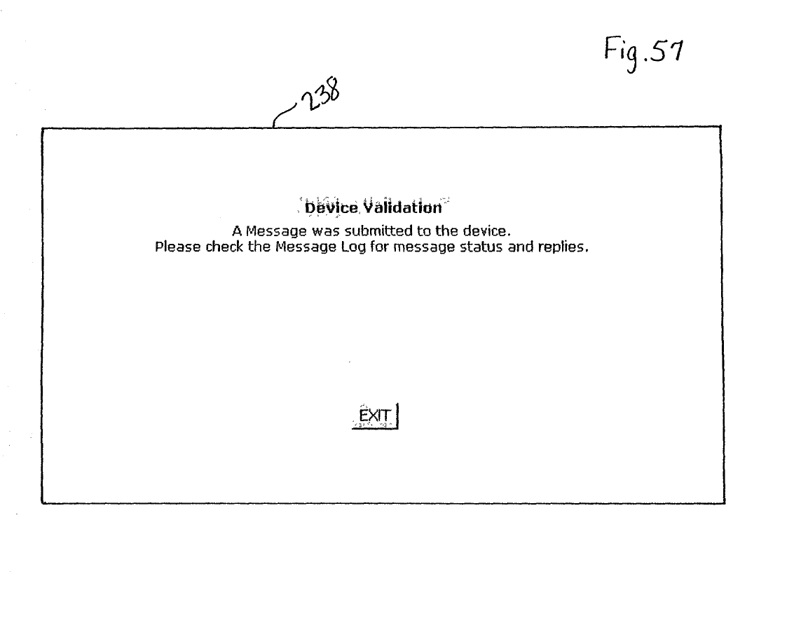

As illustrated in FIG. 25, the user 14 elects to either test the communication device 18 (block 226) or exit the validation procedure (block 228). If the user 14 elects to test the communication device 18 at block 226, then the routine proceeds to display a test validation screen 238 (FIG. 57) at block 230 in FIG. 25. At block 232 in FIG. 25, the system 10 communicates to the communication device 18 (FIG. 1). It should be understood that during this procedure, the system 10 displays progress information in the message log area 70d as best illustrated in FIG. 59 where the device 18 being tested is listed along with validation information 242 relative to the status of the validation.

The routine proceeds to block 234 (FIG. 25) where it is determined whether the communications device 18 has replied to the test pager query and if it has, to display (block 236) an alert screen 240 (FIG. 58) which provides status information 240a, original message request information 240b, member information 240c and a message 240d relative to the device being tested, such as whether the device was validated or whether the validation failed. It should be appreciated that if the system 10 does not receive a reply at block 234, then the routine loops until the device is validated. After the validation procedure for one or more of the communication devices 18 is selected, the user may click anywhere in the screen 240 (FIG. 58) at which time the system 10 again displays the “Modify Physician Profile” active server page 180 (FIGS. 53-55).

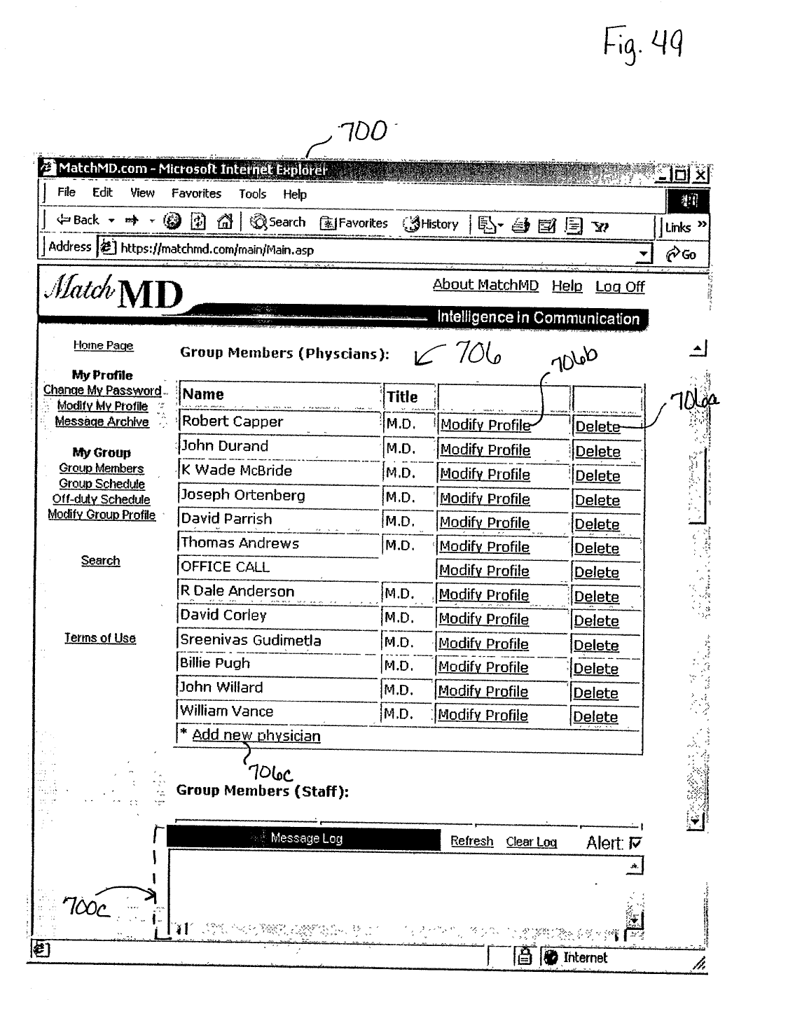

Referring back to FIG. 17, the logged-in user 14 may, in the physician referral area 180c (FIG. 55), add a reference to other physicians or persons to whom the logged-in user 14 wishes to refer patients, doctors or other persons. Although not shown, the logged-in user 14 may also delete physicians (block 184 in FIG. 17) in which case the physician listed in the physician referral area 180c (FIG. 55) is deleted from the referral list. It should be appreciated that the physician referral list will typically provide a listing of other physicians or persons (not shown) in the physician referral area 180c in FIG. 55, along with an adjacent delete command similar to the type illustrated in FIG. 49 and described later herein.

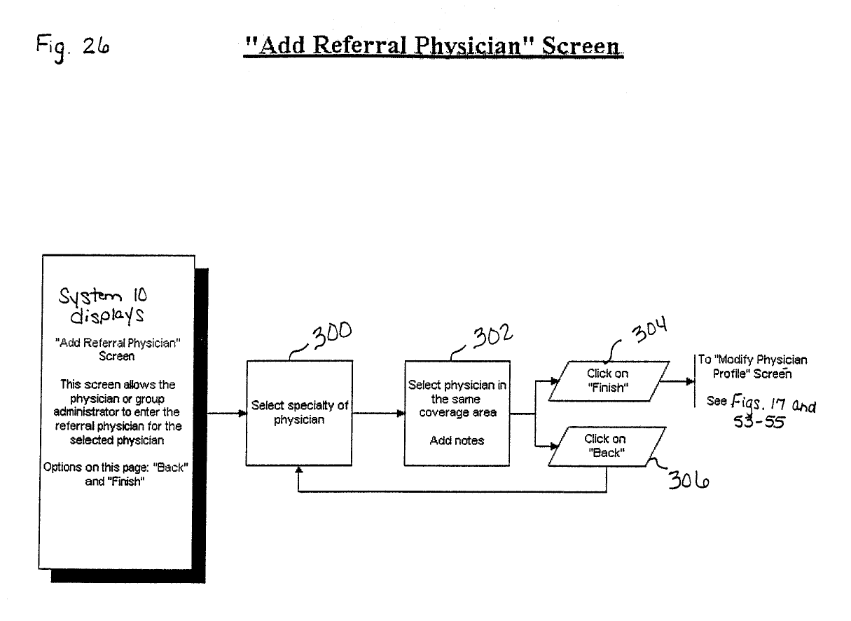

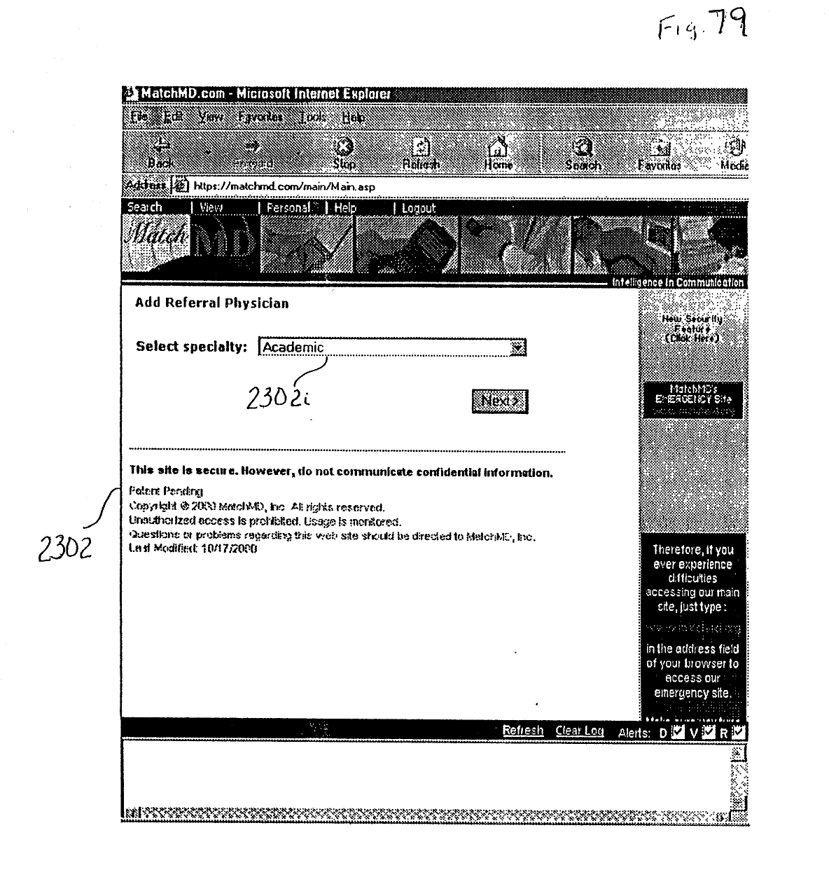

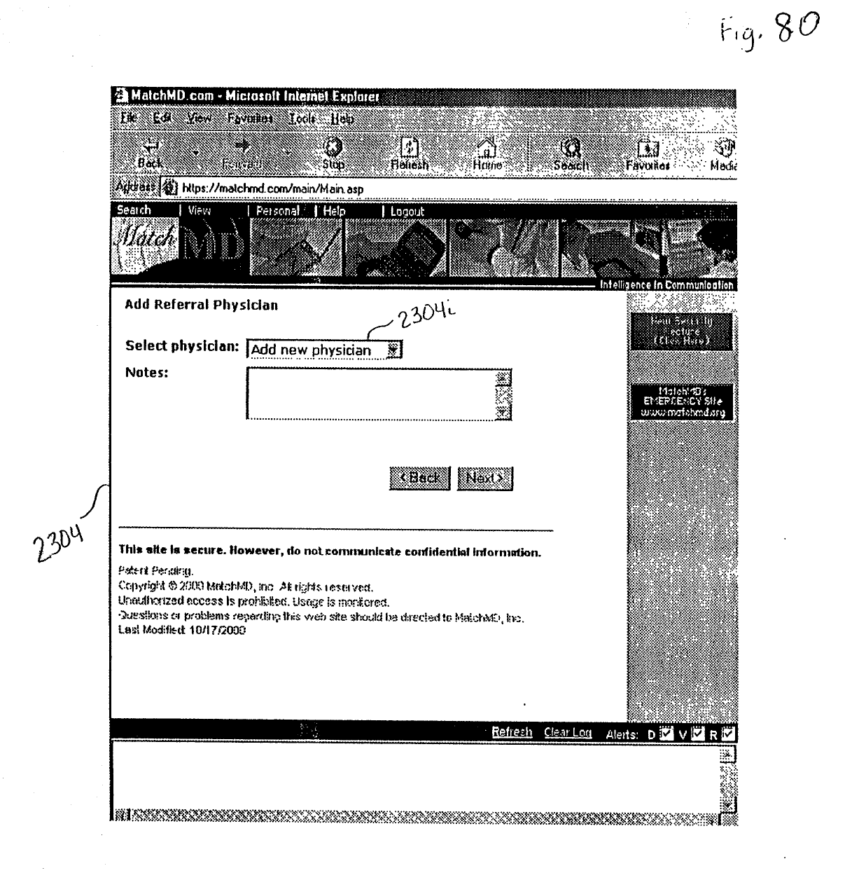

After the user 14 has deleted or modified the information in the physician referral area 180c in FIG. 55 (block 198 in FIG. 17), the routine proceeds to the top of the active server page or screen 180 where the general information area 180a and paging information area 180b are again displayed. As indicated at block 188 in FIG. 17, if the user 14 desires to add a new physician or person to the physician referral list saved for the logged-in user 14, then the user 14 selects the ADD NEW PHYSICIAN link 180c1 (FIG. 55), the system 10 displays (block 200 in FIG. 17) the ADD REFERRAL active server page or screen 2302 and 2304 in FIGS. 79 and 80, respectively. The routine then proceeds to the ADD REFERRAL PHYSICIAN routine which will now be described relative to FIG. 26. Note that screen 2302 (FIG. 79) and 2304 (FIG. 80) comprise the pull-down menus 2302i and 2304i for enabling the user to add a physician and a specialty. It should be appreciated that the system 10 uses the active server page 180 illustrated in FIGS. 53-55 to enable the user 12 to add or modify a physician profile (FIGS. 53-55).

The routine begins at block 300 where the specialty for the physician to be added to the logged-in user's 12 referral list is selected with the pull down menu and a physician in the same geographic coverage area for that specialty is selected at block 302. Thereafter, the routine proceeds to either block 304 or 306 where the logged-in user 12 actuates a finish command whereupon the system 10 again displays the modified physician active server page or screen (FIGS. 53-55). If the user selects the back button (block 306 in FIG. 26), then the routine returns to block 300 as shown.

Thus, it should be appreciated that each logged-in user 14 may identify in a logged-in user specific referral list one or more other physicians who are categorized by specialty of practice so that other logged-in user is provided with a referral list of other physicians to whom that physician desires to refer patients.

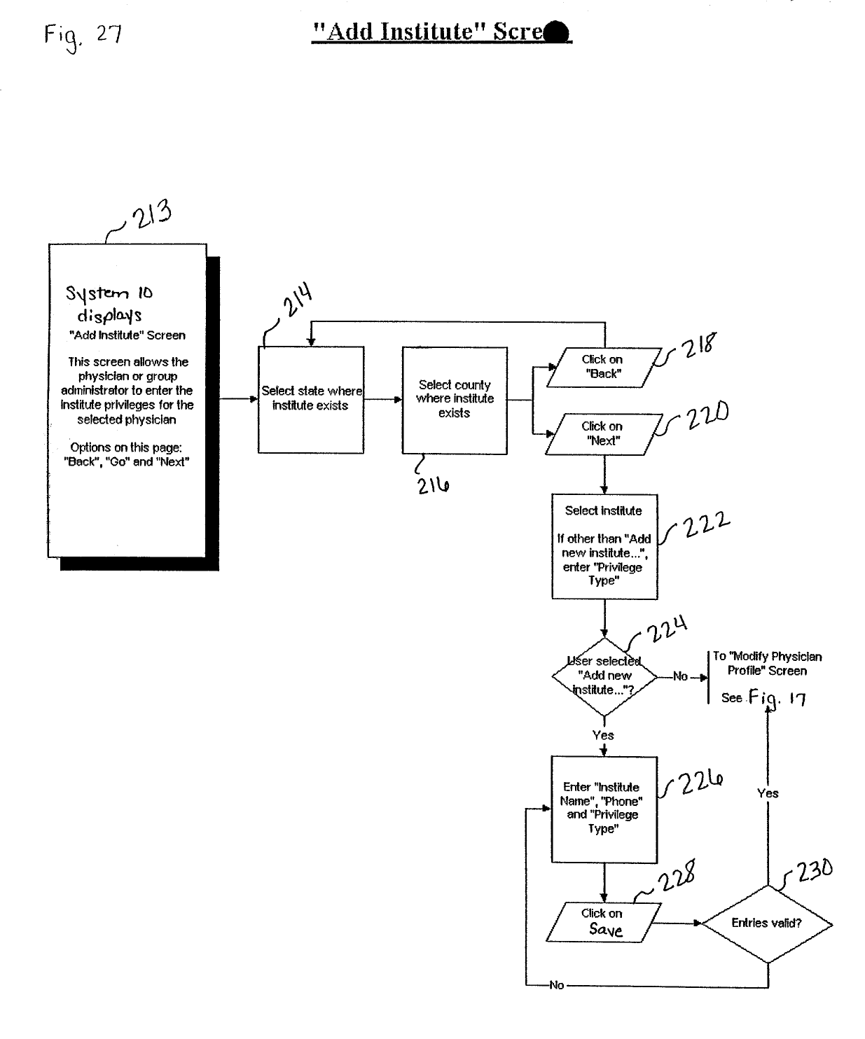

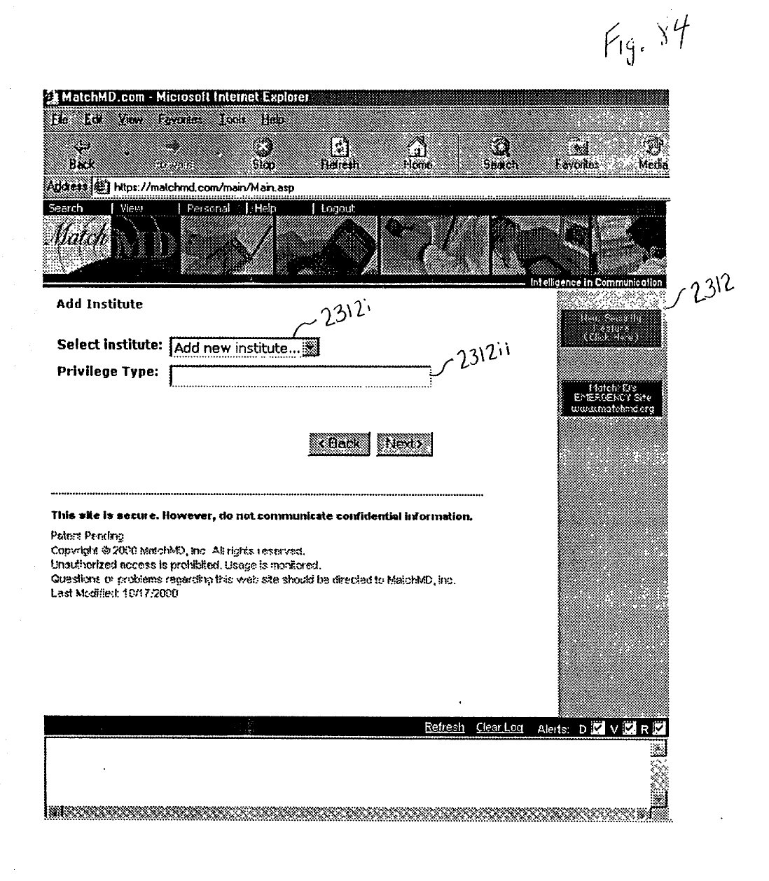

Referring back to FIG. 17 and associated FIG. 55, the logged-in user 14 may identify institute privileges for the person identified in areas 180a2-180a4 (FIG. 53) in the institute privileges area 180d. In the embodiment being described, the institute privileges include a reference to the institute name, such as a hospital name, and the type of privileges that the logged-in user has with respect to that institute. As illustrated in FIG. 17, the logged-in user 14 may elect to add a new institute to which the user has privileges (block 192 in FIG. 17) in which case an “Add Institute” page or screen 2312 (FIG. 84) is displayed (block 202) by system 10. If the logged-in user 14 selects the add new institute button, then the routine proceeds to the add institute screen 2312 (FIG. 84) which allows the logged-in user 14 to enter the institute privileges for the selected physician, in accordance with the routine illustrated in FIG. 27 which will now be described.

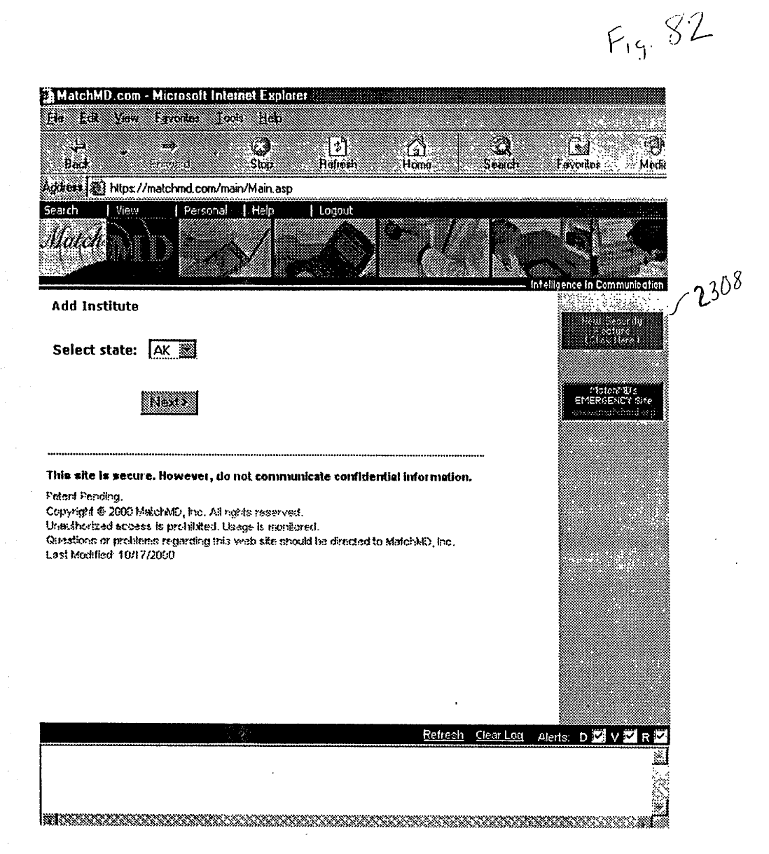

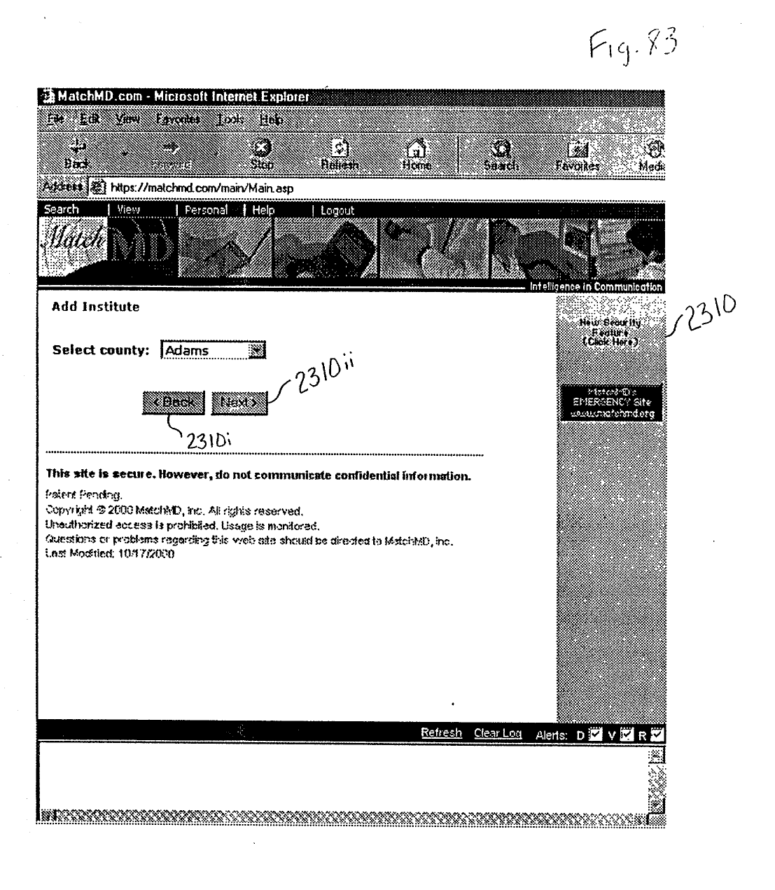

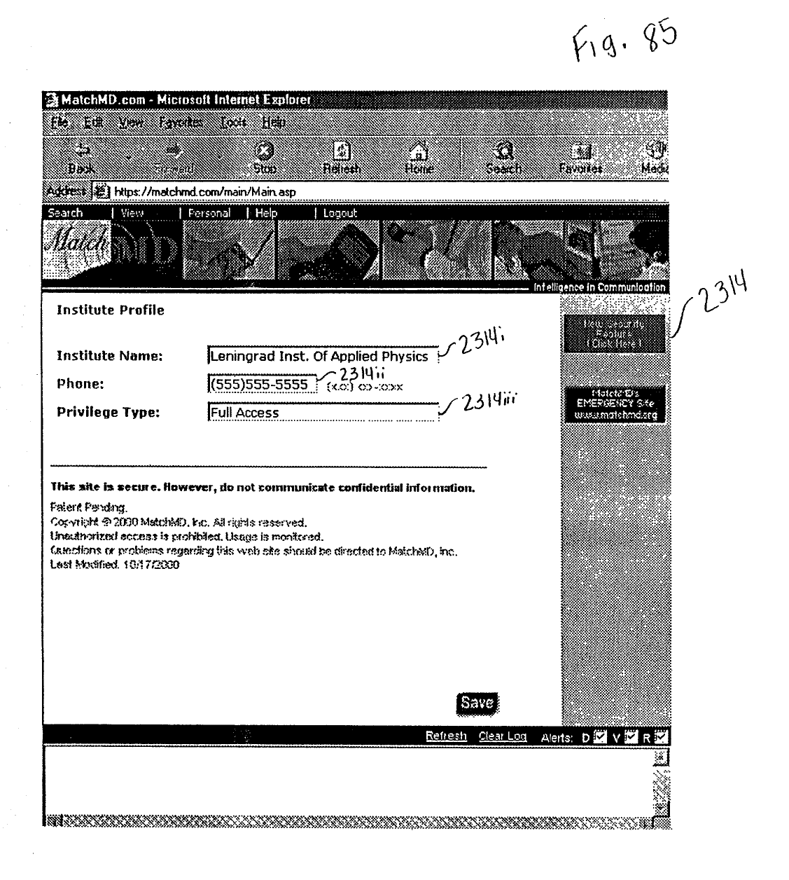

The routine begins at block 213 where the system displays the “Add Institute” screen 2308 (FIG. 82) and the user 14 selects a state (block 214 in FIG. 27) where the institute is geographically located. At block 216, the system 10 displays screen 2310 (FIG. 83) in response and the logged-in user selects the county where the institute exists. The logged-in user 14 may then select either the “back” button 2310i (block 218) in which case the routine loops back to block 214 as shown or the “next” button 2310ii (block 220), whereupon the screen 2312 (FIG. 84) is displayed and the user then selects an institute (block 222) from the pull-down menu 2312i. The user may then identify for the particular logged-in user the institute privileges (at area 2310ii in FIG. 84) for the selected physician. The user may also actuate an “add new institute” button at block 222. It is determined at decision block 224 whether the user has selected the add new institute button and if he has not, the system 10 displays the modified physician screen (FIGS. 53-55) and returns to the routine described relative to FIG. 17. If it is determined that the user has selected the add new institute button (decision block 224 in FIG. 27), then the system 10 displays screen or active server page 2314 (FIG. 85). The user enters the institute name, phone and privilege type information in the areas 2314i, 2314ii and 2314iii, respectively, for that institute (block 226 in FIG. 27) and then actuates (block 228) a save button. The system 10 then determines (block 230) whether the entries entered by the user are valid, which means that all the information is filled in the areas 2314i-2314iii. If they are valid, then the routine returns to the routine described earlier herein relative to FIG. 17 and system 10 displays the modify physician profile screen (FIGS. 53-55). If the decision at decision block 230 is negative, then the routine loops back to block 226 as shown.

Returning to the active server page 180 (FIGS. 53-55), after a user 14 has added or modified information relative to referral physicians, institute information and privilege information for a particular institute, the user is provided with the ability to delete a particular institute and associated privileges, such as medical privileges, at blocks 190 and 201 (FIG. 17), whereupon system 10 removes the institute selected to be deleted from the physician's privilege list. Thereafter, the routine proceeds to Modify Physician Profile screen 180 (FIGS. 53-57), whereupon the system 10 again displays the general information area 180a and paging information 180b at the beginning of the screen 180 shown in FIGS. 53-55.

Thus, it should be appreciated that a logged-in user may add, modify or edit profile information for a particular individual, such as a physician. In the embodiment being described, different privileges for adding, modifying or deleting information stored by system 10 may be provided to different logged-in users as mentioned earlier. For example, a group administrator for a group of physicians may be given full access privileges while an individual physician may be given access privileges, with respect to only his or her profile information. Still another category of users of the system 10, those who are not logged-in as either a group administrator or physician, may be given privileges that permit read-only access to selected information stored in the database 24. In the embodiment being described, there are three levels of access. User level access allows a user to access only information in database 24 relevant to that user. Group administrator access permits the logged-in user to access everyone's profile and information in the group. Institute members are users who only have capabilities of reading e-mails, sending mail and pages to Group members, and searching. Institute members cannot, for example, page or message a person that only has institute privileges. Of course, other levels of access privileges may be defined.

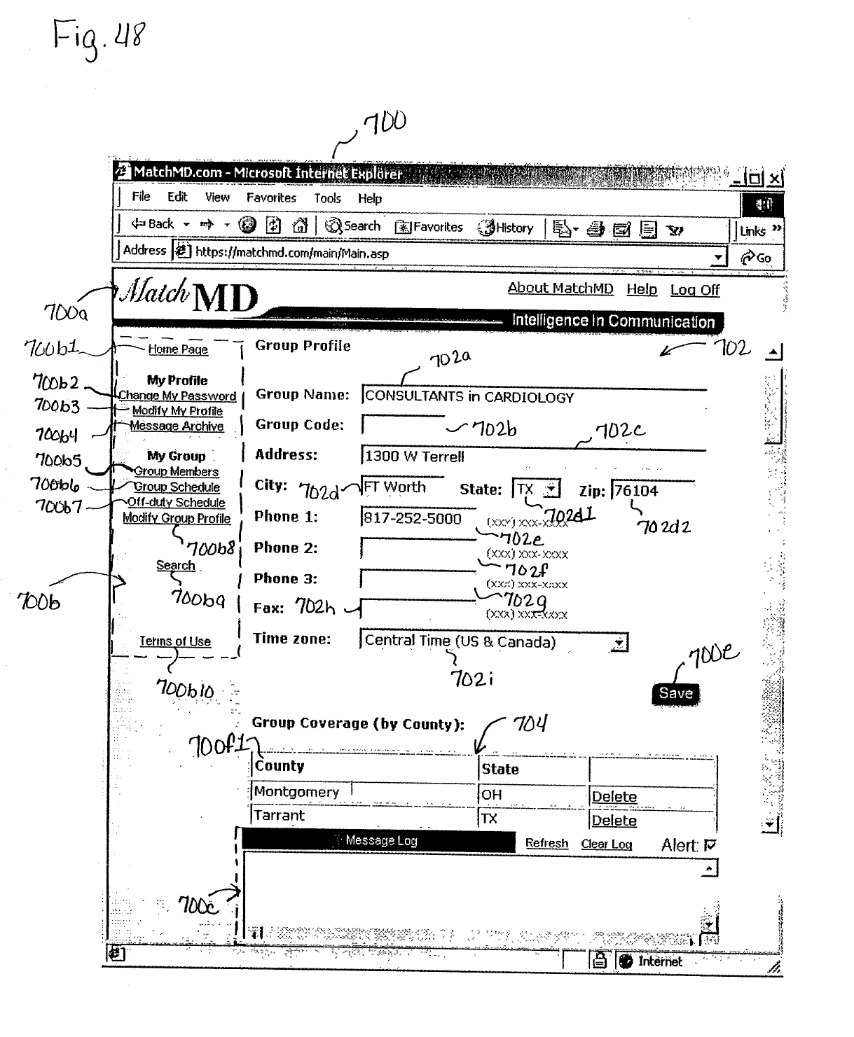

After the logged-in user has performed all desired additions, modifications and deletions, the user selects (block 206 in FIG. 17) the save button 180e (FIG. 55) which saves the information in the system 10 database 24. At decision block 208 (FIG. 17), the system 10 determines whether the entries selected by the user are valid and if they are not, the routine loops back to the Modify Physician Profile screen 180 (FIGS. 53-55) as shown, whereupon the system 10 displays the general information area 180a and paging information are 180b (FIGS. 53-54). If the entries are valid (block 208 in FIG. 17), then the routine proceeds to decision block 210 where it is determined whether the Modify Physician Profile screen 180 was called from the “Modify Group Profile” screen 700 (FIGS. 48-52) described later herein. If it was not, then system 10 displays (block 212 in FIG. 17) a message that the profile has been updated. If it was called from the “Modify Group Profile” screen 700, then the routine proceeds to the “Modify Group Profile” screen 700 (FIGS. 48-52) described later herein.

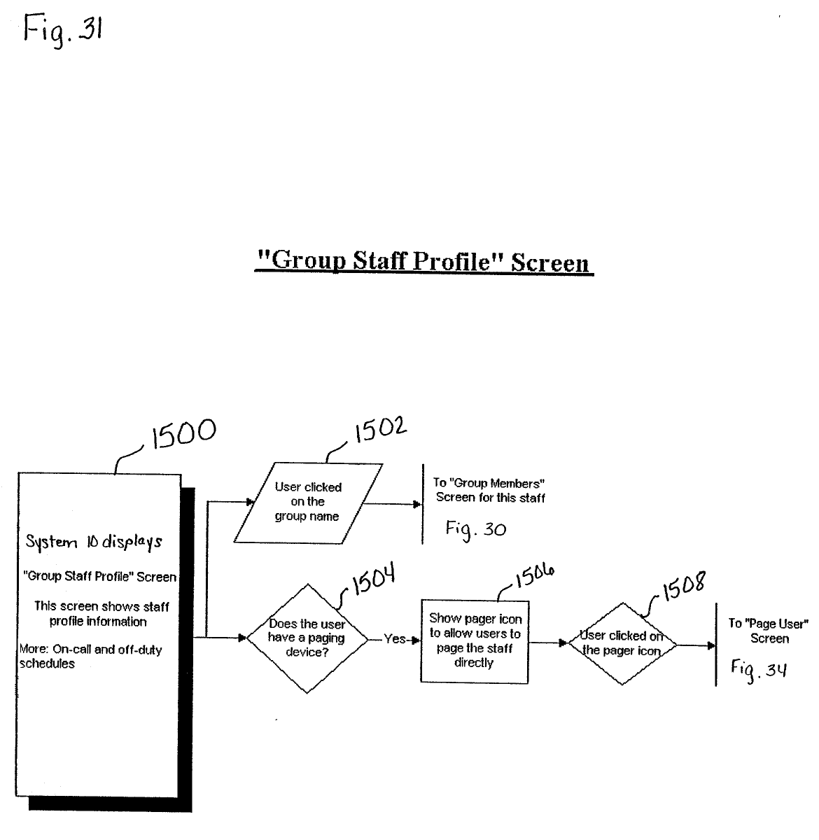

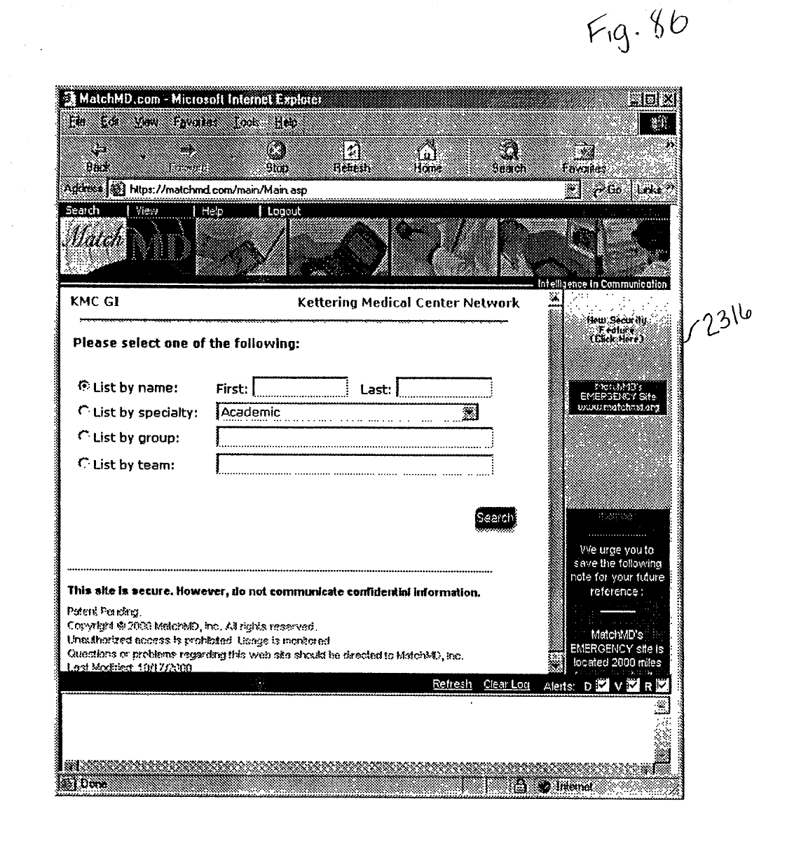

Referring back to FIG. 7, if the system 10 determines that the user is an Institute Staff Member (block 130 in FIG. 7), then the routine displays the Institute Navigation screen 2316 (FIG. 86) (block 140 in FIG. 7). This screen 2316 displays or lists an institute's name, instead of a group name or individual profile, and the search screen (block 142). The routine proceeds in accordance with the routine described relative to FIGS. 11 and 31. The routine shown in FIG. 31 was described earlier herein, and the routine illustrated in FIG. 11 will now be described.

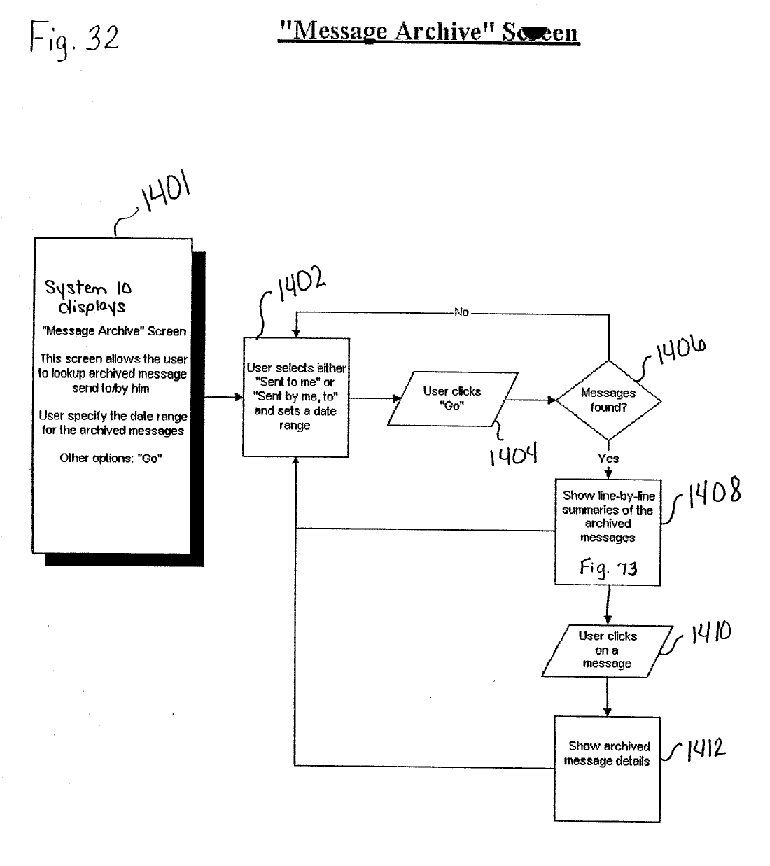

The system 10 displays (block 2500 in FIG. 11) the Institute Staff Navigation screen 2316 (FIG. 86) which is a screen similar to the screen shown in FIG. 43, except that the links 70b5-70b8 are not included. In the embodiment being described, it is envisioned that this level of access is intended for staff members only, as opposed to group administrators who have access to all links 70b1-70b9. As illustrated in FIG. 11, the user 14 may select the Message Archive link 70b4 (block 2502), Search link 70b9 (block 2504) or Terms of Use link 70b10 (2506) in which case the routine proceeds to the routines or screens shown relative to FIGS. 32 and 33 and the Terms of Use screen (block 2510), respectively.

If system 10 determines (block 2508 in FIG. 11) that the user 14 is a group administrator, then the Change My Password link 70b2 (FIG. 43), Modify My Profile link 70b3 and Modify Group Profile link 70b8 are displayed. If the user 14 actuates the change my password link 70b2 (block 2512), the Modify Institute Profile link 70b3 (block 2514,) or the Modify Institute Profile link (block 2516), the routine proceeds as illustrated in FIG. 11 to the routines described in FIGS. 13, 21 and 15, respectively, as shown.

Referring back to FIGS. 7 and 10, the system 10 determines a user's status based on her login name and password, and the system 10 tags the user as a group administrator when the group profile is created. If the system 10 determines (block 128 in FIG. 7) that the logged-in user 14 is a group administrator, such as a group administrator for a plurality of physicians, then system 10 displays (block 501 in FIG. 10 and block 136 in FIG. 7) a Group Staff Navigation screen 500 (FIG. 43A) for the logged-in user 14. It should be appreciated that this screen 500 and corresponding components are the same as the screen 70 (FIG. 43) described earlier herein. For ease of illustration, the screen 500 (FIG. 43A) will be described with different part numbers. As with the “Physician Navigation” screen 70 referred to and described relative to FIGS. 9 and 43, the “Group Staff Navigation” screen 500 comprises the title area 500a, link area 500b and message area 500c. Note that the title area 500a comprises the information link 500a1, help link 500a2 and log-off link 500a3 described earlier herein relative to FIGS. 9 and 43. As illustrated in FIGS. 10 and 43A, the screen 500 comprises the plurality of links described relative to FIG. 43, including a home page link 500b1, change my password link 500b2, modify my profile link 500b3, message archive link 500b4, group members link 500b5, group schedule link 500b6, off-duty schedule link 500b7, modify group profile link 500b8, search link 500b9 and terms of use 500b10. These links 500b1-500b10 enable the logged-in user to access various active server pages which permit the user to add, delete or edit various information for a particular group, such as the Consultants in Cardiology Group in the embodiment being described relative to FIG. 43. Thus, the links 500b1-500b3 enable the logged-in user to add, edit, or delete information such as profile information, password information or message archive information relative to that particular logged-in user. The links 500b5-500b8 enable the logged-in user to add, modify or delete information to group members, a group schedule, off-duty schedule and the group profile for the group, such as a physician group. These links will now be described relative to FIG. 10.

If a logged-in user actuates the homepage link 500b1 (block 502 in FIG. 10), then the system 10 displays (block 518) a homepage. In the embodiment being described, the homepage may be the screen 60 (FIG. 38) described earlier and may include information relative to the provider of the homepage and of the system 10 and other pertinent information.

If the user actuates (block 504 in FIG. 10) the change my password button 500b2 (FIG. 43A), then the routine proceeds to the change password routine described earlier herein relative to FIG. 13.

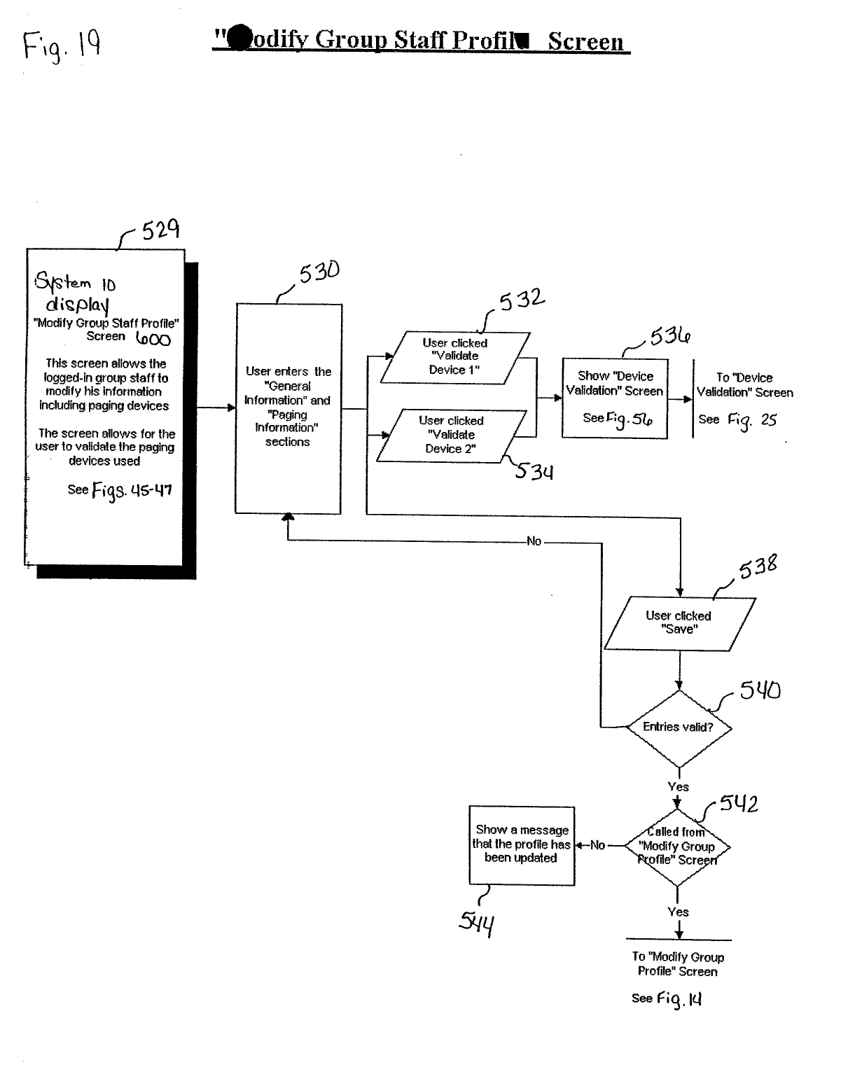

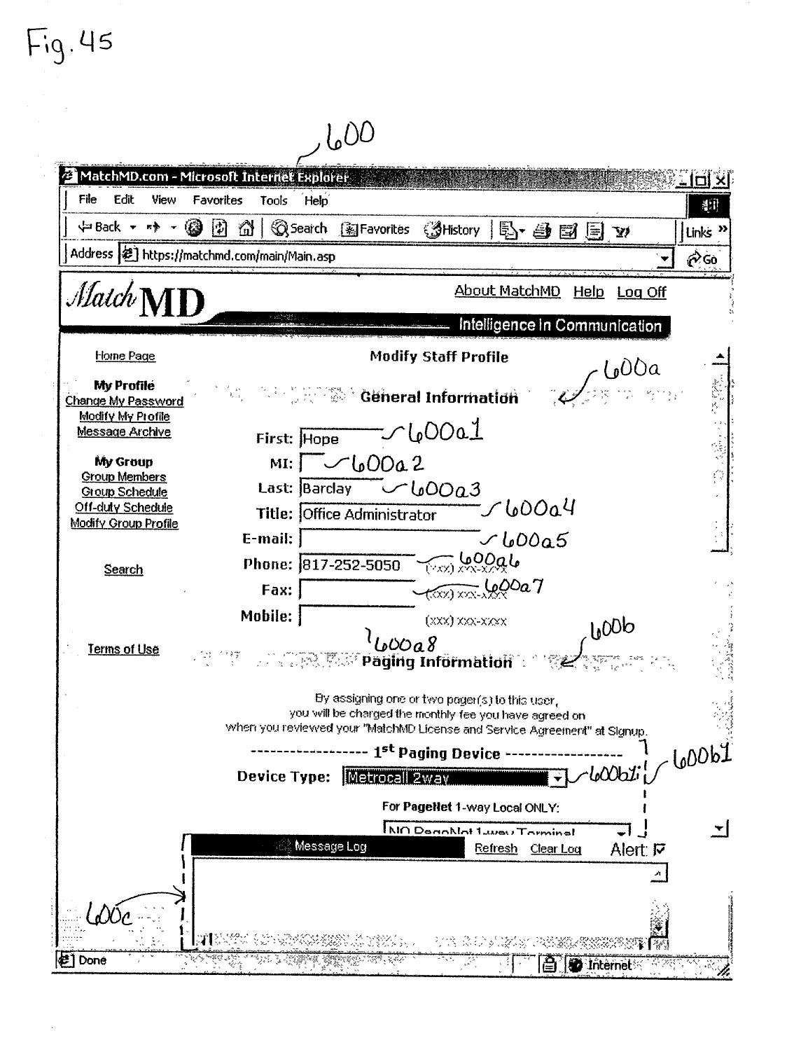

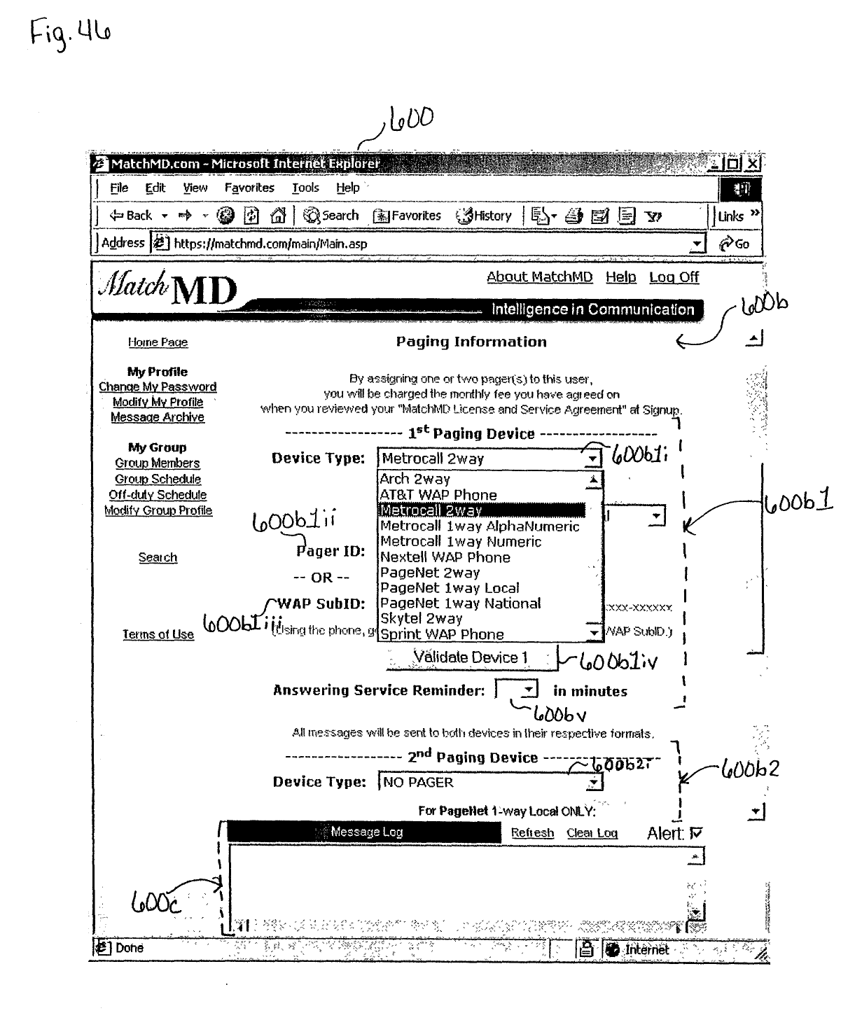

If the user selects (block 506 in FIG. 10) Modify My Profile, then the user actuates the link 500b3 (FIG. 43A), and the routine proceeds to a modify group profile routine and system 10 displays screen 600 (block 529 in FIG. 19) that will now be described relative to FIGS. 19 and 45-47. As illustrated in FIGS. 45-46, the modify group profile active server page or screen 600 comprises the general information areas 600a (FIG. 45), paging information area 600b (FIGS. 45-47) and message log area 600c that are similar to the areas 180a and 180b described herein relative to FIGS. 53-55. In the general information area 600a, the logged-in user may enter, edit, or delete information as desired. The general information area 600a comprises the first name data field 600a1, middle initial data field 600a2, last name data field 600a3, title data field 600a4, e-mail data field 600a5, phone data field 600a6, fax data field 600a7 and mobile phone data field 600a8 as shown. The fields 600a1-600a8 enable the logged-in user to enter, edit or delete pertinent profile information.

The paging information area 600b on the screen 600 enables the logged-in user to assign one or more communication devices 18, such as the pagers 18 (FIG. 1), and to validate those devices 18 in the same manner as described earlier herein relative to FIGS. 53-55. In the embodiment being described, the paging information area 600b comprises the field areas 600b1 and 600b2 for entering, editing or deleting information relative to the communication devices 18. In the embodiment being described, the field 600b1 comprises a device type identification 600b1i, pager identification 600b1ii, wireless application protocol (WAP) identification number 600b1iii, validate device button 600b1iv and answering service reminder 600b1v. Likewise, the field area 600b2 for the second paging device comprises similar fields 600b2i-600b2v. It should be appreciated that the fields 600b1i-600b1iii enable the user to assign a particular communication device and associated identification number to the logged-in user. The answering service reminder 600b1v enables the logged-in user to automatically send a message to a backup device 16 a certain amount of time has gone by the device 18. The area 600b2 comprises the same fields 600b2i-600b2v, which enable a user to assign another communication device 18 to the logged-in user. Thus, it should be appreciated that the logged-in user may assign one or more communication devices to a person for purposes of communication using system 10 in the manner described later herein.

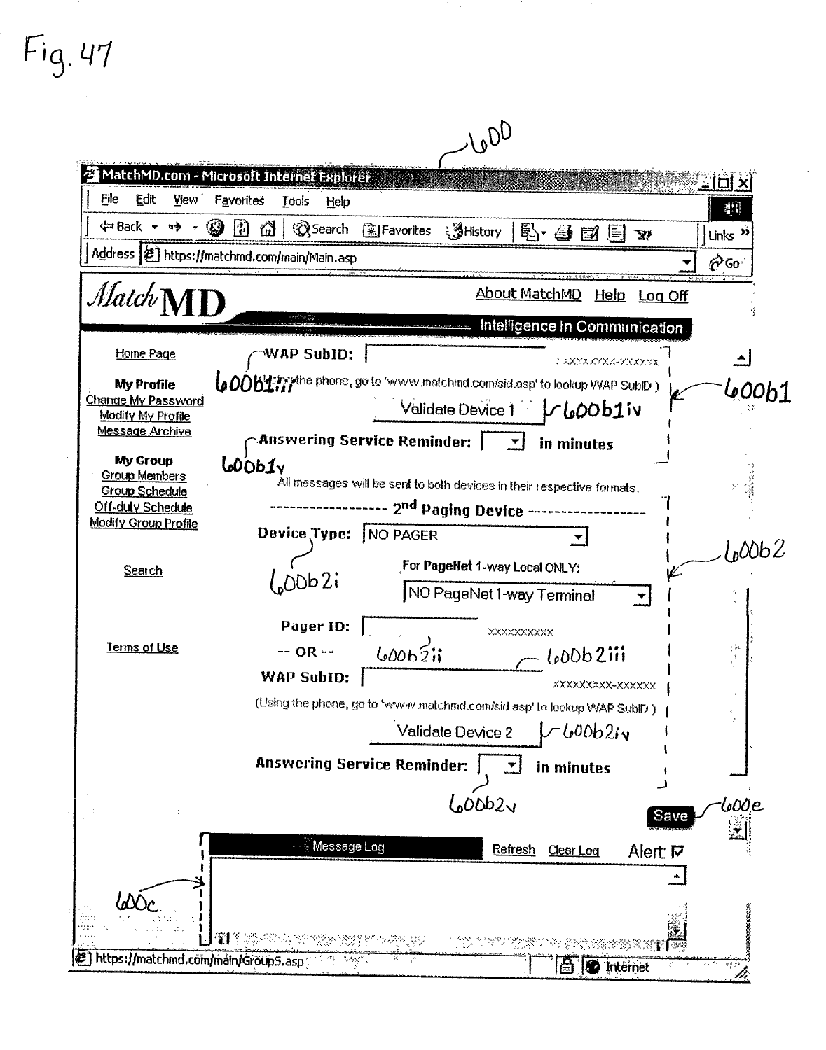

Referring back to the routine illustrated in FIG. 19, the user enters the general information (block 530) where the system 10 presents the user with the general information area 600a (FIG. 45) and paging information area 600b (FIGS. 45-46). The user may elect to validate the first communication device (block 532) and/or second communication device (block 534) by actuating the validation buttons 600b1iv and 600b2iv (FIG. 47) respectively. At block 536 (FIG. 19), the system 10 displays the “Device Validation” screen (FIG. 56) and proceeds to validate one or both the selected communication devices in accordance with the routine illustrated in FIG. 25 described earlier herein.

The user may also click the save button 600e (FIG. 47) at block 538 in FIG. 19 and the information loaded on page 600 will be saved to database 24.

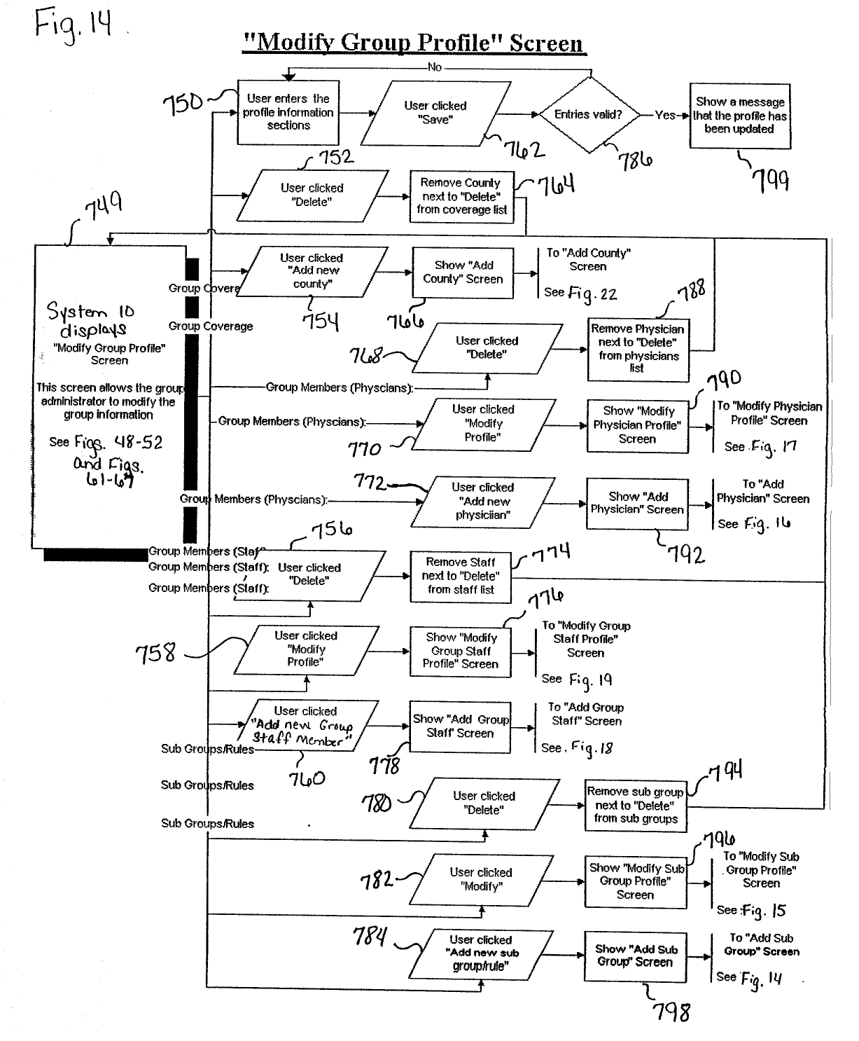

The system 10 then determines whether the entries are valid at decision block 540 in FIG. 19 and if they are not, the user is returned (block 530 in FIG. 19) to the top of the screen 600 (FIG. 45). If they are valid, then the system 10 determines whether the modify “Group Staff Profile” screen was called from the “Modify Group Profile” screen described later herein at decision block 542. If it was not, then the routine displays (block 544) a message (not shown) to the logged-in user that the group profile has been updated. If the decision at decision block 542 is affirmative then the system 10 displays (block 749 in FIG. 14) the “Group Profile” screen 700 (FIGS. 48-52) and the system 10 proceeds in accordance with the routine shown in FIG. 14 which will now be described.

Note in FIG. 48, the “Group Profile” screen 700 comprises a title area 700a, links 700b1-700b10 and 700c which operate in the same manner as the links 70a, 70b1-70b10 and 70c described earlier herein relative to FIG. 43, a group information area 702 where the logged-in user, such as a group administrator may enter a group name 702a, a group code 702b, group address 702c, group city 702d, group state 702d1, group zip code 702d2, phone number 702e-702g, fax number 702h and time zone 702i as shown. At block 750 in FIG. 14, the user enters various profile information for the group in a group profile area 702, which may be a group of individuals such as a group of physicians in the embodiment being described. The logged-in user may save (block 762 in FIG. 14) the information by actuating the save button 700e (FIG. 48). Thereafter, the system 10 determines (block 786) whether the entries entered by the user are valid and if they are then the system 10 displays a message (block 799) that the profile has been updated. If they are not, then the routine loops back to block 750 in FIG. 14 whereupon the group profile area 702 is again displayed.

If the user 14 selects (block 752 in FIG. 14) the delete button 700f (FIG. 48) adjacent a geographic locality 700f1 (FIG. 43), then that area is deleted from the group or physician's coverage area (block 764 in FIG. 14).

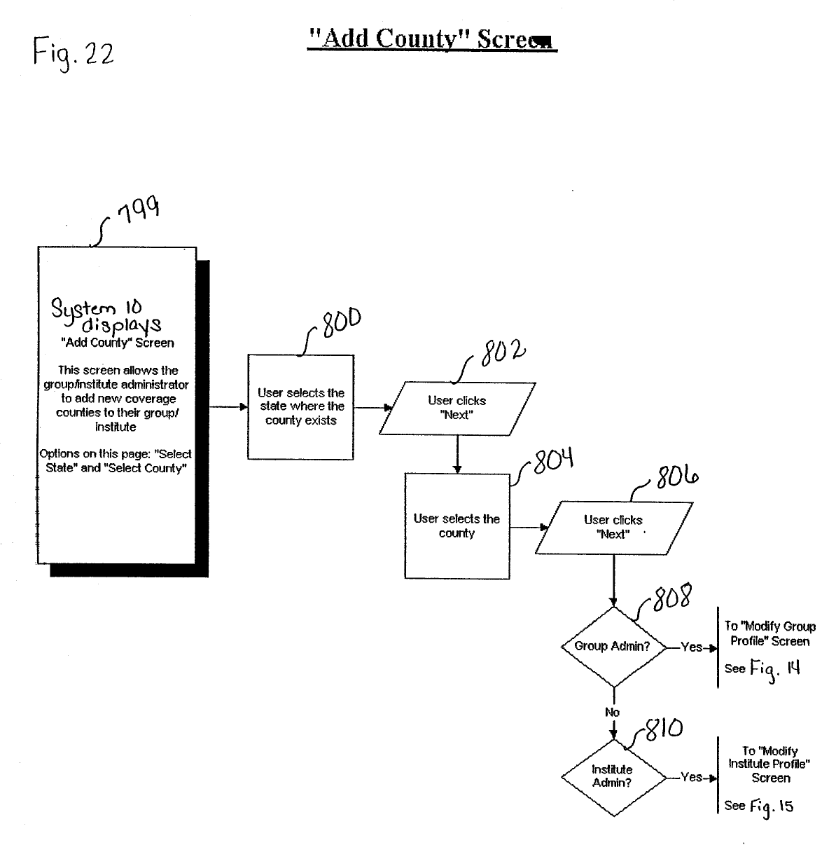

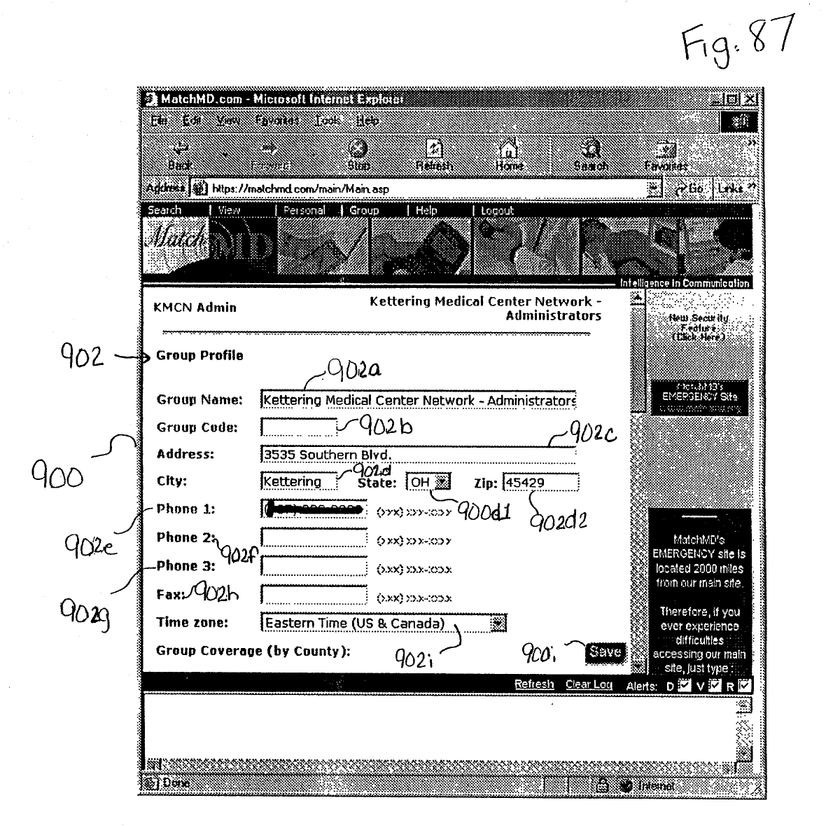

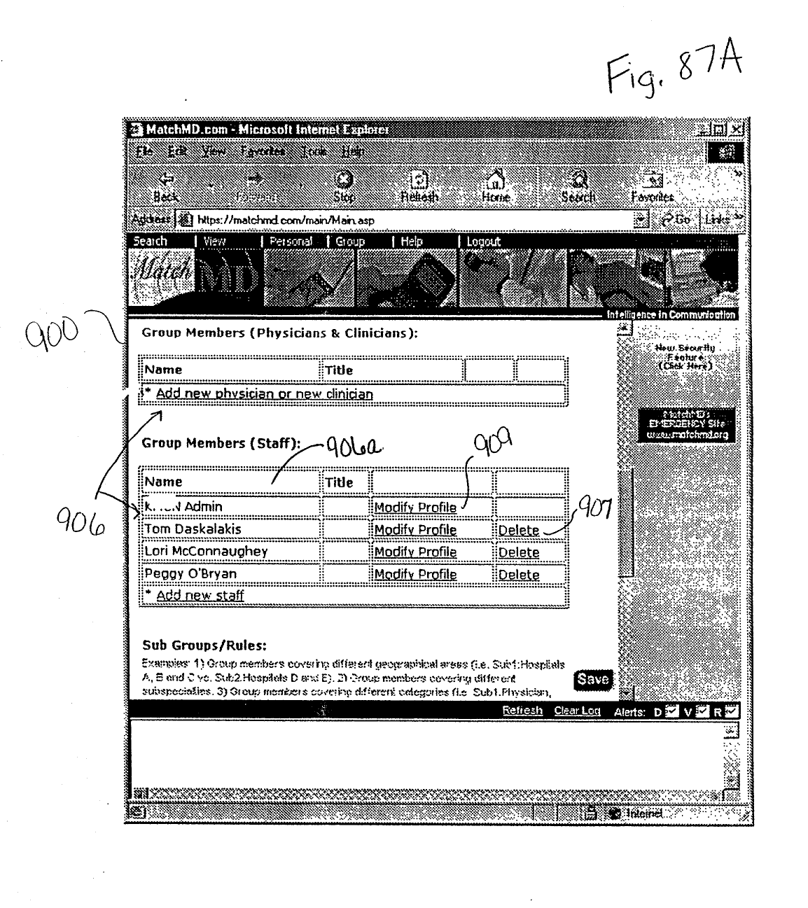

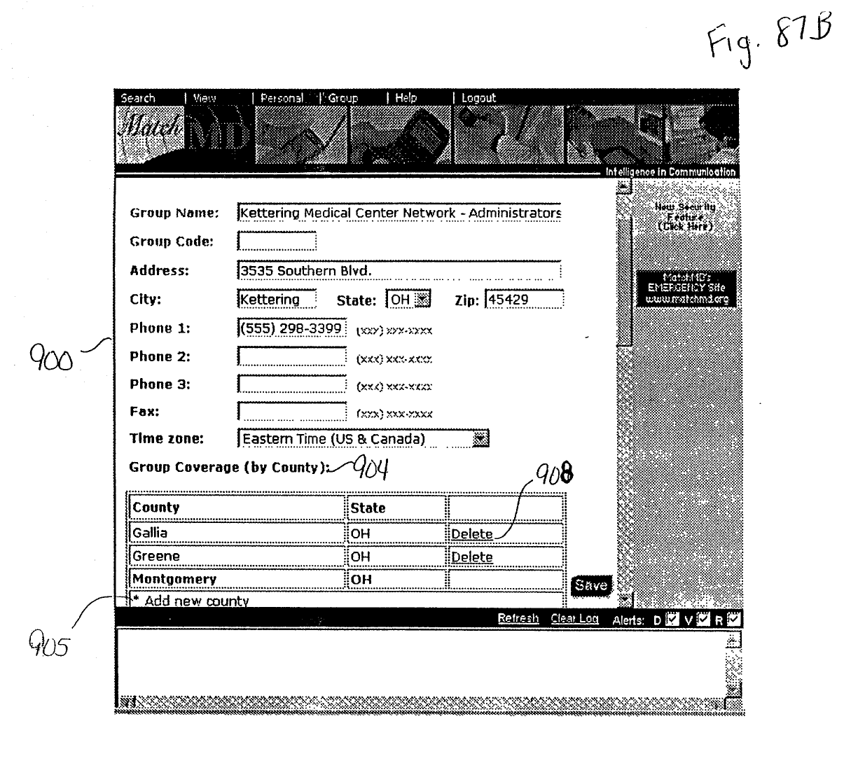

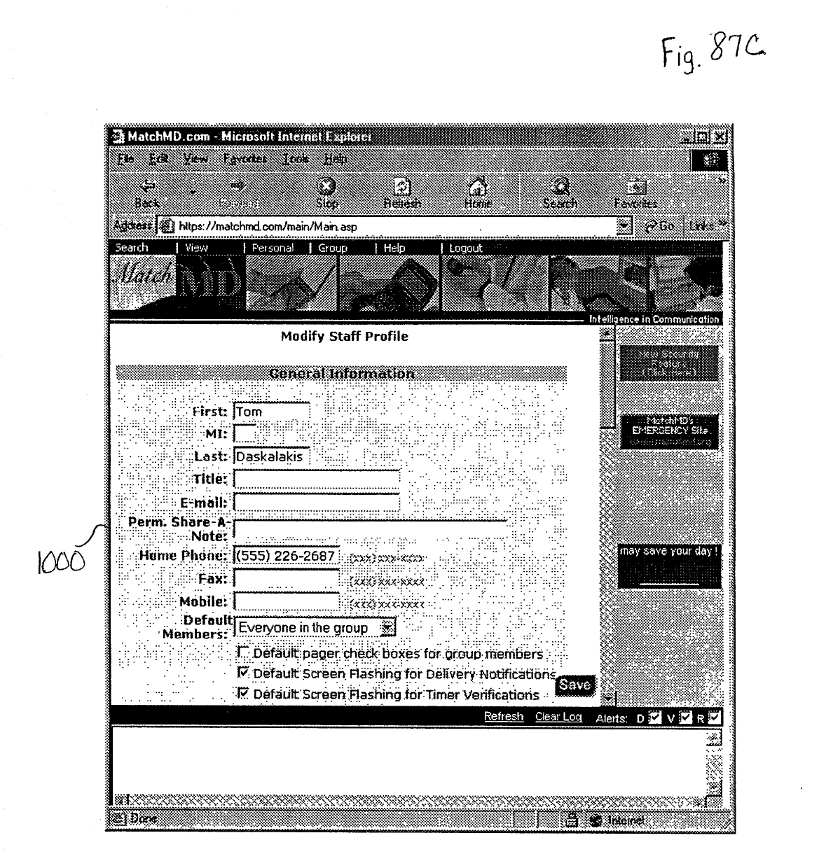

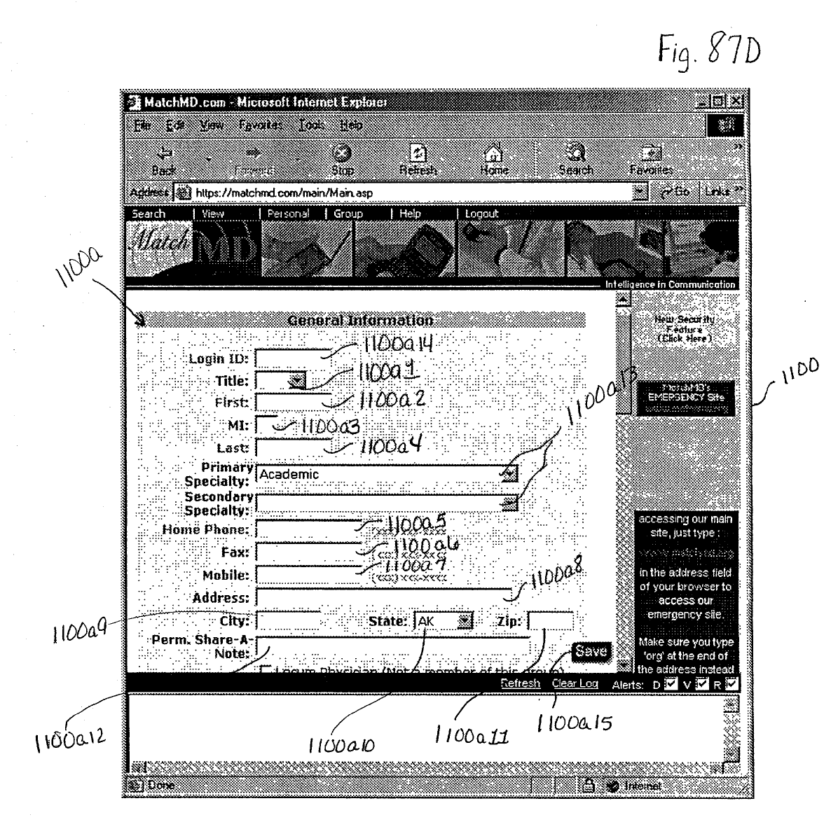

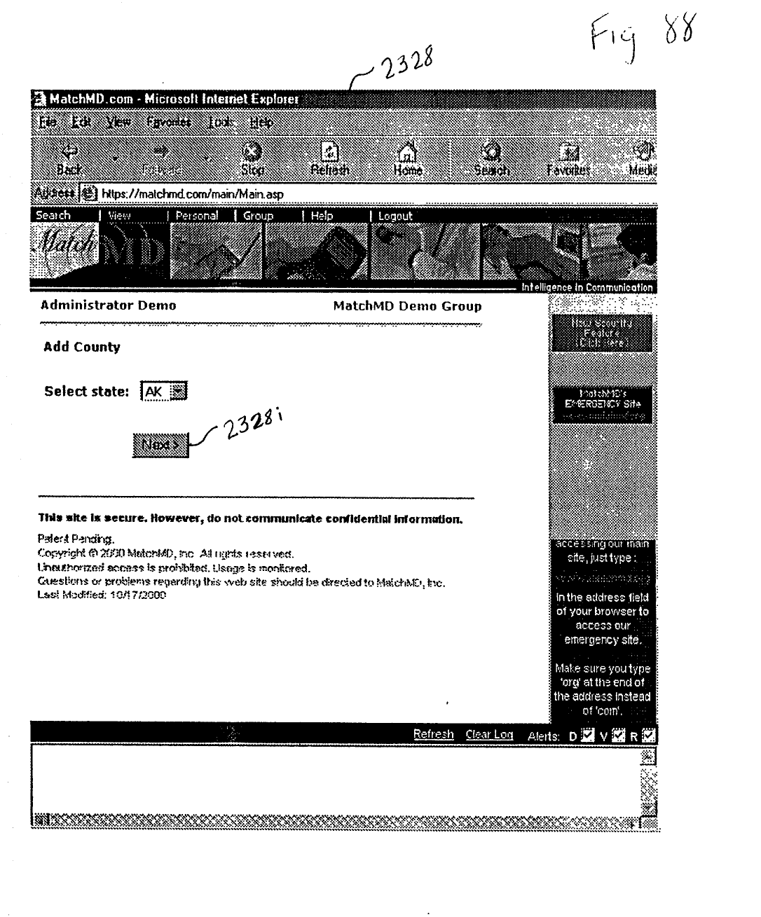

The screen 700 (FIGS. 48-52) further comprises the group coverage area 704 (FIG. 48) wherein system displays the geographic coverage area for the group. In the illustration being described, the coverage area is shown for the “CONSULTANTS IN CARDIOLOGY” group. The user may elect to add a new geographic area, such as a new county of coverage for the group whereupon the user actuates block 754 in FIG. 14 the “Add New County” link 905 (FIG. 87B). The system 10 displays (block 766 in FIG. 14) the “Add New County” screen 2378 (FIG. 88). Whereupon the system 10 allows the logged-in user to add a new geographic coverage area to an assigned group in accordance with the routine which will now be described relative to FIG. 22.

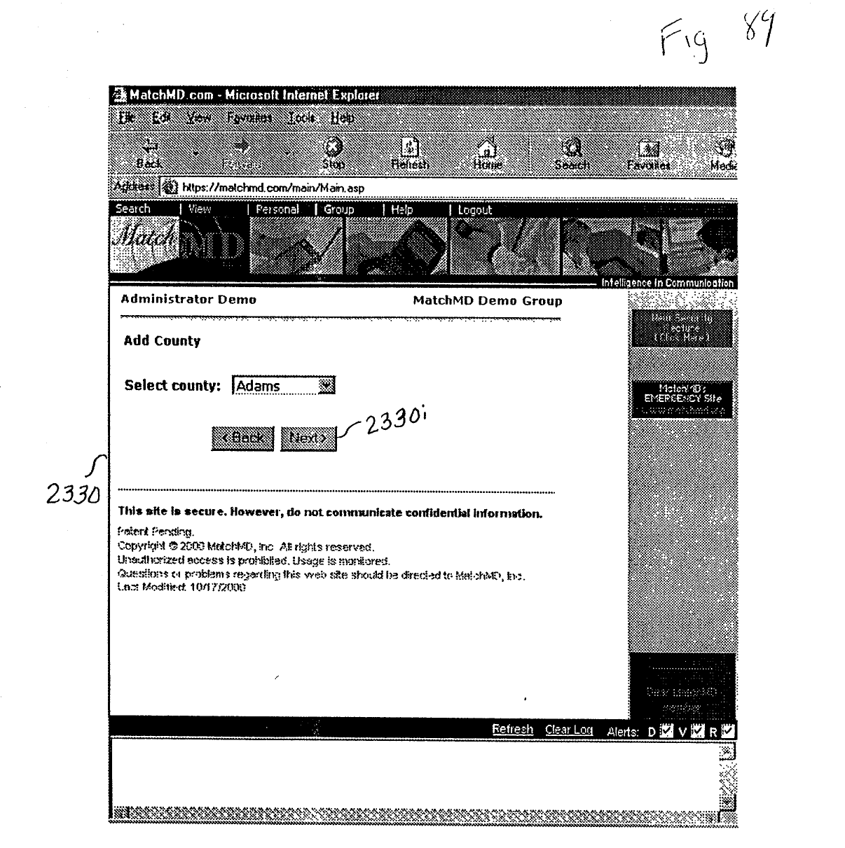

The system 10 displays (block 799 in FIG. 22) an “Add New County” screen 2328 (FIG. 88) that allows the logged-in user to add or assign new geographic areas to their particular group. In the embodiment being described, the geographic areas are identified as counties, but it should be appreciated that other geographic indicators, such as city, state, country or the like could be identified. At block 800 in FIG. 22, the user selects the state where the county exists and then clicks (block 802) the “Next” button 2328i (FIG. 88) whereupon the user selects the county which is desired to be added (block 804 in FIG. 22). The routine then proceeds to block 806 where the user clicks the “Next” button 2330i (FIG. 89). In response, the system 10 determines whether or not the logged-in user is a group administrator (decision block 808 in FIG. 22) and if he is, then the routine returns to the modify group profile screen 700 (FIG. 48) and associated routine illustrated in FIG. 14. If the logged-in user is not a group administrator, it is determined (decision block 810) whether or not the logged-in user is an institute administrator. If he is, then the routine proceeds to the modify institute profile screen 900 (FIG. 87), which allows an institute administrator to modify associated institute information in the areas 900a-900h. The information may be saved in database 24 when the user selects the save button 900i. Thus, as explained earlier herein relative to FIG. 7, the system 10 categorizes each logged-in user and provides various levels of access to the information associated with that logged-in user in the group or institute with which they are associated.

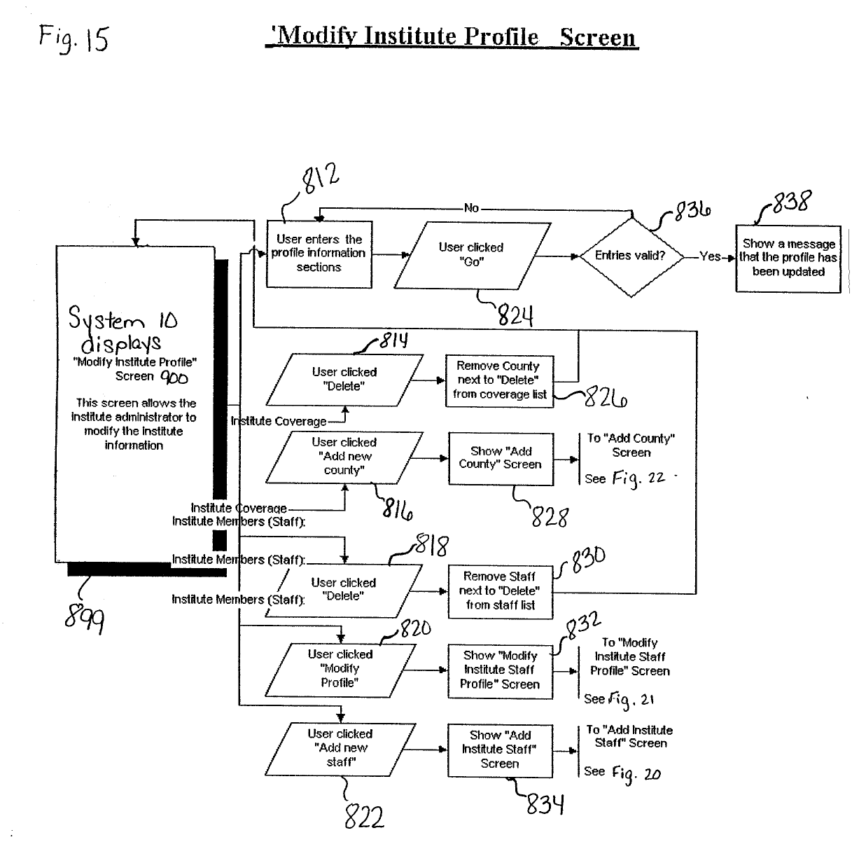

Referring now to FIG. 15, the system 10 displays (block 899) a Modify Institute Profile screen 900 (FIG. 87) where the user is given various options including enabling the logged-in user to enter (block 812 in FIG. 15) profile information into the profile information area 902 (FIG. 87A). Note that the profile information area 902 comprises information relative to the institute. This information area 902 includes the institute name 902a (FIG. 87) institute code 902b, institute city 902d, state 902d1, zip code 902d2, phone numbers 902e-902g, fax number 902h, and time zone 902i. After entry of the institute information (block 812 in FIG. 15), the user can select (block 824 in FIG. 15) the go button (not shown in FIG. 87) that system 10 causes to appear on the active server page, whereupon system 10 determines whether the entries are valid (decision block 836), and if they are, then the system 10 displays a message that the profile has been updated (block 838). If they are not, then the routine loops back to block 812 as shown.

The modify institute profile screen 900 (FIG. 87) further comprises the institute coverage 904 area FIG. 87B that enables the user to add or assign a new geographic area to the institute (block 816 in FIG. 15) or delete a geographic area (block 814). Those geographic areas listed in the database 24 for an institute will be the geographic areas that the group is assigned to and the geographic areas which they may search. If the user clicks the “Delete” button 908 (FIG. 87B), then the system 10 removes the geographic area from the coverage listed in the system 10 databases 14 (block 826 in FIG. 15). If the user has selected the “Add New County” button 905 (FIG. 87B), then the system 10 displays (block 828) the “Add New County” screen 2328 (FIG. 88) and the logged-in user proceeds in accordance with the routine described earlier herein relative to FIG. 22.

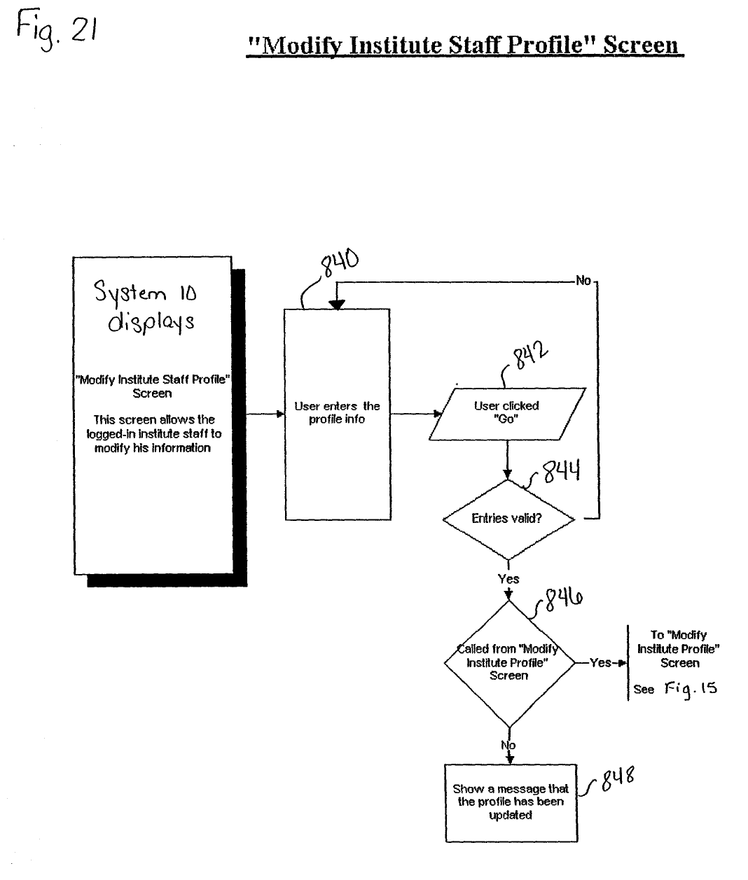

Referring back to FIG. 15 and FIG. 87, the screen 900 further comprises an institute members area 906 (FIG. 87A) that provides a list of the members corresponding to or associated with the logged-in user's 14 institute. Note that the member area 906 comprises a listing of member names at area 906a (FIG. 87A). Associated with each member listing 906a is the option for the logged-in user to delete or modify the profile associated with that member (blocks 818 and 820 in FIG. 15). If the user elects to delete a member or the logged-in user actuates a delete button 907 (FIG. 87A) at block 818, the system 10 removes (block 830) the member from the list in the area 906. Thereafter, the routine loops back to the “Modify Institute Profile” screen 900 as shown. If the user elects to modify a profile associated with the particular member (block 820 in FIG. 15), then the user actuates the “Modify Profile” button 909 in FIG. 87A and the routine proceeds to block 832. The system 10 presents the “Modify Staff Profile” screen 1000 (FIG. 87C) so that the logged-in user can modify the information associated with the institute member (block 832 in FIG. 15) in accordance with the routine shown in FIG. 21 which will now be described.

The system 10 displays the modify staff profile screen 1000 at block 832 in FIG. 15, whereupon the logged-in user is allowed to modify the information associated with the institute's staff member selected. The user may then enter (block 840 in FIG. 21) profile information on the screen 1000 (FIG. 87C) and then select (block 842 in FIG. 21) the go button (not shown). As with other entries entered into the system 10, the system 10 determines whether the entries are valid (decision block 844 in FIG. 21), and if they are not, the routine loops back to the block 840 as shown. If the entries are valid, then the routine proceeds to determine whether the modify staff profile screen 1000 was called (block 846) from the modify institute profile screen 900 (FIG. 87), and if it was, the routine displays the modify institute profile screen 900 and returns to the options and routine described earlier relative to FIG. 15. If the modify institute staff profile was not called from the modify institute profile screen 900, then the system 10 displays a message (block 848 in FIG. 21) that the profile has been updated.

If the decision at decision block 846 is affirmative, then the routine returns to the beginning of the modify institute profile screen 900 (FIG. 87) as shown.

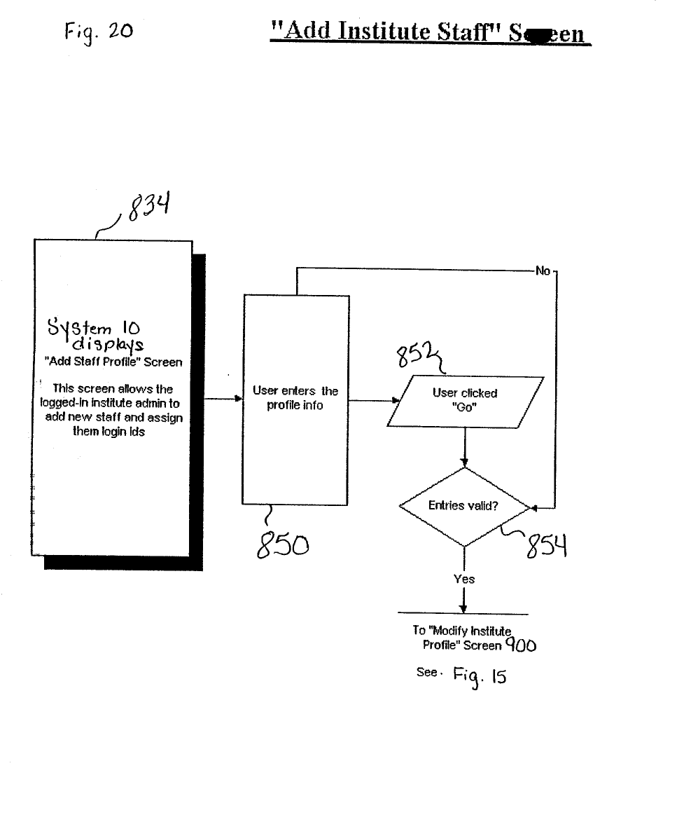

Referring back to FIG. 15, if the user elects to add a new staff member to the listed members (block 822 in FIG. 15), then the user actuates the “Add New Staff” button 900 (FIG. 87A) whereupon the system 10 displays (block 834 in FIGS. 15 and 20) the “Add Institute Staff” screen 1100 (FIG. 87D). The “Add Institute Staff Profile” screen 1100 permits the logged-in user 14 to add new staff members to the list of staff members for the institute associated with the logged-in user as well as assign log-in identification numbers. The logged-in user enters the profile information (block 850 in FIG. 20), which includes title 1100a1, first name 1100a2, middle initial 1100a3, last name 1100a4, phone number 1100a5, fax number 1100a6, mobile number 1100a7, address 1100a8, city 1100a9, state 1100a10, zip code 1100a11 and special instructions or share-a-note 1100a12, specialties 1100a13 and a login identification number 1100a14. Thereafter, the logged-in user actuates (block 852 in FIG. 20) a save button 1100a15 (FIG. 87D), whereupon system 10 saves the information in database 24.

At decision block 854 (FIG. 20), it is determined whether the entries are valid, and if they are, the routine returns the user to the “Modify Institute Staff Profile” screen 900 (FIG. 15) where the logged-in user may modify other information in accordance with the routine described relative to FIG. 15. If the decision at decision block 854 is negative, then the routine proceeds back to the screen 1100 (FIG. 87D) where the user can enter other profile information (block 850). After the user has added any appropriate staff members desired and all modifications to the institute information have been made via the “Modify Institute Staff Profile” screen 900, then the “Modify Institute Profile” routine is complete.

Returning to FIGS. 14 and 48-52, note that the link area 700b of the modify group profile screen 700 comprises a home page link 700b1, change my password link 700b2, modify my profile link 700b3, message archive link 700b4, group members link 700b5, group schedule link 700b6, off-duty schedule link 700b7, modify group profile link 700b8, search link 700b9 and terms of use link 700b10. The screen 700 further comprises a listing of all the group members associated with the group. In the embodiment being described, the group members may be physicians, staff or other interested parties who the logged-in user associates or includes in the group. Note that the screen 700 comprises a group member area 706 (FIG. 49) which provides the listing. At block 768, 770 and 772 in FIG. 14, the logged-in user may elect to delete, modify or add a new physician to the group by actuating the delete button 706a (FIG. 49), modify profile button 706b or add new physician button 706c, respectively. If the delete button 706a (FIG. 49) is selected, then the physician is removed (block 788 in FIG. 14) from the list and the logged-in user is returned to the beginning of the group profile screen 700 (FIG. 48). If the user selects the modify profile button 706b in FIG. 49, then a modify physician profile screen 180 (FIGS. 53-55) is displayed by system 10 (block 790 in FIG. 14). The user may then proceed in accordance with the routine described relative to FIG. 17 to modify a physician profile.

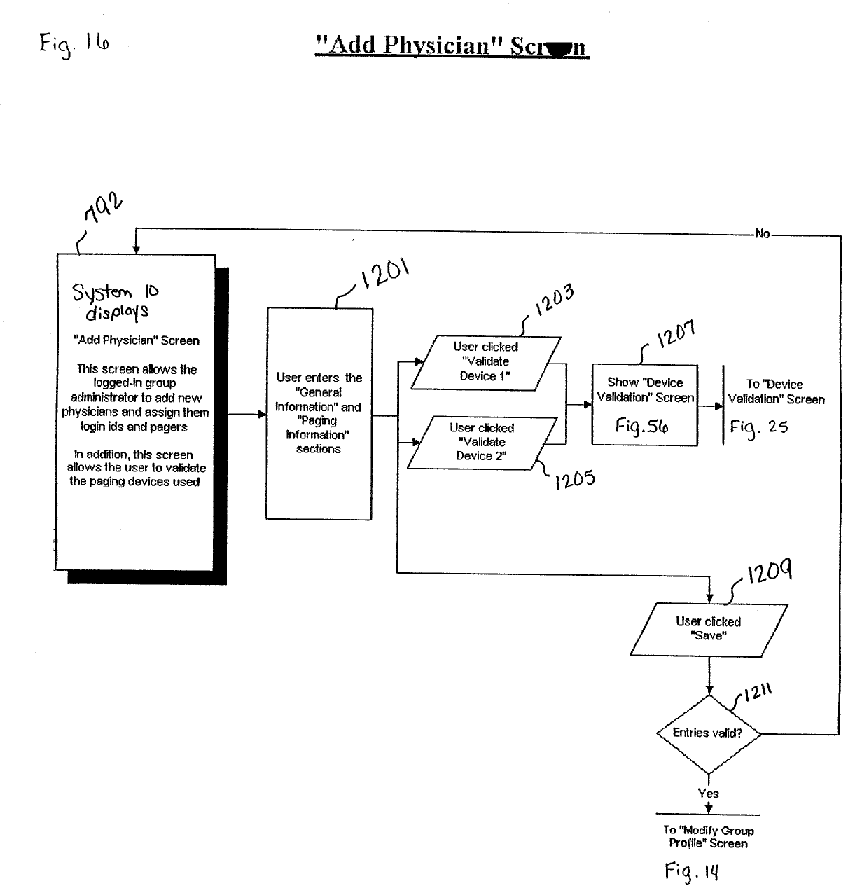

If the user elects (block 772 in FIG. 14) to add a new physician by actuating the add new physician button 706c in FIG. 49, then the screen 1100 (FIG. 87D) is displayed (block 792 in FIGS. 14 and 16), and the routine proceeds in accordance with the routine described in FIG. 16. This screen 1100 permits a logged-in user, which in the embodiment being described is a group administrator, to add new physicians and assign them login identification numbers and pagers. In addition, this screen 1100 allows the user to validate any communication devices, such as paging devices 18 (FIG. 1), that are used by the physician. As with the screen illustrated in FIG. 54, the add physician screen 1100 comprises a general information area 1100a, and a paging information area (not shown) that comprises the same or similar information, as described earlier herein relative to FIGS. 53-55. At block 1201 in FIG. 16, the user may enter the general information and paging information and then elect to validate one or both of the paging devices (block 1203 and 1205) in the manner described earlier herein relative to the screens shown in FIGS. 53-55. Thereafter, the device validation screen 220 (FIG. 56) is displayed at block 1207 in FIG. 16. The routine proceeds to the device validation routine described earlier herein relative to FIG. 25.

After the user has entered the appropriate general information and paging information in the general information area 1100a and paging information area (not shown), the user can elect to save the information (block 1209 in FIG. 16), whereupon the system 10 determines if the entries are valid (decision block 1211 in FIG. 16). If they are, then the routine proceeds back to the modify group profile screen 700 and the routine described in FIG. 14. If the entries made by the logged-in user are determined to be invalid, then the routine proceeds to the beginning of the add physician screen 1100 and the general information area 1100a and paging information area (not shown) is again displayed.

Returning to FIG. 14, if the user 14 elects to add a new physician by actuating (block 772 in FIG. 14) the add new physician button 706c (FIG. 49), the add physician screen 1100 is again displayed. The logged-in user is then allowed to add new physicians and assign login identification numbers and pager numbers in accordance with the routine described relative to FIG. 16.

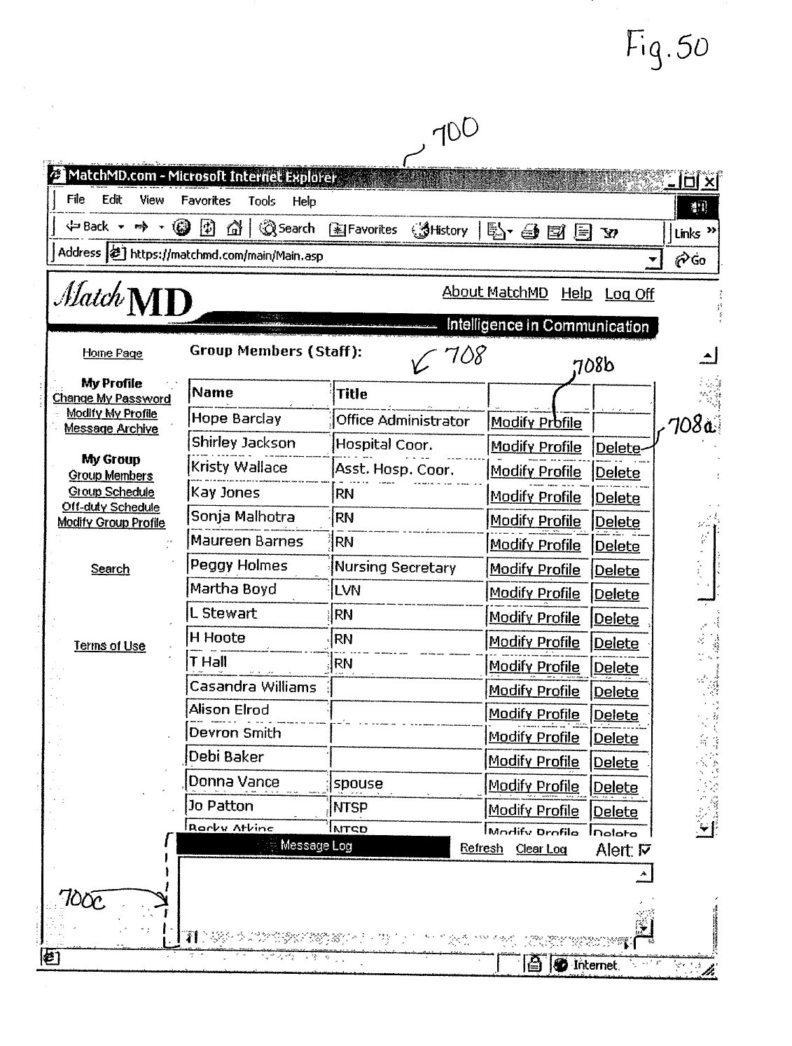

Referring back to FIG. 14 and the modify group profile screen 700 (FIGS. 48-52), notice that the system 10 displays group members in area 708 (FIG. 50). As with physicians, a user can elect to modify or delete a staff member by activating links 708b or 708a, respectively. In the embodiment being described, the group members are, for example, staff members associated with the physicians listed in area 706 (FIG. 49) of screen 700. The system 10 enables the logged-in user, which may be an office administrator, to add new group staff, modify profile information with respect to a group staff member, or delete a group staff member in a manner similar to the modifications, additions and deletions that were performed relative to group staff physicians described earlier herein. Thus, at block 756 in FIG. 14, the logged-in user may remove a staff member (block 774) by actuating a delete link 708a (FIG. 50) associated with one of the group members listed in the group member area 708. Thereafter, the routine proceeds by again displaying the beginning of the modify group profile screen 700 as shown.

At block 758 in FIG. 14, the user may select the modify profile button 708b (FIG. 50). In response, the system displays (block 776 in FIG. 14) the modify group staff profile screen 600 (FIGS. 45-47). The logged-in user may add, delete or modify staff profile information relative to individual staff members who are assigned or associated with the logged-in user's group in accordance with the routine described earlier herein relative to FIG. 19. The logged-in user may also verify and validate any communication devices as described earlier.

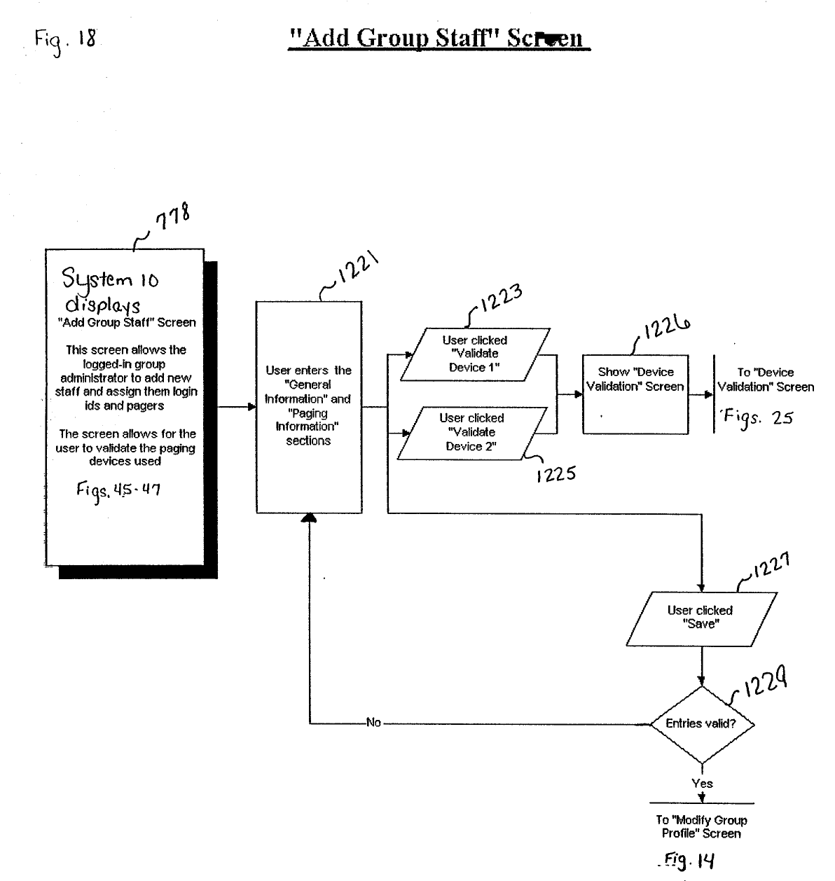

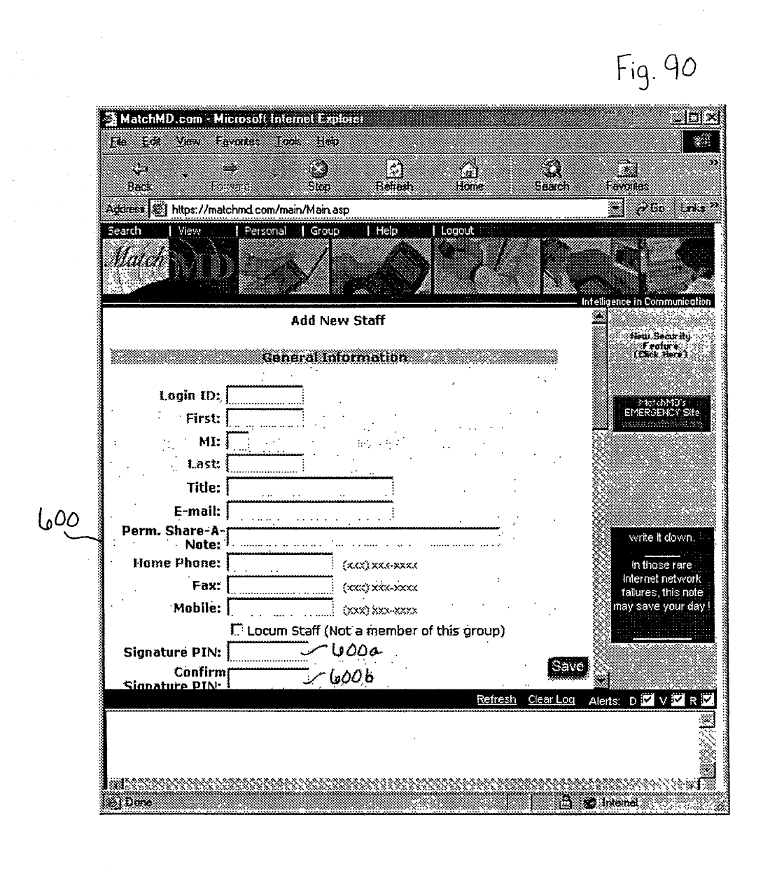

Returning to FIG. 14, if the user elects to add a new group staff member (block 760 in FIG. 14), then the user clicks the add new staff member button (not shown) which is provided at the end of the group members' listing in the group members area 708 in FIG. 50. This button is similar to the add new physician button 706c in FIG. 49. The system 10 displays (block 778 in FIGS. 14 and 18) the add group staff screen 600 (FIG. 90), which allows the logged-in user, such as a group administrator, to add new staff members to the group and assign them log-in identification numbers and communication device identification numbers. As with the validation procedures described earlier, the logged-in user may also validate any assigned paging devices 18 for any member of the group in the same manner as described earlier herein. For ease of illustration and description, the areas on the screen 600 (FIG. 90) are similar to those described earlier, except the screen 600 comprises signature personal identification numbers (PIN) area 600a and a confirmation area 600b for use by the user.

As shown in FIG. 18, the add group profile screen 600 comprises the general information area 600a and paging information area 600b which is displayed by system 10 (block 1221 in FIG. 18). In the paging information area 600b, the user may select the validate device one button 600b1 iv or the validate device 2 button 600b2iv (at block 1223 and 1225 in FIG. 18). The routine proceeds to block 1226 (FIG. 18) whereupon system 10 displays the device validation screen 220 (FIG. 56) described earlier herein. System 10 then proceeds with the device validation routine in accordance with the routine described earlier herein relative to FIG. 25.

After the user has entered the new staff member and associated profile for that staff member into the system 10, the user may actuate (block 1227 in FIG. 18) the save button 600e (FIG. 47) so that all profile information relative to the group staff member is added to the system 10 database 24 (FIG. 2). Thereafter, system 10 determines whether the entries entered by the logged-in user are valid (block 1229) and if they are not it returns to the beginning of the screen 600 and displays the general information area 600a and paging information area 600b. If the entries are valid (block 1229 in FIG. 18), then the routine returns to the modify group profile screen 700 and the routine described relative to FIG. 14.

A unique feature of the invention is that it enables a logged-in user to add subgroups or rules associated for a group. For example, the system 10 enables the logged-in in user to group or categorize members based upon different geographic areas, or even areas of practice or institutions. A subgroup may comprise one or more hospitals A, B, and C, whereas a second group may comprise one or more other hospitals D and E. This is particularly convenient when the hospitals A, B and C are located in one geographic region while hospitals D and E are located in a remote geographic region. Yet another subgroup that can be associated with a group may be group members that cover different specialties. For example, a subgroup may include all physicians who practice in the specialty of cardiology, while another subgroup may be created for physicians who practice in orthopedics, for example. Still another subgroup may be defined as group members covering different professional categories or areas of specialties. For example, one subgroup may be all physicians within a group. Another subgroup may be created for all nurses within the group, and yet another subgroup may be created for all staff personnel within a group. It should be appreciated that this invention is not limited to these subgroups, and the system 10 enables the user to program or define as many subgroups as they desire or as needed and each subgroup may have their own defined work or call schedule. This can be stored in the database 24 (FIG. 2) available to logged-in users who are using the active server pages 22 (FIG. 2).

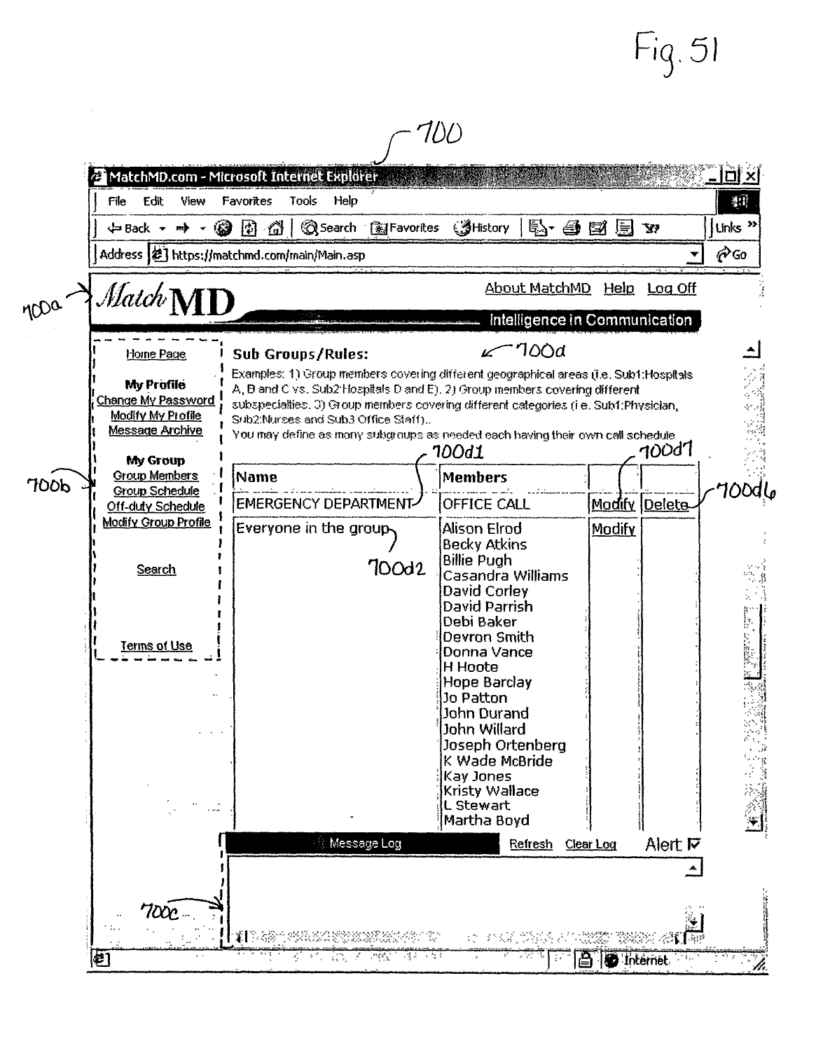

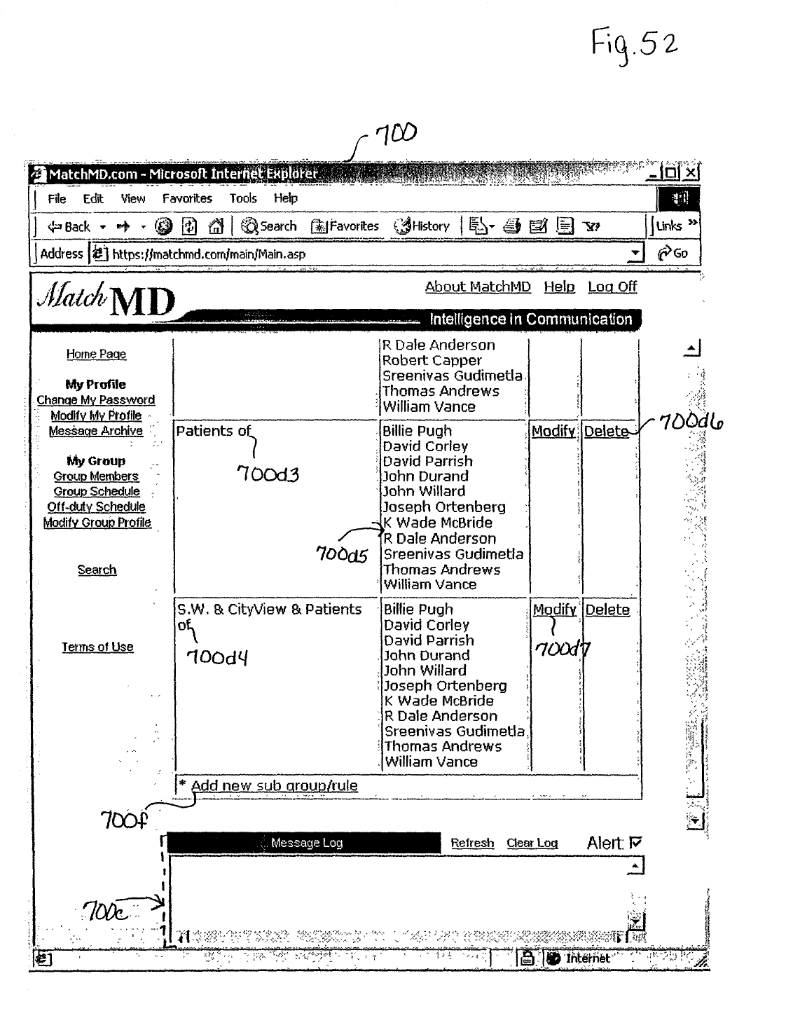

The subgroup or rules associated with a particular group may be added to, modified or deleted in the area 700d (FIGS. 51-52) which will now be described. In the illustration in FIGS. 51-52, the subgroups or rules for the “CONSULTANTS in CARDIOLOGY” group (referred to in the group name 702a in FIG. 48) are shown to include to include the subgroups “EMERGENCY DEPARTMENT,” “everyone in the group,” “Patients of,” and “S.W. & CityView & Patients Of” which are identified with the part numbers 700d1, 700d2, 700d3, and 700d4, respectively, in FIGS. 51 and 52. Note, for example, that the “Patients of” subgroup 700d3 comprises a plurality of associated group members 700d5 associated with the subgroup 700d3. It is to be understood that a subgroup is analogous to a department of a hospital. In the illustration, Consultants in Cardiology practice is the group and the individual subgroups are made up of sub areas that they want to divide their staff into. Each subgroup can have its own schedule and select only those people that are associated with it. This feature of the invention allows group members with different departments to sort their staff into smaller groups. For example, nurses may be assigned to their own subgroup within the group. Thus, the administrator can create custom mini-groups or species of larger group or genus, respectively, to make paging easier and for accessing, loading and viewing different call schedules.

If the user elects to delete a subgroup or rule (block 780 in FIG. 14), then the user selects one or more of the delete links 700d6 (FIGS. 51-52). Thereafter, system 10 deletes (block 794) the subgroup/rule from the database 24 (FIG. 2) in response thereto and returns to the beginning of the group profile screen 700 (FIG. 45).

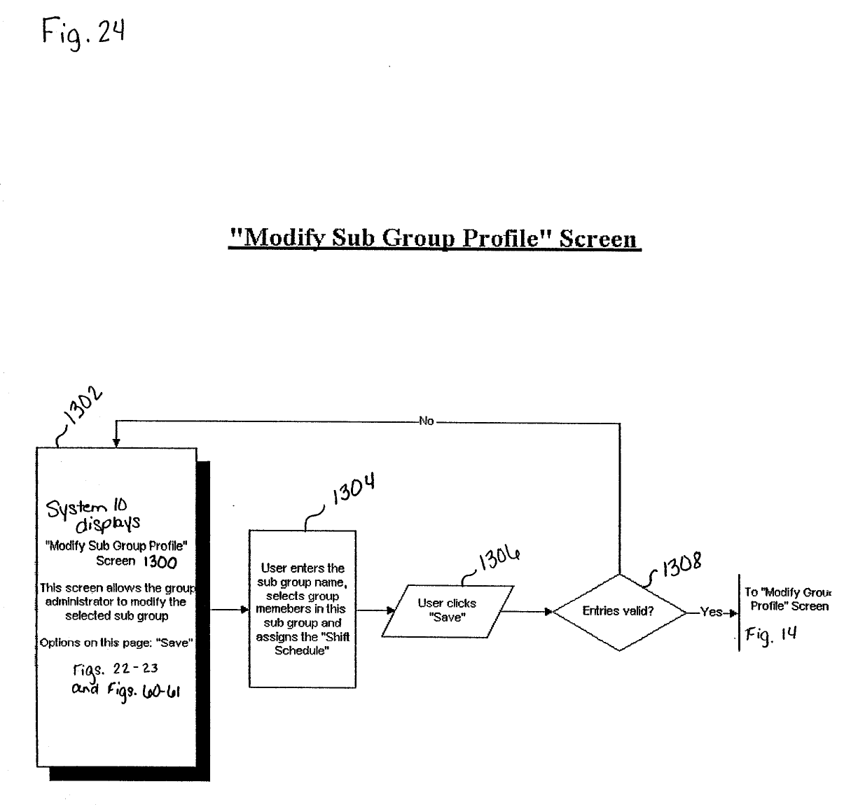

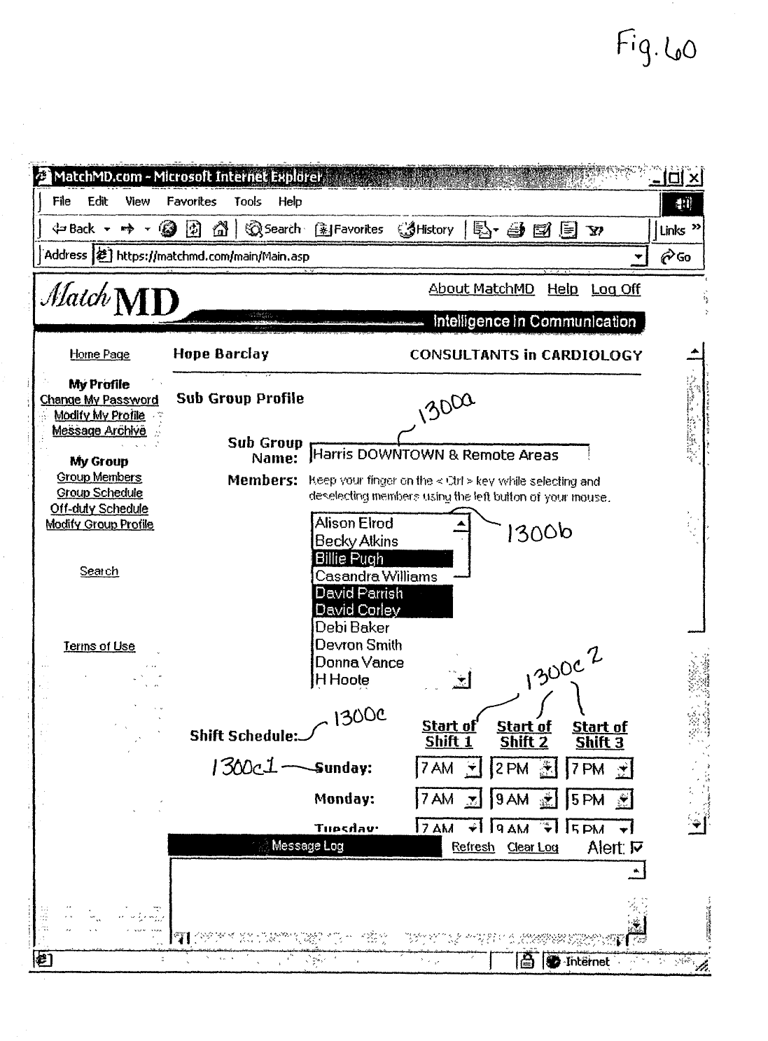

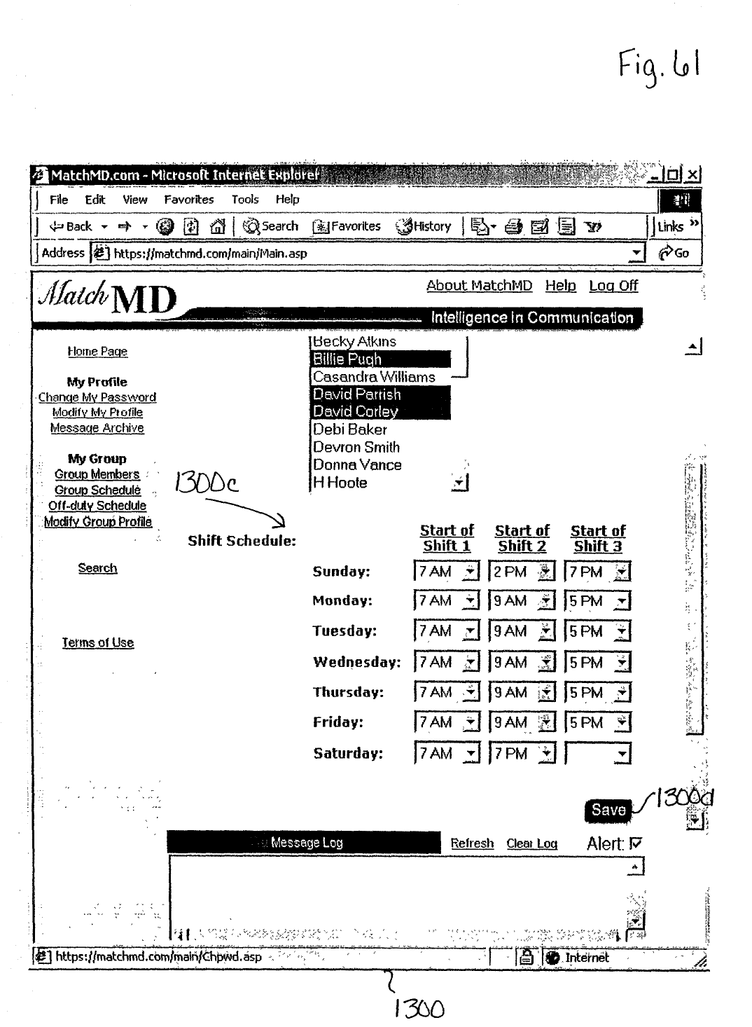

If the logged-in user elects (block 782 in FIG. 14) to modify a subgroup/rule, then the user may select one or more of the modify buttons 700d7 (FIGS. 51-52). The system 10 then displays (block 796 in FIG. 14) the modify subgroup profile screen 1300 (FIGS. 60-61) which allows user, such as the group administrator, to modify a selected group. At block 1304 in FIG. 24, the user enters the subgroup name 1300a (FIG. 60) and selects group members 1300b that will be associated with the group 1300a. In the embodiment being described, the system 10 is configured to be used with physicians so it is convenient to provide or assign a shift schedule 1300c for the subgroup. The shift schedule 1300c comprises each day of the week 1300c1 and also three shifts per day 1300c2, as illustrated in FIGS. 60-61. After the user has selected the subgroup name, identified group members 1300b, and identified the shift schedule associated with this group, the user may select (block 1306 in FIG. 24) the save button 1300d. Thereafter, the routine proceeds to decision block 1308 (FIG. 24) where system 10 determines whether the entries entered by the logged-in user are valid. If they are not, then the routine returns to the beginning (block 1302) of the modify subgroup profile screen 1300. If the entries are valid, then the routine proceeds to the modify group profile screen 700 (FIGS. 48-52) and the routine may proceed as described relative to FIG. 14.

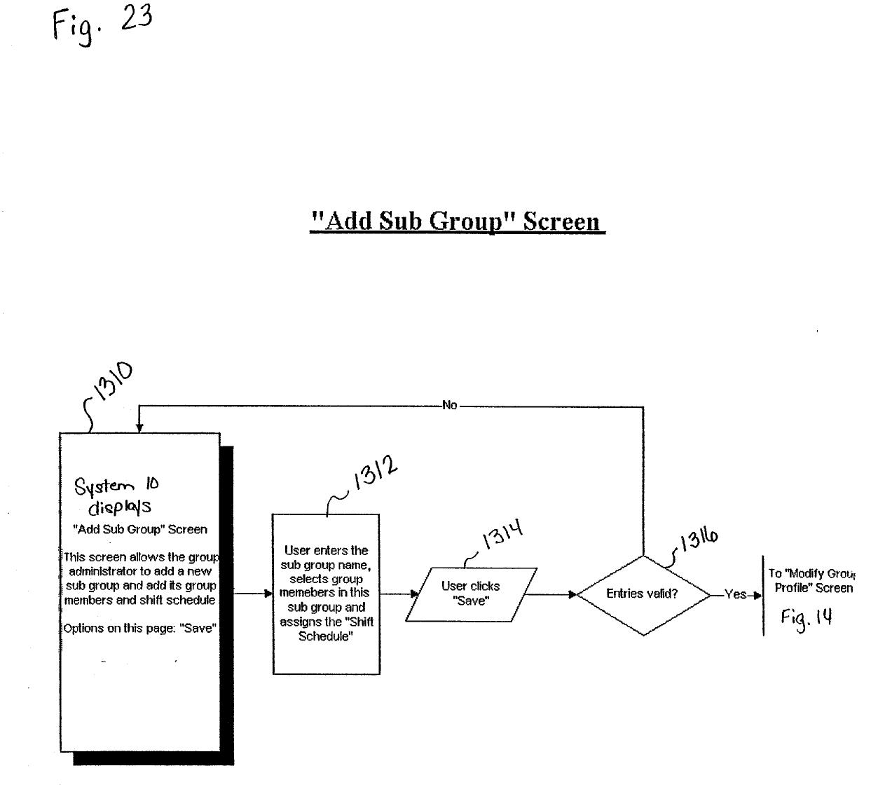

If the user elects to add a new subgroup or rule for the logged-in user's group, the user may select (block 784 in FIG. 14) the add new subgroup/rule link or button 700f (FIG. 52) whereupon system 10 displays (block 798 in FIG. 14) the add subgroup active server page 1300 (FIGS. 60-61). As with the routine described earlier relative to FIG. 23, the logged-in user may enter the subgroup name in area 1300a, and assign group members from the pull-down menu in area 1300b to the particular subgroup, along with associated shift schedule (block 1312 in FIG. 23) in the area 1300c. Thereafter, the user may select (block 1314 in FIG. 23) the save button 1300d (FIG. 61). The system 10 then determines whether the entries are valid (decision block 1316 in FIG. 23) and if they are not, returns to the beginning (block 1310) of the screen 1300. If they are valid, then the information is saved into the database 24 (FIG. 2) and the routine returns to the modify group profile screen 700 and the associated routine shown in FIG. 14.

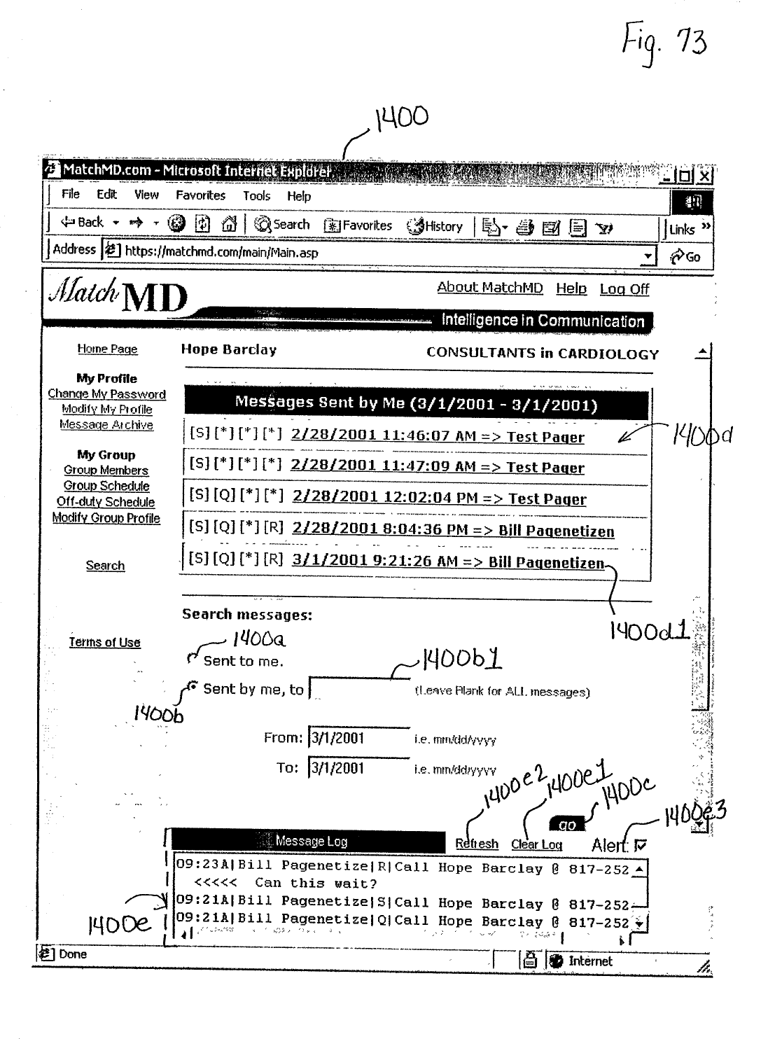

Referring back to FIG. 10 and the illustration being described, the logged-in user may elect to archive the message by actuating (block 508) the message archive button 70b4 (FIG. 43). The system 10 then displays (block 1401 in FIG. 32) the message archive screen 1400 (FIG. 73) in response which enables the user to select (block 1402 in FIG. 32) messages sent to the logged-in user or messages sent by the logged-in user to a particular member of the logged-in user's group using the buttons 1400a and 1400b and associated information 1400b1, such as name of recipient or date range in which the message was sent as illustrated in FIG. 73. The user selects (block 1404 in FIG. 32) the go button 1400c (FIG. 73), whereupon the system 10 searches the database 24 (FIG. 2) to locate the messages falling within the parameters entered by the logged-in user on the screen 1400. If no messages are found (decision block 1406), then the routine loops back to display the message archive screen 1400. If, however, messages are found, then the system 10 displays (block 1408 in FIG. 32) a line-by-line summary of each archived message in the area 1400d in FIG. 73. Note that the message log area 1400e in the screen 1400 in FIG. 73 displays all the message communications, both to and from the logged-in user, and any associated message.

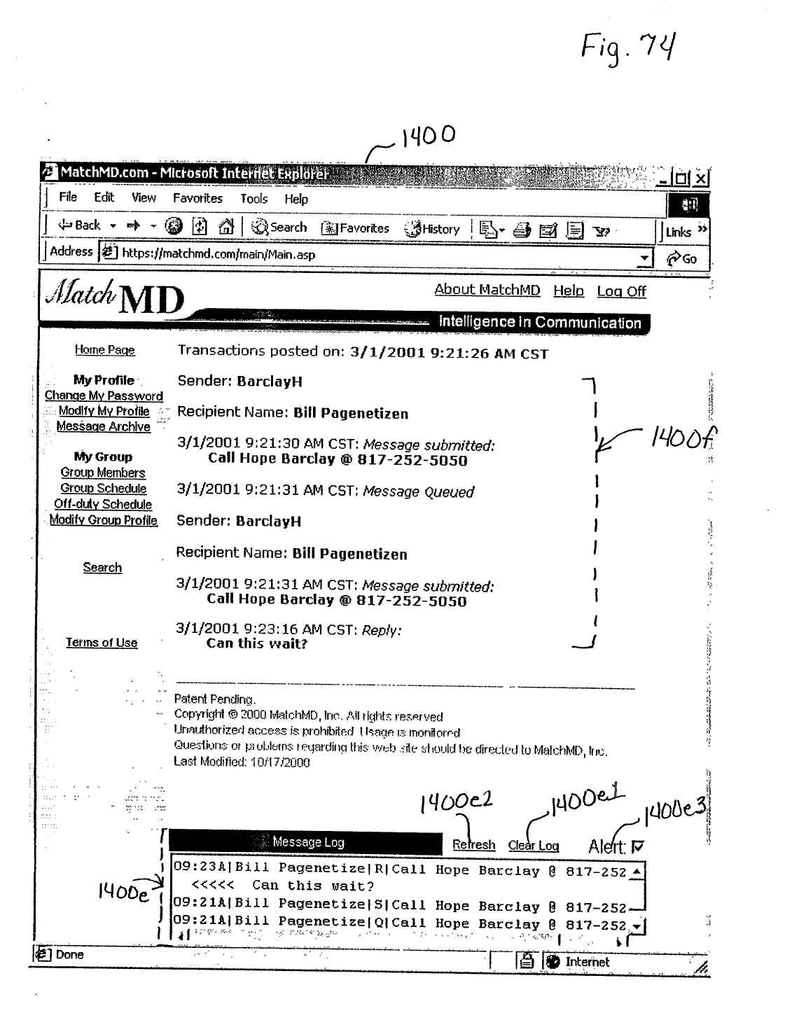

The logged-in user may select (block 1410 in FIG. 32) one or more of the messages, such as message 1400d1, and the system 10 displays (block 1412) the information 1400f (FIG. 74) associated with the selected message at block 1410 in FIG. 32. The logged-in user may clear the message log by selecting the clear log button 1440e1 or refresh the message log by selecting the refresh button 1400e2 in FIG. 73. Note that the message log area 1400e also includes an alert area 1400e3 which may be selected by the logged-in user. If the alert button 1400e3 is selected, then the system 10 will display an alert screen similar to the screen 240 (FIG. 58) described earlier herein whenever the pager sends a confirmation message ID back through the WAP/WTCP and the web. The recipient gets the page and the device sends a delivery notification back to system 10 within 5-10 seconds. When the user replies, another pop-up alert screen flashes with the body of the reply message.

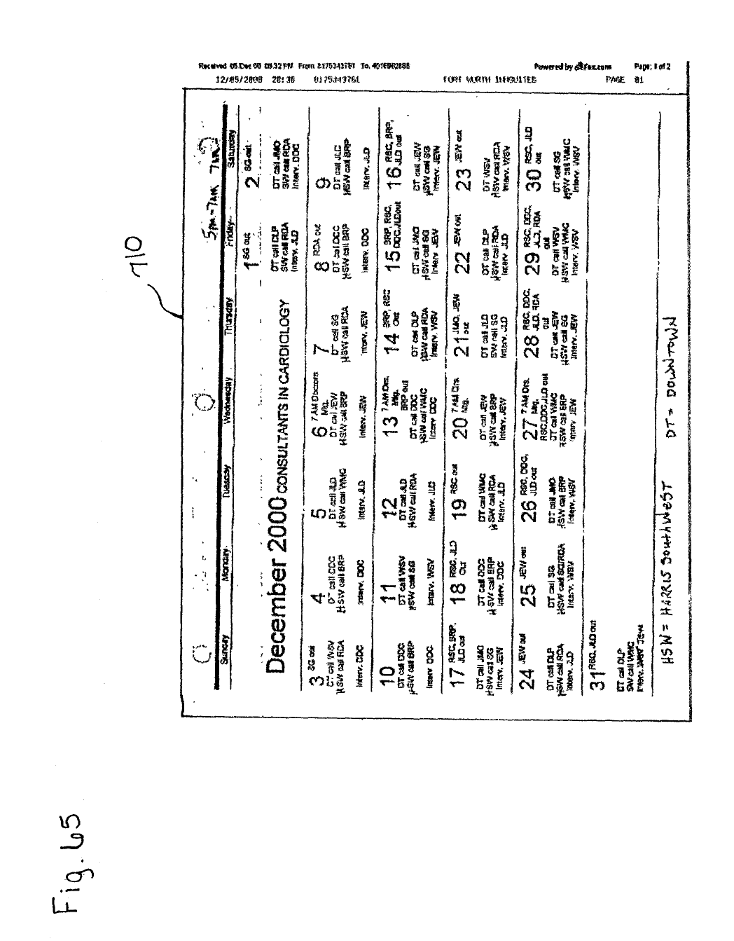

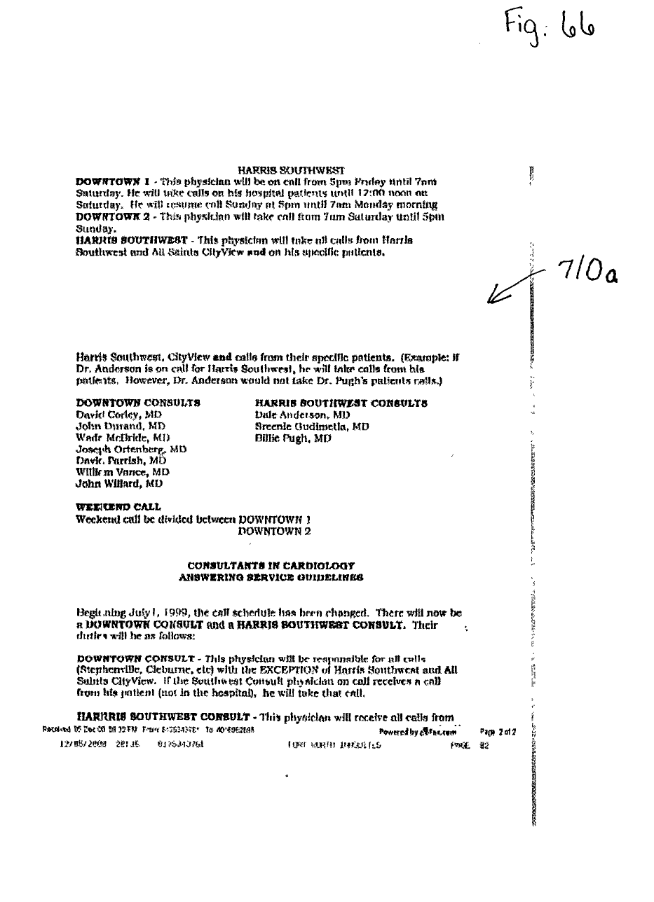

Referring back to the group staff navigation screen in FIG. 43, the logged-in user, which again in this illustration is a group administrator, may select to view or modify the group members of a group by selecting (for example, block 510 in FIG. 10, block 158 in FIG. 9 or block 138 in FIG. 7) the group members link 70b5 in FIG. 43 in the area 70b of screen 70. In response, the system 10 displays (block 1500 in FIG. 31) the information 70d1-70d4 described earlier herein relative to FIG. 43. If the logged-in user selects (block 1502 in FIG. 31) the group name 70d1 (FIG. 43) by clicking on the name “CONSULTANTS in CARDIOLOGY” link, then the routine proceeds to display (block 1510 in FIG. 30) the group members screen 70d4, which provides a list of all the group members associated with the group name 70d1 (FIG. 43). As illustrated in FIG. 43, the group member screen 70 lists all group members, such as physicians and staff, for a particular group. Note also that the system 10 displays the call and off-duty schedules in a calendar month for the group in a screen 710 (FIG. 65). Note that screen 64 shows the drop-down menus for selecting schedules. Conveniently, the schedule 710 in FIG. 65 provides on-call and off-duty work schedules for the members of the group, such as physicians in the group. Other information, such as answering service guidelines or rules 710a (FIG. 66) may also be provided to the user 14.

If the system 10 determines (block 1504 in FIG. 31) that the user has a paging device 18 (FIG. 1), then the system 10 displays a pager icon such as icon 71a in FIG. 43, at block 1506 in FIG. 31. Thereafter, the user may select that pager icon 71 a (block 1508), whereupon the routine proceeds to page the user in accordance with the routine described earlier herein relative to FIG. 34.

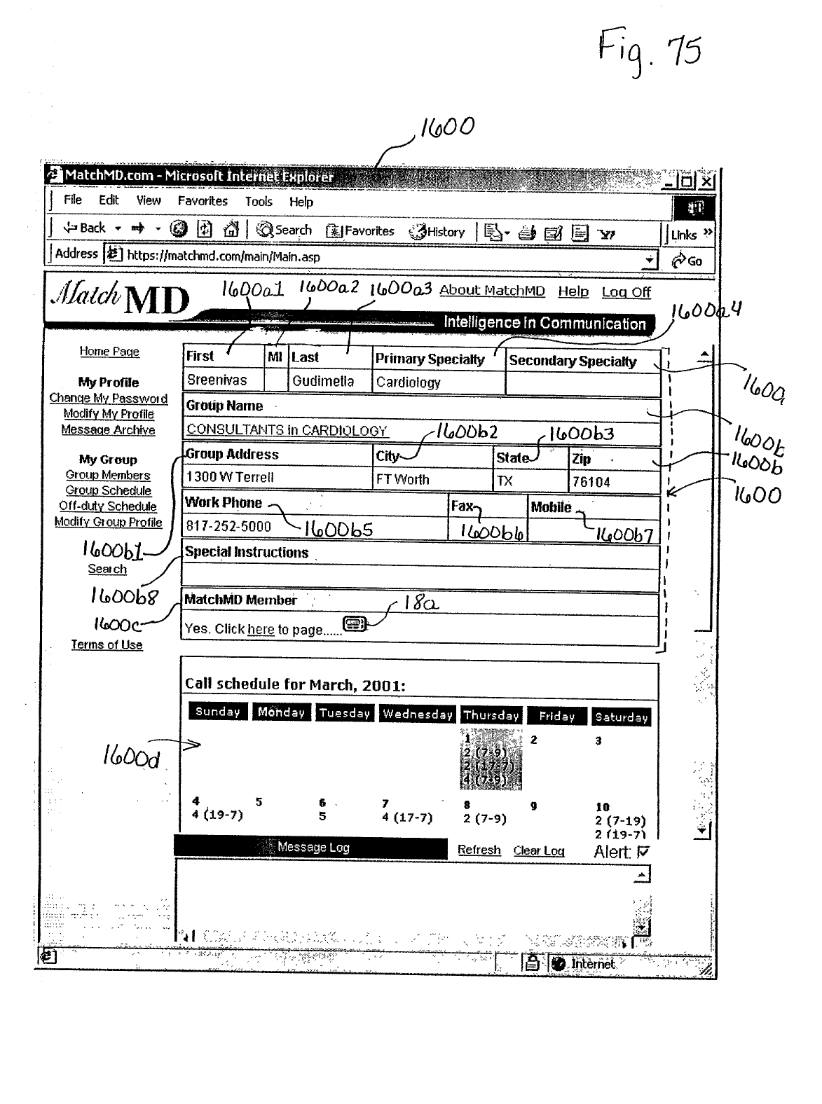

At block 1512 (FIG. 30), the user may double-click or select one or more of the physician names 71 (FIG. 43) and in response, the system 10 displays (block 1602 in FIG. 30a) the physician profile screen 1600 (FIGS. 75-77). The physician profile screen 1600 comprises physician information 1600a comprising first name 1600a1, middle initial 1600a2, last name 1600a3, primary specialty 1600a4 and secondary specialty 1600a5. The screen 1600 further comprises a group name 1600b (FIG. 75), which is the group to which the physician is a member, group address 1600b1, group city 1600b2, group state 1600b3, group zip code 1600b4, work phone 1600b5, fax number 1600b6, mobile phone number 1600b7, special instructions 1600b8 which provides instructions (not shown) which a user can enter to provide special instructions to users attempting to message the user. The call center/answering service can use these special instructions to determine how a physician wishes to be contacted. For example, a message, “please don't page me after 5 pm, please call me at 555-555-5555” may be selected by the user. All users of the system who attempt to contact the user will see the special instructions.

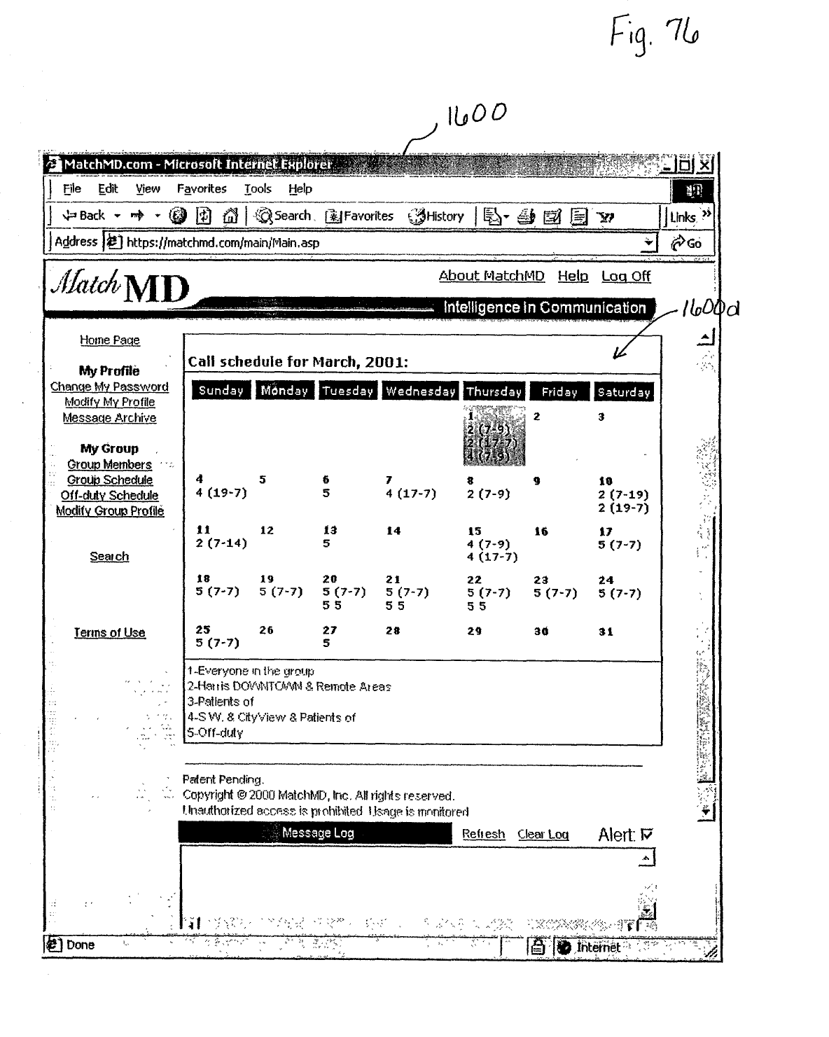

If the physician has access to a communications device 18, then a link is provided to enable a communication to the device in the area 1600c (FIG. 75). The page 1600 further lists the physicians schedule for a particular period, such as a month in the schedule area 1600d as illustrated in FIGS. 75 and 76. If the user selects (block 1604 in FIG. 30A) the group name, which in the illustration being described is “CONSULTANTS in CARDIOLOGY” in the area and link 1600b (FIG. 75), then a group member screen, such as the screen 70 illustrated in FIG. 43, for this particular physician is displayed.

Thus as described with respect to FIG. 30, the screen 70 (FIG. 43) displays information for a particular group, such as the “CONSULTANTS in CARDIOLOGY” group in the illustration being described. Returning to the screen 1600 in FIGS. 75-77, if the physician has a communications device 18 (block 1606 in FIG. 30A), then a pager icon 18a (FIG. 75) is displayed to allow users who have access to screen 1600 to actuate the icon 18a and page the physician directly (block 1610 in FIG. 30A). If the user selects (block 1612 in FIG. 30a) the pager icon 18a, then the paged user routine is performed in accordance with the routine shown and described relative to FIG. 44. It should be appreciated that the device 18 may comprise means or a circuit (not shown) which is able to respond to the wireless paging signal by dialing up, for example, an Internet Service Provider, making an internet connection and then performing the operations described generally herein relative to blocks 1712, 1714 and 1716 of FIG. 34.

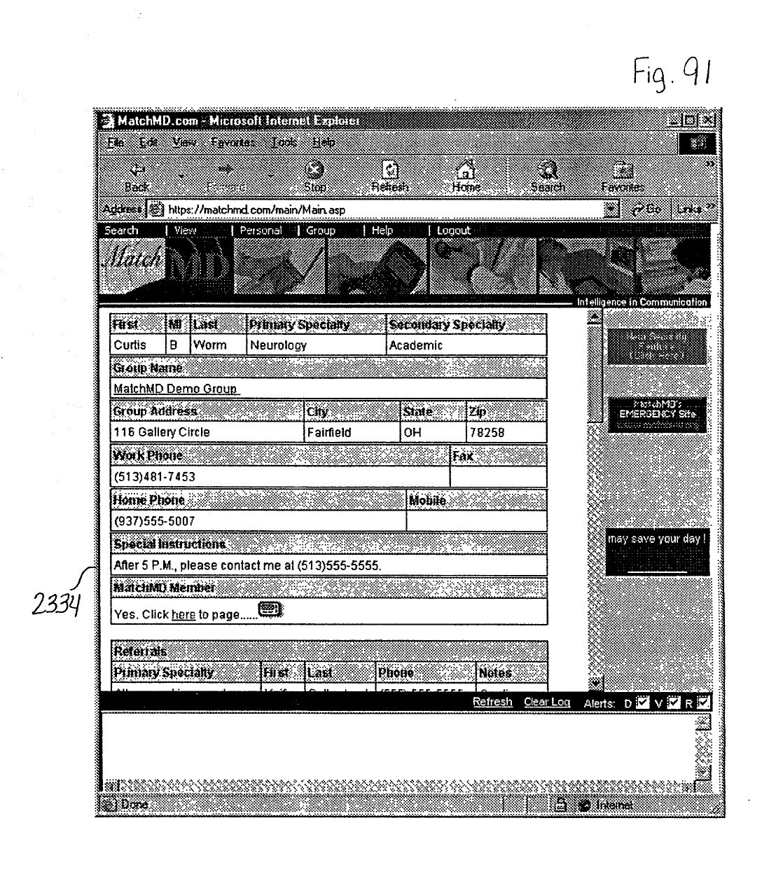

The user may also select (block 1608 in FIG. 30A) the last name of a referral entity, such as a listed referral doctor (FIG. 43) listed in this group in which case the system 10 displays the physician profile screen 2334 (FIG. 91) which is similar to the profile screen 1600 (FIGS. 75-77) and the logged-in user is given the options described to FIG. 30A.

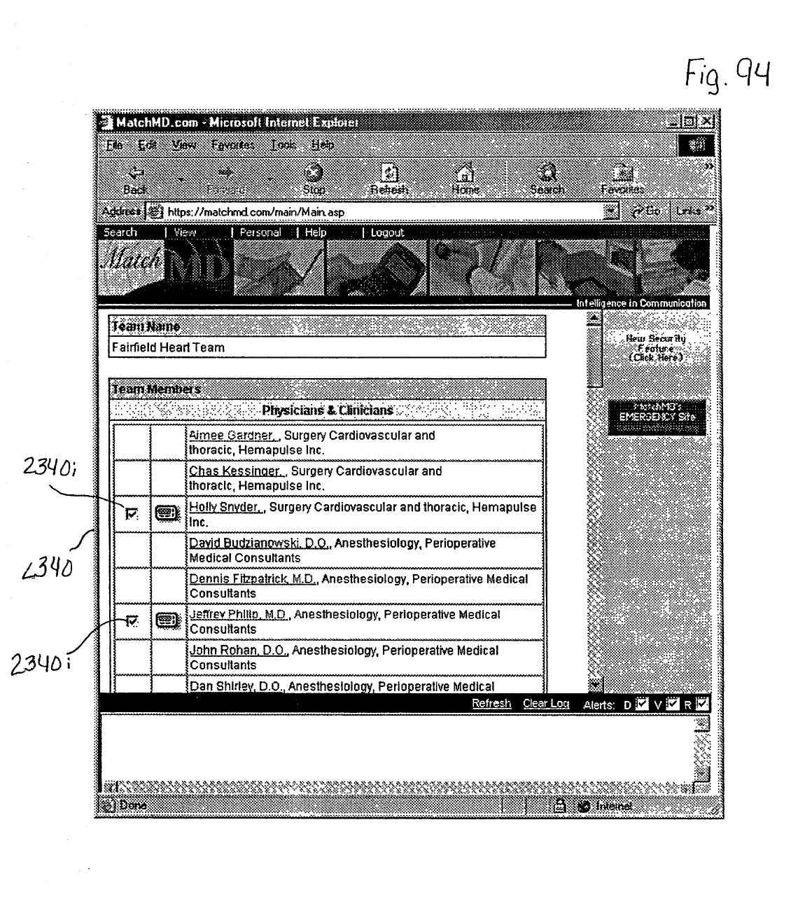

As mentioned, if a logged-in user elects to page a member of a group who has a communication device 18 (FIG. 1), the user selects, for example, the pager icon 18a in FIG. 75 or the icon 71a in FIG. 43. In response, the system 10 displays the paged users' screen 1700 in FIG. 70 that allows the logged-in user to select, enter and send a message to an individual, such as “Bill Pagenetizen” in the illustration shown in FIG. 70. As mentioned earlier, the logged-in user accesses this page 1700 by actuating the pager link or button, such as button 18a. System 10 displays plurality of default messages in a default field 1700a and also comprises an area 1700b wherein the logged-in user may write a message to the person being paged. In the illustration being described, the group administrator, Hope Barclay in the illustration, is using screen 1700 to prepare a message to Bill Pagenetizen to have Pagenetizen call her. At block 1704 (FIG. 34), the user selects the text message type at the area 1700a (FIG. 70) and enters a message 1700b1 in an area 1700b. In the areas 1700c, the user may provide or enter the predefined responses for the recipient. The user then actuates (block 1708 in FIG. 34) the send or go button 1700d (FIG. 70) in which case the system 10 causes (block 1712 in FIG. 34) the message to be sent to all paging devices that the user has selected. As illustrated in FIG. 94, the system 10 may display a screen 2340 for a particular group. The user may then select which persons receive a paging message by selecting the box, such as box 2340i and 2340ii next to a name. As shown in FIGS. 2 and 3, the message selected or entered on the active server page 1700 (block 22 in FIG. 2) is sent via database 24 to at least one of the paging/phone WCTP or WAP ServerX servers 25, 26 or 28 in the illustration. The recipient server 25, 26, or 28 communicates the message to at least one network carrier 30-34, which transmits the message to the recipient 20, Bill Pagenetizen in the example. One of the servers 25, 26 or 28 sends out the message via the world wide web to that recipient's WTCP/WAP device server 25, 26 or 28 which locates and sends the message to the device 18. The device 18, in turn, sends a reply tag back through the same path to the server which sent the message.

Thereafter, the system 10 loops or continuously attempts to send the message until a return reply is received (blocks 1714 and 1716 in FIG. 34). The system 10 causes the progress of the message sent and the reply to be displayed in the message log area 1700e (FIG. 70). This is illustrated by the progress information 1700e1 in the area 1700e in FIG. 72. Note that the system 10 also displays on the active server page 1700 a notice 1700g (FIG. 72) that the message was submitted.

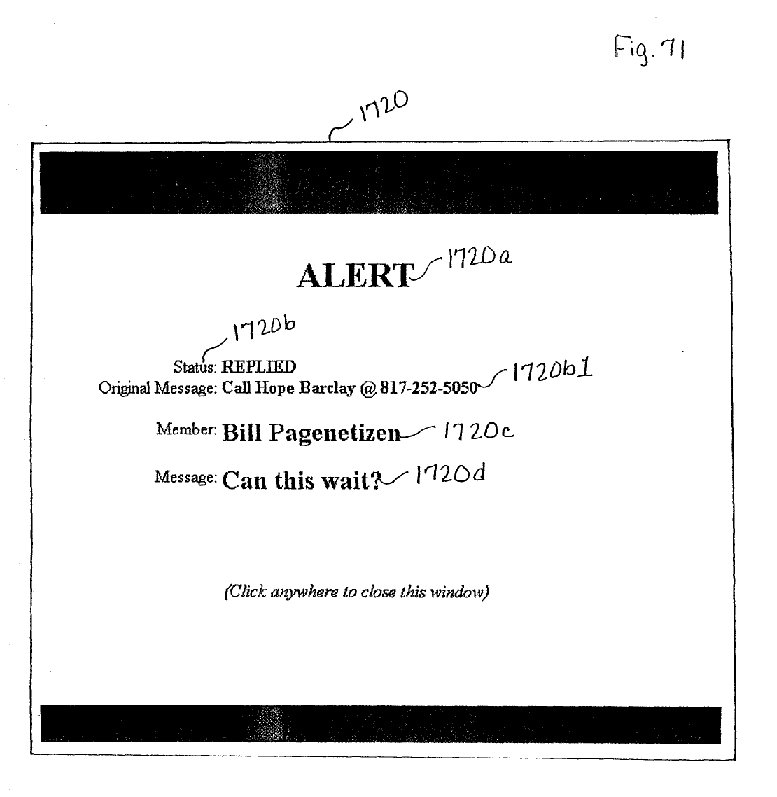

After system 10 detects that a reply has been received (block 1716 in FIG. 34), an alert screen 1720 (FIG. 71) is displayed (block 1718 in FIG. 34). Note that the alert message screen 1720 comprises a notification 1720a, a status message 1720b, the original message 1720b1, the name of the group member 1720c and a reply message 1720d. Note also that the reply message may be one of the response messages entered by the sensor in the response message area 1700c (FIG. 70) or may be a new message that is sent by the recipient, which is Bill Pagenetizen in the illustration being described. As illustrated in FIG. 36, the alert screen is displayed (block 1729 in FIG. 36) a response or reply message 1720d (FIG. 71) that was received from two-way communications device 18. The system 10 displays the response (block 1730 in FIG. 36) from the communications device 18 on the screen 1720 (FIG. 71). After the reply message has been received, the user may click anywhere (block 1732 in FIG. 36) on the screen 1720 (FIG. 71) and system 10 then closes the screen (block 1734) in response.

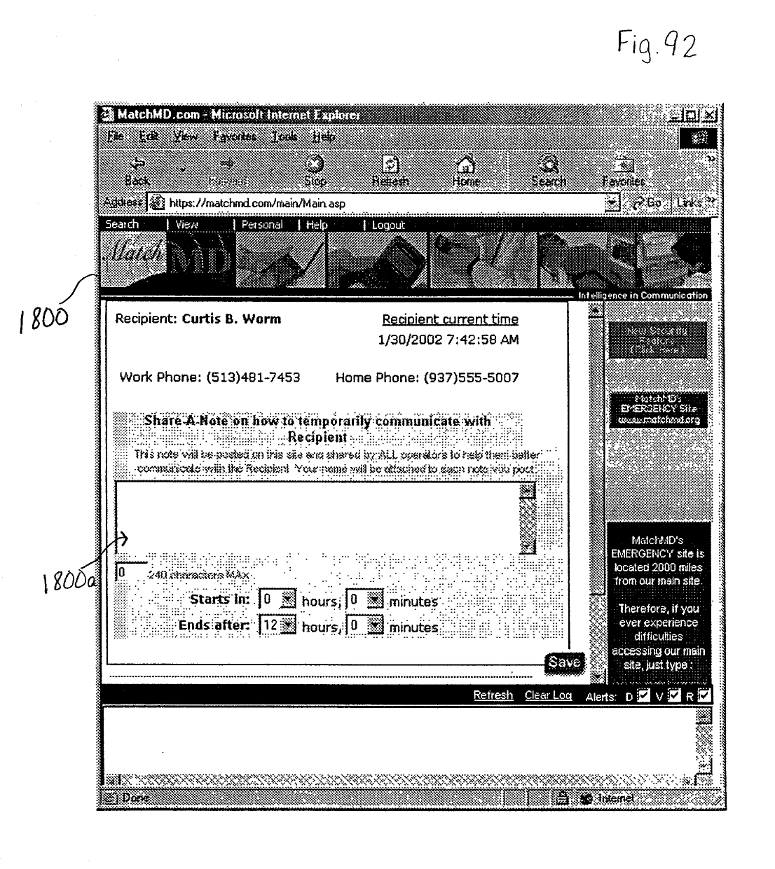

Returning to FIG. 34, the display 1700 (FIG. 70) further comprises a share-a-note feature next to block 1700f in FIG. 70 during which the system 10 displays (block 1706) all notes previously entered by a user using the share-a-note feature. The logged-in user may then actuate (block 1710 in FIG. 34) the share-a-note button 1700f (FIG. 70). In response, the system 10 displays (block 1802 in FIG. 37) the share-a-note screen 1800 FIG. 92 that allows the logged-in user to leave a note (not shown) for users who have paged the selected user. For example, a logged-in user may leave a “on vacation, contact Dr. Walker who is covering for me” message that is sent in response to anyone who attempts to page him. The note is available for a selectable time period and is then automatically removed by the system 10. Thus, in the area 1800a (FIG. 92), the user enters (block 1804 in FIG. 37) a note and then selects the start and end times during which the note will be available. At block 1806 in FIG. 37, the user selects the save button and the information is saved by the system 10 in database 22 (FIG. 2). Thereafter, the routine returns to the page users screen 1700 (FIG. 70) and the associated routine described relative to FIG. 34. It should be appreciated that the share-a-note feature enables a logged-in user to provide information relative to other users who will page the selected user.

It should be appreciated that the message log screen 1700e in FIGS. 70 and 72, 70d in FIG. 43; 600c in FIG. 45; 700c in FIGS. 48-52; 70d in FIG. 59; and 1400e in FIGS. 73 and 74 displays the progress of messages sent to a recipient. The system 10 displays (block 1900 in FIG. 35) the message log screen 70d (FIG. 43) and main text (block 1902 in FIG. 35) comprises the main message area, such as the message 1700e1 in FIG. 72. The system 10 displays the progress of the communication sent by users. If the user selects (block 1904 in FIG. 35) the refresh link 70d2ii, then the database 24 (FIG. 2) is searched (block 1910 in FIG. 35) by system 10 for new responses. If the user selects (block 1906 in FIG. 35) the clear log button 70d3iii, then the system clears (block 1912 in FIG. 35) the text box area 70d1i. If the user selects (block 1908 in FIG. 35) the alert button 70d4iv, then the system 10 ceases looking for messages in the database 24 (block 1914). As mentioned earlier, if the user selects the alert button 70d4iv, system 10 toggles the flashing notification screen on and off (FIGS. 58 and 71).

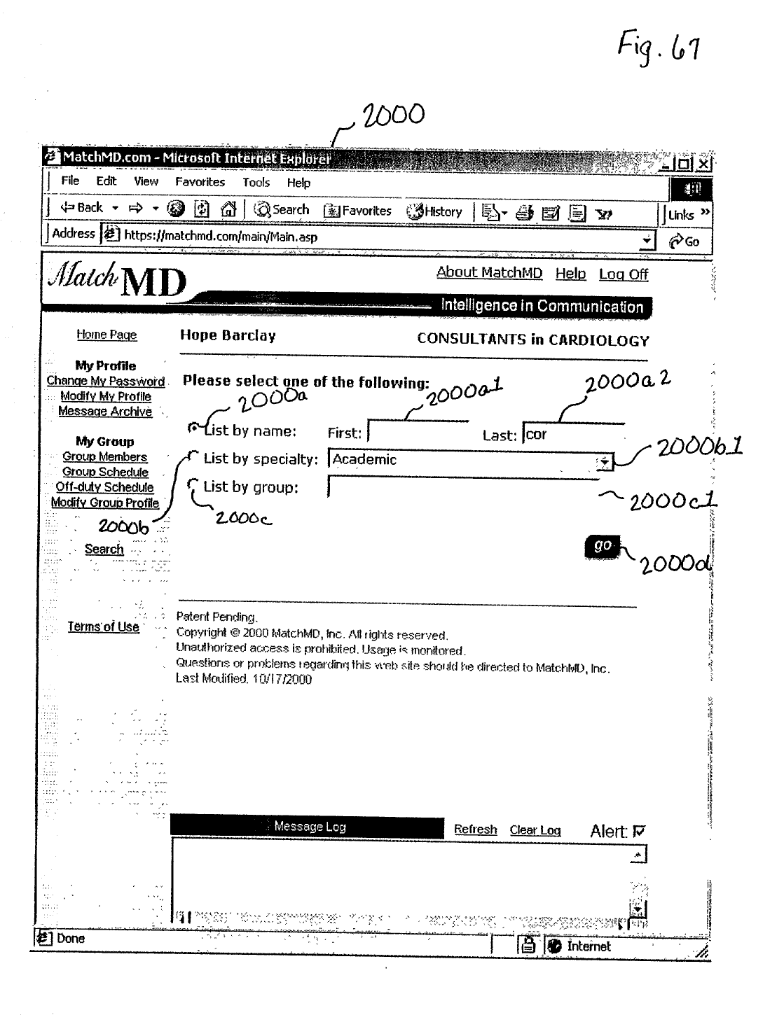

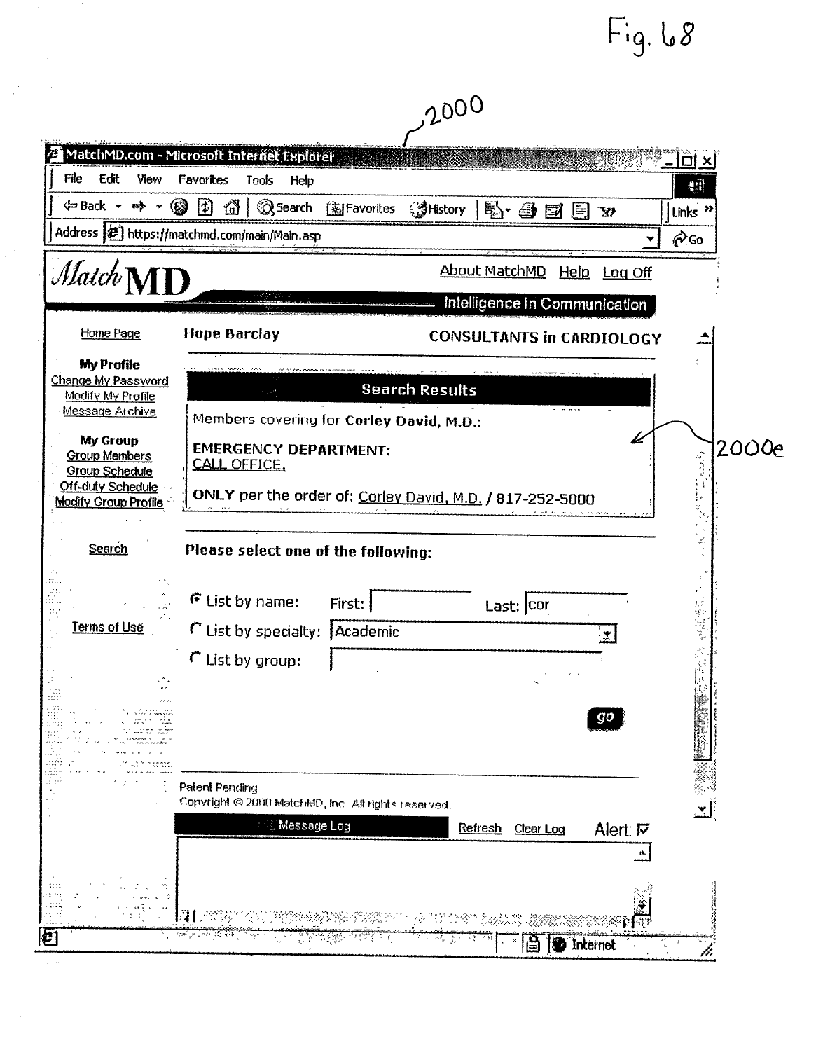

Referring back to screen 70 in FIG. 43, the system 10 also enables the logged-in user to perform a search (block 512 in FIG. 10) by selecting the link 70b9 (FIG. 43). The system 10 displays (block 2002 in FIG. 33) a search screen 2000 (FIG. 67) in response. The screen 2000 allows the logged-in user to search for active members in the database 24. In the physician illustration described, the search results will indicate whether a group member is on-call, off-duty, or has another physician covering for the physician searched. The search screen 2000 comprises three search categories, namely, list by name 2000a, list by specialty 2000b, and list by group 2000c. As illustrated in FIG. 67, the list by name button 2000a comprises a first name area 2000a1 and a second name area 2000a2. The list by specialty comprises a pull-down menu of specialties 2000b1, and the list by group category 2000c comprises an area 2000c1 in which the logged-in user may search a particular group name. If the user selects (block 2004 in FIG. 33) the list by name button 2000a (FIG. 67), then the user enters the first and/or last name in the areas 2000a1 and 2000a2, respectively. The user then selects (block 2014 in FIG. 33) the go button 2000d (FIG. 67) and the system 10 searches the database 24 for the desired information. At block 2020 in FIG. 33, if the results are found, then the information is displayed for each group member found. Note in the illustration being described, that the logged-in user entered the letters “COR” in the area 2000a2 (FIG. 67) and after selecting the go button 2000d, the system 10 returns the search results in the area 2000e (FIG. 68) of the page 2000 for the members of the database 24 and information associated with the member found. In the example, the system 10 located David Corley, M.D.

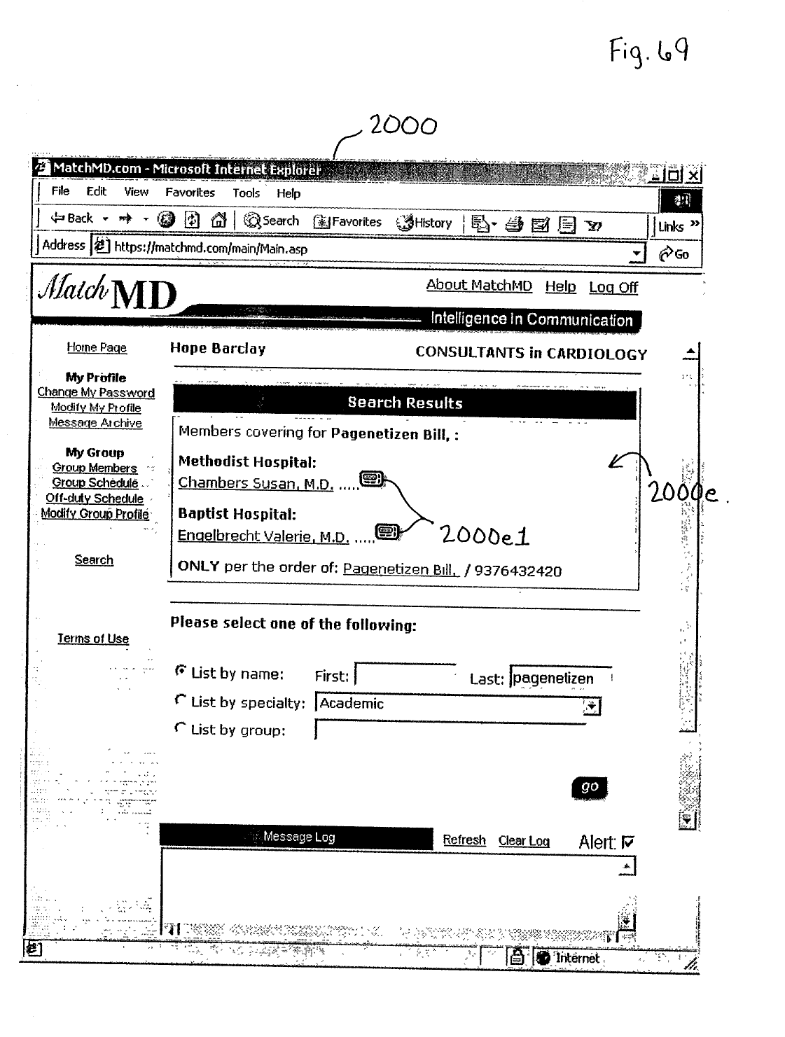

It should be understood that the system 10 displays all subgroups that this member's group has, as well as who is on-call for each such subgroup. For example, if the search was for “pag,” the system 10 searches and locates “Pagenetizen, Bill” (FIG. 69) in the illustration. The system 10 displays the subgroups, Methodist Hospital and Baptist Hospital in the illustration, and covering physicians Susan Chambers and Valerie Engelbrecht. The paging icons 2000e1 (FIG. 69) for any members that have a communication device 18 are also displayed. By further example, in the search results for Bill Pagenetizen shown in FIG. 69, the display is a display of physicians who are on-call for him, such as the physicians Susan Chambers and Valerie Engelbrecht. As illustrated in FIG. 69, the system 10 automatically gives any logged-in users the ability to search for physicians and identify associated physicians who are on-call for that physician. The system 10 further gives such logged-in users the ability to page the on-call physicians as desired. Thus, after the information is displayed (block 2024 in FIG. 33), the user may click (block 2012) on a pager icon 2000e1 (FIG. 69). The system 10 responds by displaying the page user screen 1700 (FIG. 70) described earlier. The system 10 proceeds in accordance with the routine described earlier herein relative to FIG. 34.

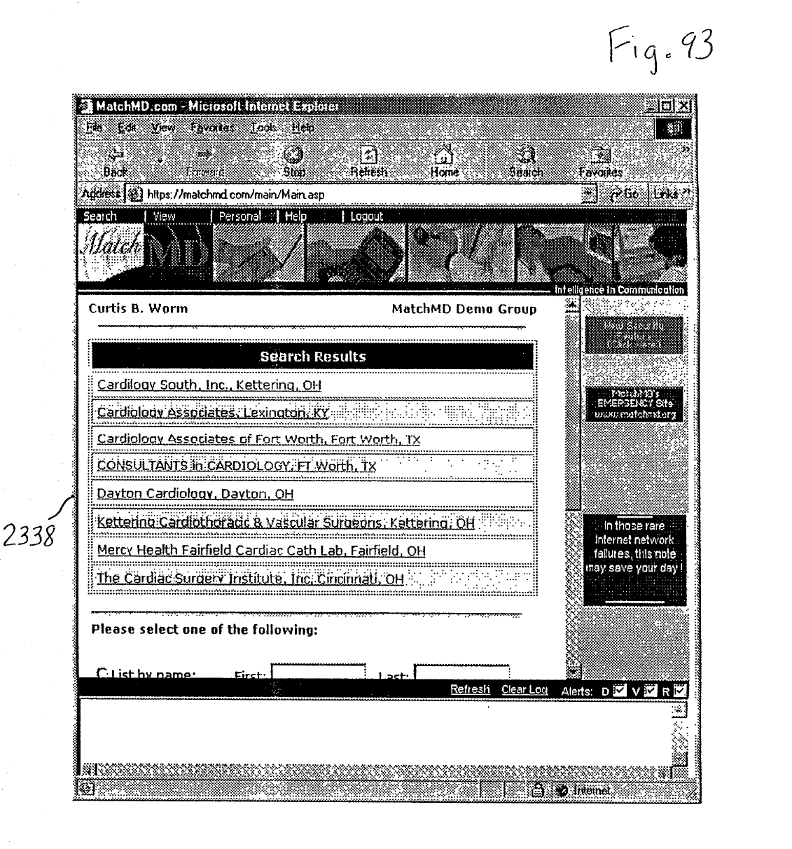

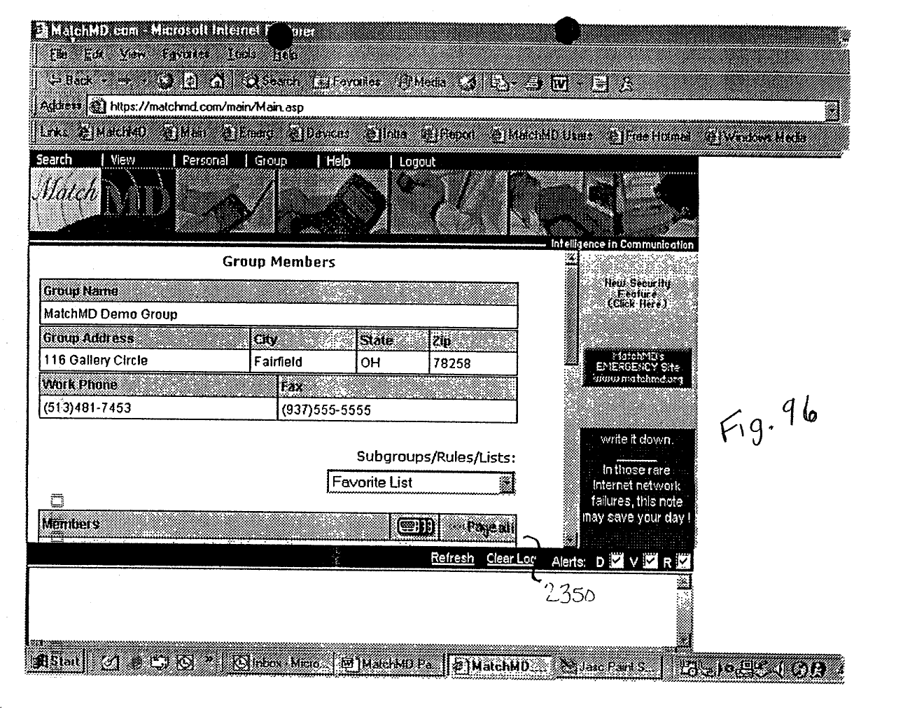

Returning back to the routine shown in FIG. 33, the user may select (block 2006) the list by specialty button 2000b (FIG. 67) and select a corresponding specialty in area 2000b1 after which the routine proceeds to the block 2014 (FIG. 33) as shown. The user may also select (block 2008 in FIG. 33) the list by group button 2000c in which case the logged-user enters a group name in the area 2000c1 (FIG. 67) and selects (block 2016 in FIG. 33) the go button 2000d (FIG. 67). If the system 10 finds results (block 2022 in FIG. 33) in the database 24, then the routine displays each group found with a link to that group's profile, such as the profile displayed in FIG. 33 for the “CONSULTANTS in CARDIOLOGY” group. Group profiles will list members of the group and contain links to the members with the group as illustrated in screen 2338 (FIG. 93), in which case system 10 displays a screen (not shown) similar to the screen 700 (FIGS. 48-52). Also, displayed is the team screen 2340 (FIG. 94) to allow a logged-in user to send the same message to members of a particular team or group at block 2026, by checking the boxes 2340i and 2340ii as mentioned earlier. It should be understood that the team is a special group that shares member's schedules (member of different companies and individual groups and their respective call schedules) across an area. If the searched for group is part of a team, it will have a page team icon on blue bar 2350 (FIG. 96).

If no results no search results are found in response to a search (block 2022 in FIG. 33), then the routine loops back to block 2008.

It is contemplated that the system 10 may enable a national search of all counties listed in the database 24 for the particular logged-in user or may permit only counties assigned to a group to be searched. Note that system 10 assigns each group a group code number. If it is determined at decision block 2010 in FIG. 33 that this feature has been enabled for this particular logged-in user, then the user may select a list by group code block 2018 in FIG. 33. If the user knows the group code number, the user can enter it into the group field in the search screen, and the server will find and display information for that group. The routine then proceeds to block 2016 as shown.

Returning to FIG. 10, the logged-in user may select (block 514 in FIG. 10) the terms of use button 70b10 in FIG. 43 in which case the terms of using the system 10 are displayed (block 520 in FIG. 10) so that any user who has logged into the system 10 can view the terms and conditions under which their use of the active server pages and information thereon is governed.

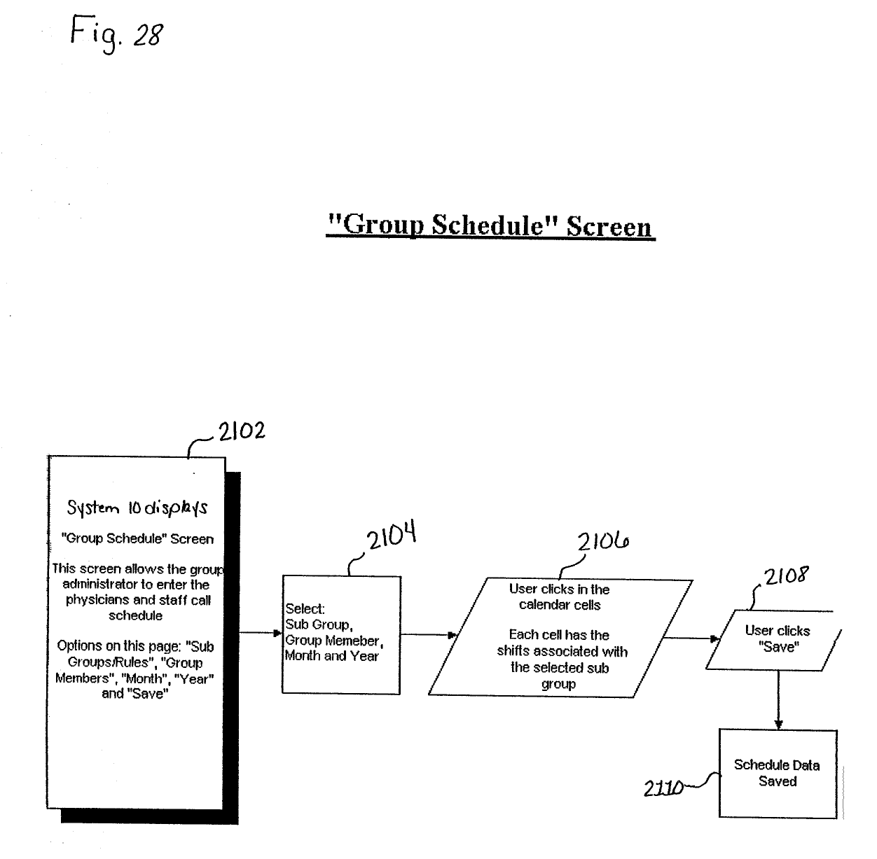

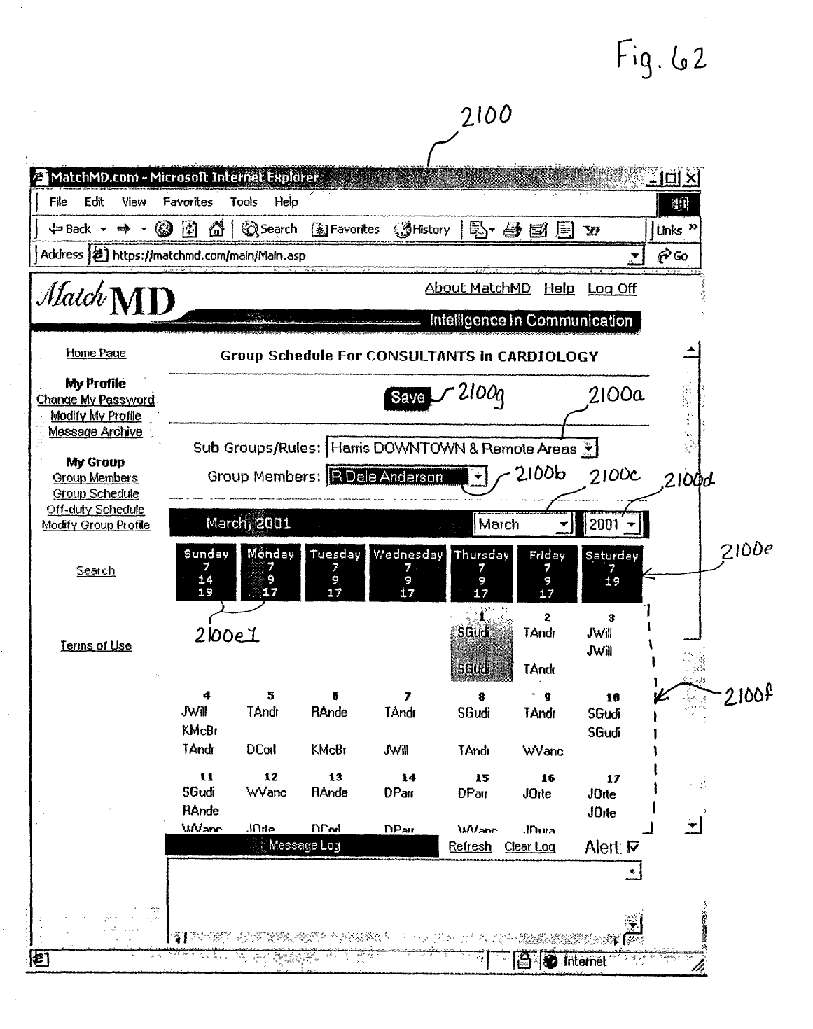

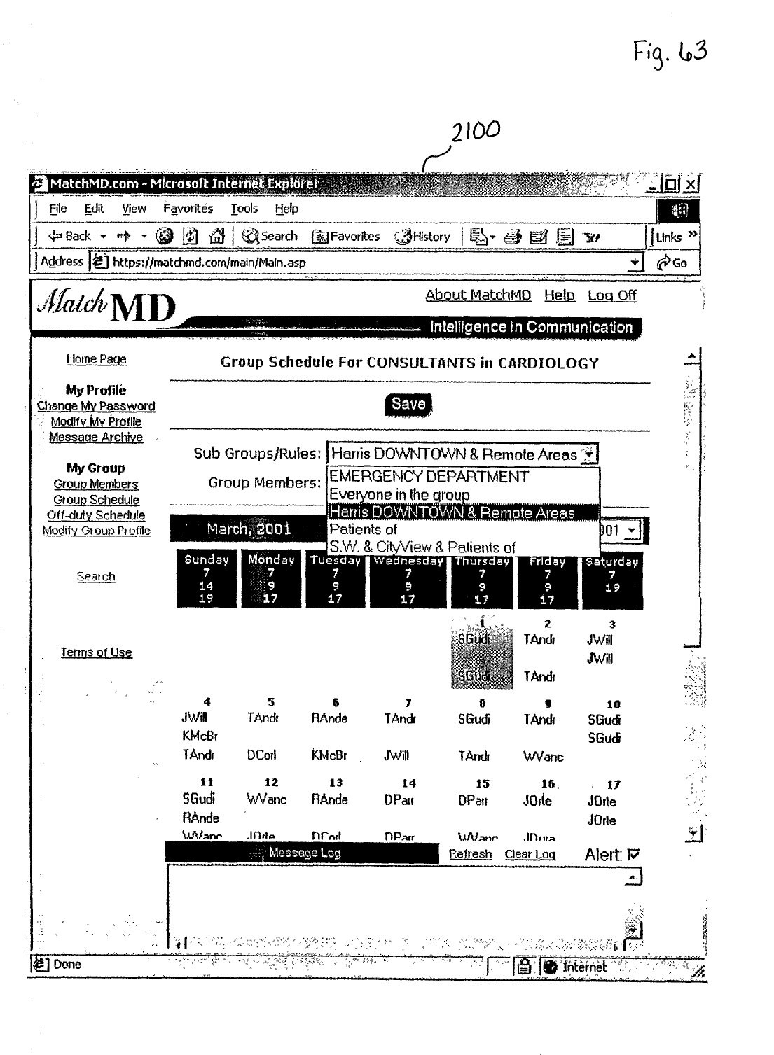

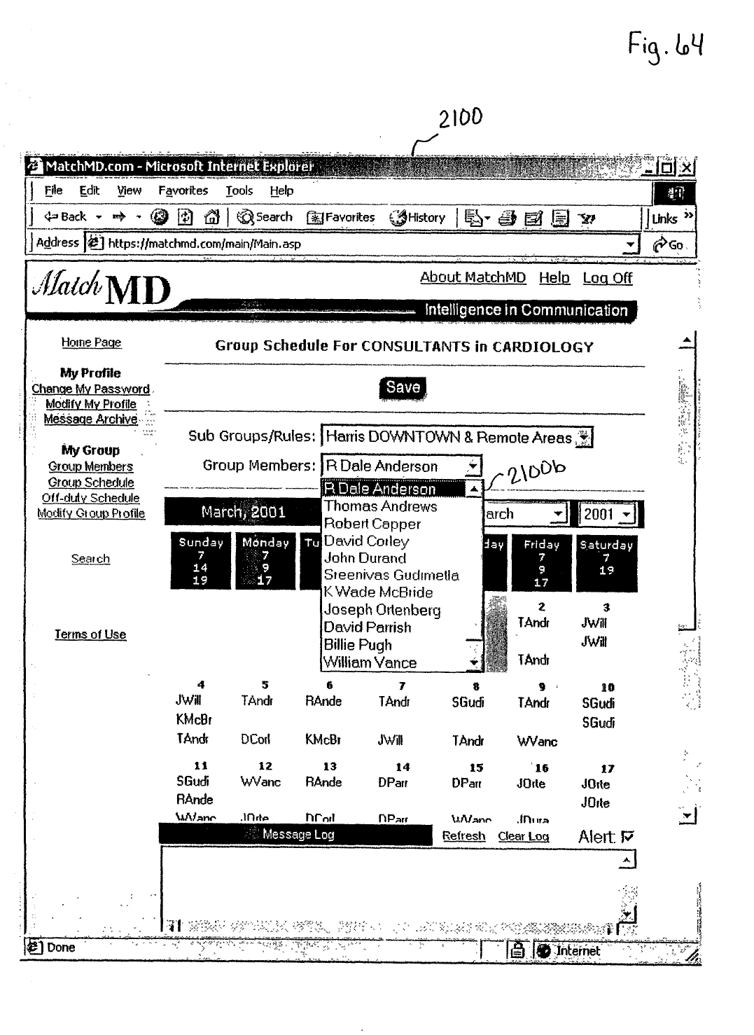

As mentioned earlier herein, various access level privileges to information on the database 24 (FIG. 2) are established for each logged-in user. In the illustration being described, a logged-in user, such as a staff member, may be given limited access to, for example, group information or group member information, while a physician may be given further access to view, edit, modify, delete or add information relative to himself or herself. Further, a greatest level of access may be provided to a group or system administrator who can view, modify, edit, delete or add information relative to the group or any of its members. This information may include the schedule for the group and for each member of the group. For example, an on-call schedule and an off-duty schedule may be programmed into the database 24 (FIG. 2) by the group or system administrator. To facilitate this feature, the screen 70 (FIG. 43) that is displayed for the group or system administrator will comprise additional links, including links to the group schedule 70b6, off-duty schedule 70b7, and modify group profile 70b8 described earlier herein relative to FIG. 14. When the user 14 logs into the system 10, the system determines (block 516 in FIG. 10) whether the logged-in user is a group administrator. If he is, then the system 10 displays (block 2102 in FIG. 28) the additional links mentioned. If the logged-in group administrator selects (block 522 in FIG. 10) the group schedule link 70b6 in FIG. 43, then system 10 displays a group schedule screen 2100 (FIGS. 62-64) that allows the logged-in group administrator to enter a call schedule for a physician or staff member or other member of the group. The logged-in user may select (block 2104 in FIG. 28) the subgroup 2100a (FIG. 62), group members 2100b, the month 2100c and year 2100d desired. As illustrated in FIG. 63, the user may select a subgroup in the area 2100a as illustrated in FIG. 63 and the group members in the area 2100b, as illustrated in FIGS. 63 and 64, respectively. The user 14 then selects (block 2106 in FIG. 28) the various cells, such as those cells highlighted in the row 2100e of screen 2100 in FIG. 62. In the embodiment being illustrated in FIG. 62, the cells 2100e1 listed in the row 2100e provide a key for the calendar area 2100f for the area that follows. In the embodiment being described, each cell has a work shift associated with the selected subgroup 2100a and group member 2100b. In the illustration being shown in FIG. 62, three shifts are shown for Sunday, with the first shift beginning at 700 hours (GMT), the second shift beginning at 1400 hours and the third shift beginning at 1900 hours. In the corresponding date for Sunday in March 2001, a doctor is identified as being on-call for each shift. For example, note for Sunday, Mar. 4, 2001, Drs. JWill, KMcbar and TAndr, respectively, are on schedule for each of these shifts.

After the logged-in administrator has entered the schedule for each doctor, the save button 2100g (FIG. 62) is selected (block 2108 in FIG. 28) and the schedule data entered by the logged-in user is saved (block 2110 in FIG. 28) into the database 24 (FIG. 2).

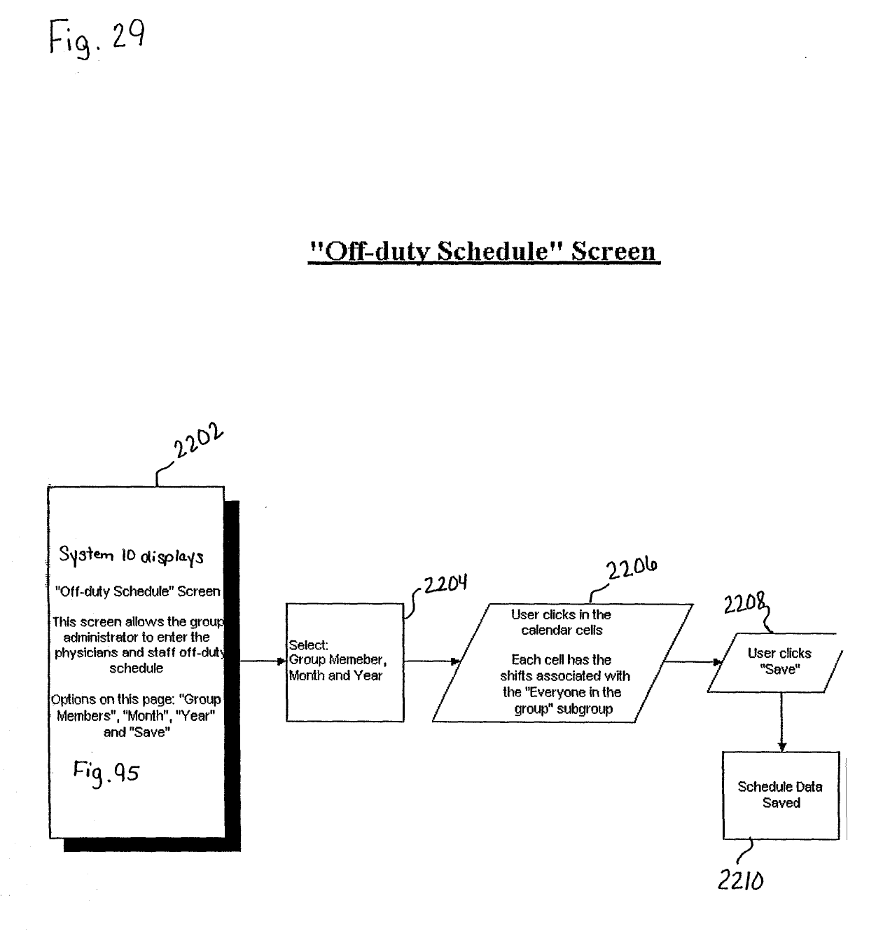

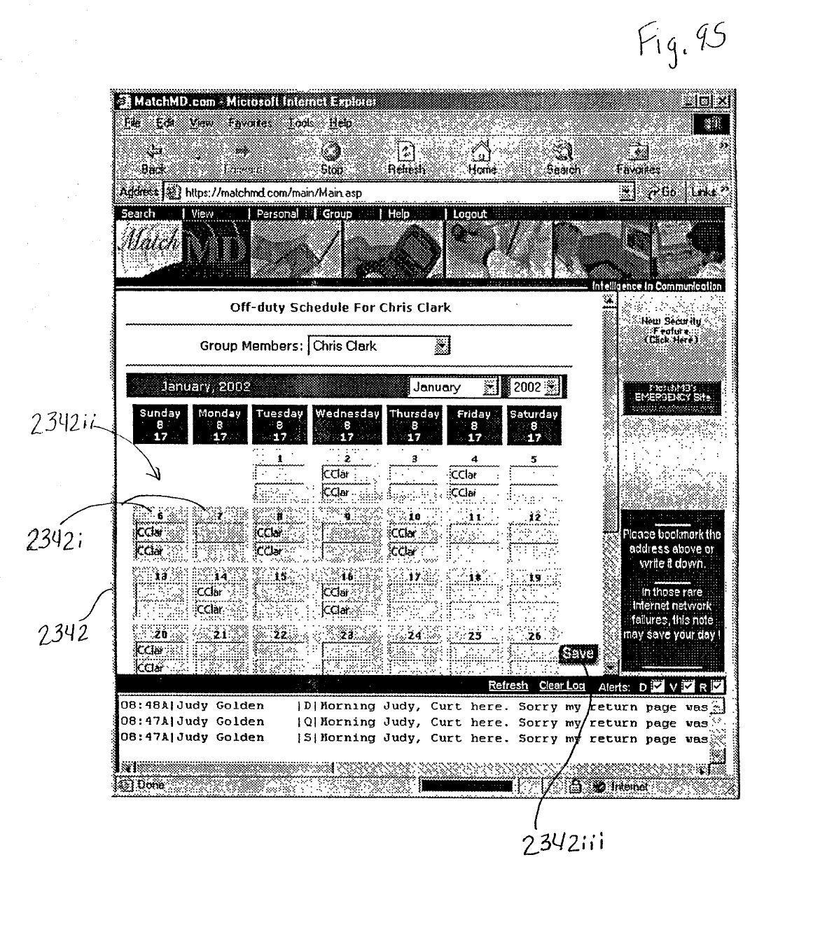

Returning to FIG. 10, if the group administrator selects (block 524 in FIG. 10) the off-duty schedule, then the system 10 displays (block 2202 in FIG. 29) the off-duty schedule screen 2342 (FIG. 95) which looks the same as the screen 2100 shown in FIG. 63, except the schedule is labeled “Off-Duty,” as illustrated in the screen 2342 in FIG. 95 and allows the group administrator to enter the physician, staff or other group members who are off-duty schedule. In a manner similar to the routine described relative to FIG. 28, the user selects the group member, month and year (block 2204 in FIG. 29), selects the calendar cells 2342i (FIG. 95) (block 2206 in FIG. 29), and then modifies the shift and schedule information listed in the calendar 2342ii in FIG. 95. Thereafter, the user selects the save button 2342iii (block 2208 in FIG. 29) and the system 10 saves (block 2210 in FIG. 29) the information entered by the logged-in user into the database 24 (FIG. 2).

As shown in FIGS. 10 and 43, if the user selects the Modify Group Profile link 70b8 (block 526 in FIG. 10), then the group profile link 70b8 in FIG. 43 then the modify group profile screen 700 (FIGS. 48-52) is displayed and the user 14 and system 10 may proceed as described earlier herein relative to FIG. 14.

If the user 14 select a group staff name (block 1514 in FIG. 30) then the routine proceeds as shown to the group staff profile screen and the routine described earlier herein relative to FIG. 31. Note also that if the system 10 determines (block 1516 in FIG. 30) that the logged-in user belongs to the group by checking the user's login ID against a master database of identification numbers stored in database 24, then the routine proceeds to show a pager icon next to each member to allow users to page a group member directly (block 1518 in FIG. 30). Thereafter, the routine proceeds to block 1520 where a team icon, similar to the icons mentioned earlier, to send the same message to a group of members directly, whereupon the system 10 sends a group message. If the user belongs to the group and has modification privileges, they can modify the group staff profile. The routine then proceed to block 1522 in the event the user selects a pager icon such as the link 71 a in FIG. 43 whereupon the routine proceeds to the page user screen 1700 and the routine described relative to FIG. 34.

Advantageously, this system and method provide means for providing a centralized database and communications system for enabling users to quickly identify groups, members of a group and various information associated with those groups and members. The system and method enables logged-in users to communicate to group members using the wireless communication transfer protocol and wireless application protocol in an HTTP and HTTPS Internet. The system provides architecture and means for allowing a multi-tier application environment that enables end users to submit a message to a recipient and immediately disconnect from the network. In this regard, the Internet user can quickly access and send a message to a recipient and the message is stored on the database 24 for delivery, rather than being dependent on the user being in direct contact with the recipient as has been required in the past.

A significant advantage of this system and method is that it enables logged-in users to quickly identify not only physicians, but also the referring physicians associated with a particular physician and both the physicians and referring physicians schedules. The system and method further enable a convenient on-call information to be provided for a group and for the members of the group. Significantly, the logged-in user can immediately page a member of a group who has an associated communications device 18. Thus, for example, an affiliated or non-affiliated clinician or office may publish and edit an on-call schedules for a particular physician, a patient list for a physician or group of physicians and the like. Institutes, such as hospitals, clinics, urgent care facilities and other institutions may also publish or edit schedules for member staff or physicians. A group or system administrator is given access to the system 10 database 24 (FIG. 2) so that the database 24 can be added to, modified, updated or deleted so that future users of the system 10 can be provided with information about a group or about a member of the group. For example, as mentioned earlier herein relative to the screen 1600 illustrated in FIGS. 66-67, an on-call schedule for a particular time period, such as a month in the illustration being described, can be provided for a particular physician within a group. This is convenient for both the physician's office and any other persons who are interested in the physician's on-call schedule, including the physician himself.

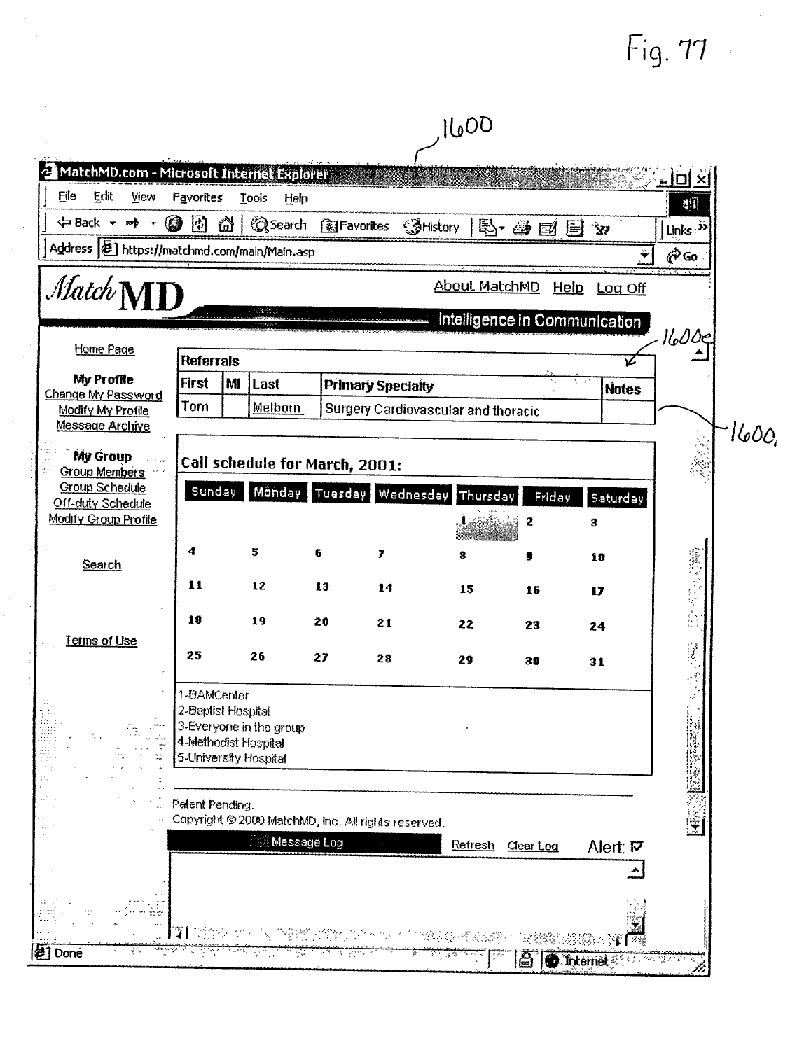

Conveniently, the system also provides users the ability to identify referral physicians, such as the referral physician 1600f (FIG. 77) identified in the referral physician area 1600e. Thus, a user who is interested in learning who a particular physician prefers to refer patients requiring a specialty can be quickly identified. In the illustration being described, the doctor referred to at 1600a1-1600a3, Sreenivas Gudimetla, prefers to refer patients requiring cardiovascular and thoracic surgery to Dr. Tom Melborn, as identified in the referral area 1600e (FIG. 77).

The system 10 also permits establishing rules for a member or a group. These rules may be, for example, a physician's geographic limits, hospital privileges or even area of specialty.

Referring back to FIG. 7, if the system 10 determines that the user is a group staff member (block 128), then the group staff navigation screen (see FIG. 43) in Group Members screen (see FIG. 43A) are displayed and the method proceeds in accordance with the routines described earlier herein relative to FIGS. 10 and 30.

In the embodiment being described, the system 10 may be operated during normal office hours, for example, 8 am to 5 pm. However, another feature of the invention is that it may be unmanned, such as during non-normal business hours, in which case the logged-in user 14 may access the host 12 during non-normal hours. As illustrated in the area 21 in FIG. 1, the logged-in user 14 may use at least one of the active server pages to, for example, locate a pager number or to transmit a message to the recipient's 20 communication device 18 in the manner described earlier herein.

It should also be understood that the system 10 may be enhanced to enable the logged-in user 14 to provide and transmit a voice message to the recipient 20 using the system 10 by having a live operator to call a person at home or the office if the pager 18 is not, for example, in service. This human backup facilitates contacting the physician if she does not have a pager 18 or if the pager 18 is not in service or turned on.

Certain other advantages of Applicants' system and method include the following:

Viewing a directory or database 24 of the community's physicians online.

Searching a directory or database 24 by name, group or specialty.

Entering custom monthly group and/or subgroup call schedule online.

Defining an unlimited number of subgroups for a group.

Defining a call pattern for up to three shifts, for example, per day per subgroup.

Making changes to a call schedule and make it available instantaneously to the medical community and others.

Allowing anyone to share a note (or a schedule exception) about how to communicate with a recipient. The note may be posted for a specified period of time to all operators before it expires. Users can edit and delete these notes, and a journal (not shown) of these edits may be saved for future reference.

Searching for physicians covering groups and/or subgroup and/or covering other physicians.

Submitting messages to one or two devices per user simultaneously, one-way, two-way pager or phone to members online through all the major paging and cellular networks (WebLink, Verizon, PageNet, Skytel, Metrocall, and the like) using SMTP, WCTP and WAP protocols

Submitting messages to a team of members (e.g. stroke team or disaster team) online.

Monitoring real-time message delivery notifications and physician replies for all pages submitted online. This eliminates the uncertainty and unreliability of one-way paging into a “black hole”.

Message submissions, deliveries and replies are automatically saved on database 24. Documented delivery of messages will improve speed of patient care, and medical outcomes.

Performing smart message search and retrieval on all previous message submissions, deliveries and replies.

Sharing the physician referral preferences and/or special instructions with the caregivers to allow for instant emergency referrals and receive email feedback on all these referrals.

Applicants' system 10 is direct and bypasses the traditional answering service which allows any medical professional to obtain instant online communication.

System 10 is accessible from any computer connected to the Internet using Netscape Navigator® 4.7/Internet Explorer® 4.0 or higher, available from Netscape, Inc. and Microsoft Corporation, respectively. All that is needed is to sign-on to system 10 using a user ID and password.

All transactions are carried out using the paging networks and not the slower and unreliable email networks.

The system 10 web site is secured and all transactions are logged using audit trails.

Applicants' system 10 is device independent. However, Applicants recommend devices that do not interfere with hospital equipment.

Assured messaging by major network carriers and Applicants' system 10 server allows for receipt, delivery notification and replies to messages even after the device 18 is turned ON or when the device 18 enters a wireless network coverage area.

### Additional Considerations

It should be appreciated that the system 10 monitors in real time the message delivery notifications and replies for all pagers 18 that are turned on. This facilitates reducing the uncertainty and unreliability of one-way paging to a recipient that does not, for example, have his or her paging device turned on. Each physician or staff member can be assigned a “back up” paging device 18, which could be alerted if the primary device 18 is not responding to the alerts from the system 10. Moreover, each physician or staff member can also be assigned a timer to alert the sender of the message or other operator if the recipient or pager 18 is not responding to any alerts of messages.

The system further provides for timeliness for institutions, such as hospitals. In this regard, the system 10 may comprise a team or group dispatch feature that allows groups to share call schedules with other groups to create a master call schedule for team dispatching. For example, if a heart attack or stroke victim team is needed, the entire team would be dispatched. With a single click, a user can select a group or physicians and staff from multiple groups, and these users and staff members are accurately identified and dispatched using their call schedule which is stored in the database 24 of system 10.

Although not shown, the system 10 may optionally comprise a confidentiality and integrity feature of the message/reply from the paging device 18 are ensured using an optional secret signature at the end of each reply.

Advantageously, the system 10 increases the speed and effectiveness of response times to doctors and ultimately to patients by reducing the time required to locate a physician; provide him or her with accurate detailed information about a patient; and provide the physicians with an immediate way of communicating through a reliable messaging system. Whenever time is saved, the possibility that lives are saved rises dramatically. For example, a stroke team may be alerted using system 10 of a patient's stroke in less than about one minute of an initial call for medical response, which significantly improves the stroke victim's chances of recovery. The system 10 enables a direct communication between a physician, for example, and a person trying to contact that physician, rather than going through an on-call switchboard operator as was done in the past. This feature significantly reduces the amount of time it takes to communicate between a physician and the person trying to contact that physician. In the embodiment being described, the system 10 facilitates enabling users to contact recipients of messages in less than about sixty seconds.

While the systems and methods herein described, and the forms of apparatus for carrying these systems and methods into effect, constitute preferred embodiments of this invention, it is to be understood that the invention is not limited to these precise methods and forms of apparatus, and that changes may be made in either without departing from the scope of the invention, which is defined in the appended claims.

1. A method for communicating on-call information among medical personnel, said method comprising the steps of:
submitting a message to an on-call server; and
transmitting the message from the on-call server to a communication device.

2. The method as recited in claim 1 wherein said method further comprises the steps of:
using a computer to generate the message;
causing the computer to transmit the message over the Internet.

3. The method as recited in claim 1 wherein said method further comprises the step of:
transmitting the message to the communication device using a wireless protocol.

4. The method as recited in claim 1 wherein said on-call server comprises a web host.

5. The method as recited in claim 4 wherein said web host performs said transmitting step.

6. The method as recited in claim 1 wherein said method further comprises the step of:
inputting information associated with a medical person into said on-call server.

7 The method as recited in claim 6 wherein said information comprises an on-call schedule for the medical personnel.

8. The method as recited in claim 6 wherein said information comprises referral information.

9. The method as recited in claim 6 wherein said information comprises hospital privilege information.

10. The method as recited in claim 1 wherein said medical personnel comprises a plurality of doctors.

11. The method as recited in claim 1 wherein said method further comprises the steps of:
logging onto the on-call server;
enabling a logged-in user to page one or more persons using said computer.

12. The method as recited in claim 1 wherein said method further comprises the steps of:
enabling a user to log into logging onto the on-call server;
enabling a logged-in user to access a database of information relative to at least one of said medical personnel.

13. The method as recited in claim 1 wherein said method further comprises the step of:
enabling a logged-in user to enter a message into the computer;
enabling the logged-in user to send the message to at least one recipient.

14. The method as recited in claim 1 wherein said method further comprises the steps of:
logging onto the on-call server;
enabling a logged-in user to page one or more persons using said computer.

15. The method as recited in claim 14 wherein said method further comprises the steps of:
enabling the logged-in user to enter a message for said one or more persons.

16. The method as recited in claim 15 wherein said method further comprises the steps of:
enabling said one or more persons to enter a reply;
displaying said reply on said computer.

17. The method as recited in claim 16 wherein said method further comprises the steps of:
providing a plurality of active server pages to enable a user to perform said enabling steps.

18. The method as recited in claim 13 wherein said method further comprises the steps of:
providing a plurality of active server pages for performing said enabling steps.

19. The method as recited in claim 16 wherein said method further comprises the steps of:
providing a plurality of active server pages for performing said enabling steps.

20. The method as recited in claim 16 wherein said plurality of active server pages comprises a message area and a plurality of common links.

21. The method as recited in claim 16 wherein said method further comprises the step of:
assigning an access level for each user;
requiring the user to log onto the on-call server;
defining said plurality of common links depending on said access level.

22. The method as recited in claim 16 wherein said method further comprises the step of:
assigning an access level for each user;
requiring the user to log onto the on-call server;

23. An on-call system comprising:
a host, said host comprising a database, at least one server and a plurality of active server pages, said database comprising on-call data associated with a person; and
said plurality of active server pages comprising an user interface page for permitting a user to access said database via the Internet.

24. The on-call system as recited in claim 23 wherein said user interface page comprises a pager link for initiating a pager communication to said person.

25. The on-call system as recited in claim 24 wherein said system further comprises:
a wireless server for sending a wireless communication in response to a user actuating said pager link.

26. The on-call system as recited in claim 24 wherein said user interface page comprises a message area for said user to input a message to said person being paged.

27. The on-call system as recited in claim 26 wherein said user interface page comprises a message area for said user to input a message to said person.

28. The on-call system as recited in claim 26 wherein said server comprises at least one queue for receiving the message and for receiving a reply in response to the message; said server causing said reply to be displayed in said message area of said user interface page.

29. The on-call system as recited in claim 24 wherein said user interface page comprises a message area for said user to input a message to said person.

30. The on-call system as recited in claim 25 wherein said wireless server transmits said message to at least one network carrier and said at least one network carrier transmits said message to a communication device associated with said person.

31. The on-call system as recited in claim 30 wherein said plurality of pages comprises at least one active server page for enabling a user to associate a communication device with said person.

32. The on-call system as recited in claim 30 wherein said plurality of pages comprises at least one active server page for enabling a user to input information relative to said person.

33. The on-call system as recited in claim 30 wherein said plurality of pages comprises at least one active server page for enabling a user to input information relative to a group of persons.

34. The on-call system as recited in claim 32 wherein said information comprises rules for the person.

35. The on-call system as recited in claim 33 wherein said person is a physician and said rules comprise at least one of preferred referral physicians, covering physicians or physician privileges.

36. The on-call system as recited in claim 33 wherein said information comprises rules for said group of persons.

37. The on-call system as recited in claim 36 wherein said group of persons comprises medical persons and said rules comprise at least one of preferred referral persons, covering persons or medical facility privileges.

38. The on-call system as recited in claim 23 wherein said at least one of said active server pages enables said user to input, modify or delete said on-call data.

39. The on-call system as recited in claim 38 wherein said data comprises a first set of data, and a second set of data, said plurality of active server pages comprising:
a first level access page for providing a first user with access to a first set of data; and
a second level access page for providing a second user with access to a second set of data;
said system causing said first or second level access page to be displayed in response to whether said user has logged into said system as a first user or a second user.

40. The on-call system as recited in claim 39 wherein said system permits said user to input, modify or delete said first set of data if said first user is logged into the system.

41. The on-call system as recited in claim 40 wherein said first set of data comprises information relative to a particular physician.

42. The on-call system as recited in claim 40 wherein said first set of data comprises information relative to a particular physician or information relative to a particular group of physicians.

43. The on-call system as recited in claim 41 wherein said information comprises information comprises at least one of said physician's name, address, affiliates and contact numbers.

44. The on-call system as recited in claim 41 wherein said information comprises said physician's on-call schedule for a particular time period.

45. The on-call system as recited in claim 43 wherein said information comprises communication information relative to a communication device associated with said physician.

46. The on-call system as recited in claim 45 wherein said communication device comprises a paging device and said communication information comprises a number associated with the paging device.

47. A communication system for communicating among medical personnel, comprising:
a host comprising a database, at least one server and a plurality of active server pages for enabling a user to access said database, determine information associated with at least one of said medical personnel and to send a message to said at least one medical personnel,
a wireless communication system for communicating said message between said host and at least one network server; and
a communication device for receiving said message from said network server when transmitted by said wireless.

48. The communication system as recited in claim 47 wherein at least one of said plurality of active server pages comprises a user interface page for permitting a user to access said database over the internet using a computer.

49. The communication system as recited in claim 47 wherein said user interface page comprises a pager link for initiating a pager communication to said person.

50. The communication system as recited in claim 49 wherein said system further comprises:
a wireless server for sending a wireless communication in response to a user actuating said pager link.

51. The communication system as recited in claim 48 wherein said user interface page comprises a message area for said user to input a message to said person being paged.

52. The communication system as recited in claim 51 wherein said user interface page comprises a message area for said user to input a message to said person.

53. The communication system as recited in claim 51 wherein said server comprises at least one queue for receiving the message and for receiving a reply in response to the message; said server causing said reply to be displayed in said message area of said user interface page.

54. The communication system as recited in claim 48 wherein said user interface page comprises a message area for said user to input a message to said person.

55. The communication system as recited in claim 49 wherein said wireless server transmits said message to at least one network carrier and said at least one network carrier transmits said message to a communication device associated with said person.

56. The communication system as recited in claim 55 wherein said plurality of pages comprises at least one active server page for enabling a user to associate a communication device with said person.

57. The communication system as recited in claim 55 wherein said plurality of pages comprises at least one active server page for enabling a user to input information relative to said person.

58. The communication system as recited in claim 55 wherein said plurality of pages comprises at least one active server page for enabling a user to input information relative to a group of persons.

59. The communication system as recited in claim 57 wherein said information comprises rules for the person.

60. The communication system as recited in claim 58 wherein said person is a physician and said rules comprise at least one of preferred referral physicians, covering physicians or physician privileges.

61. The communication system as recited in claim 58 wherein said information comprises rules for said group of persons.

62. The communication system as recited in claim 61 wherein said group of persons comprises medical persons and said rules comprise at least one of preferred referral persons, covering persons or medical facility privileges.

63. The communication system as recited in claim 47 wherein said at least one of said active server pages enables said user to input, modify or delete said on-call data.

64. The communication system as recited in claim 63 wherein said data comprises a first set of data, and a second set of data, said plurality of active server pages comprising:
a first level access page for providing a first user with access to a first set of data; and
a second level access page for providing a second user with access to a second set of data;
said system causing said first or second level access page to be displayed in response to whether said user has logged into said system as a first user or a second user.

65. The communication system as recited in claim 64 wherein said system permits said user to input, modify or delete said first set of data if said first user is logged into the system.

66. The communication system as recited in claim 65 wherein said first set of data comprises information relative to a particular physician.

67. The communication system as recited in claim 65 wherein said first set of data comprises information relative to a particular physician or information relative to a particular group of physicians.

68. The communication system as recited in claim 66 wherein said information comprises information comprises at least one of said physician's name, address, affiliates and contact numbers.

69. The communication system as recited in claim 66 wherein said information comprises said physician's on-call schedule for a particular time period.

70. The communication system as recited in claim 68 wherein said information comprises communication information relative to a communication device associated with said physician.

71. The communication system as recited in claim 70 wherein said communication device comprises a paging device and said communication information comprises a number associated with the paging device.

72. A method for communication among medical personnel comprising the steps of:
providing a host having a database for receiving information regarding said medical personnel;
permitting a user to enter said information into said database; and
permitting a second user to access said information after logging onto said host;
said information comprising at least one of the following: a medical personnel's on-call schedule or contact information for contacting said medical personnel.

73. The method as recited in claim 72 wherein said method further comprises the steps of:
providing said second user with at least one active server page from said host;
enabling said second user to communicate with said medical personnel by actuating a link on said at least one active server page.

74. The method as recited in claim 72 wherein said method further comprises the step of:
enabling said user to use at least one active server page to associated communication device information with said medical personnel.

75. The method as recited in claim 72 wherein said communication device information comprises pager information.

76. The method as recited in claim 72 wherein said medical personnel is a physician.

77. The method as recited in claim 73 wherein said host comprises a paging server, said method further comprises the steps of:
enabling said second user to use said active server page to transmit a message from said paging server to a communication device associated with said medical personnel.

78. The method as recited in claim 77 wherein said method further comprises the steps of:
providing said active server page with a message area for said second user to input a message to at least one of said medical personnel;
providing a communication device link for said second user to actuate to cause said message to be transmitted to said at least one medical personnel.

79. The method as recited in claim 78 wherein said host comprises a communication server, said method further comprising the step of:
using a wireless application protocol to transmit said message from said communication server to a network carrier, said network carrier transmitting said message to said communication device.

80. The method as recited in claim 79 wherein said method further comprising the step of:
using a wireless application protocol to transmit a reply from said communication device to said communication server.

81. The method as recited in claim 80 wherein said method further comprises the step of:
displaying an alert message at said second users terminal in response to said reply.

82. The method as recited in claim 81 wherein said user and said second user are the same.

83. The method as recited in claim 72 wherein said method further comprising the step of:
enabling said user to establish rules for said medical personnel.

84. The method as recited in claim 83 wherein said rules comprise hospital privileges.

85. The method as recited in claim 83 wherein said rules comprise geographic coverage areas.

86. The method as recited in claim 83 wherein said rules comprise on-call responsibilities.

87. The method as recited in claim 81 wherein said method further comprises the step of:
establishing different levels of access to said database for said user and said second user.

88. The method as recited in claim 77 wherein said method further comprises the step of:
providing a plurality of predefined messages that said second user may choose from to define said message.

89. The method as recited in claim 77 wherein said message is a written message.

90. The method as recited in claim 77 wherein said message is a voice message.

91. The method as recited in claim 72 wherein said method further comprises the steps of:
providing a communication device for permitting said user to page at least one of said medical personnel.

92. The method as recited in claim 91 wherein said paging device is capable of responding to a wireless paging signal by communicating with an Internet Service Provider, making an internet connection and transmitting a message from at least one medical personnel to said user.

93. The method as recited in claim 72 wherein said method further comprises the step of:
assigning a plurality of communication devices to at least one of said medical personnel.

94. The method as recited in claim 72 wherein said method further comprises the step of:
assigning a time period to alert the user if at least one communication device associated with the medical personnel being contacted is not responding to communications or alerts.

95. The method as recited in claim 72 wherein said method further comprises the step of:
creating a master call schedule for team dispatching to enable a plurality of groups of medical personnel to create a master call schedule.

96. A method of communicating to a medical person comprising the steps of:
providing a database accessible over the Internet;
enabling the user to access that database and select the medical person to be contacted over the Internet; and
using WCTP or WAP protocols to permit communication to the medical person to be contacted in response to a user action, wherein said database comprises information regarding that medical person.
